(19) United States
(12) Patent Application Publication
(10) Pub. No.: US 2023/0143643 A1
(43) Pub. Date: May 11, 2023

(54) LOW DK COPPER CLAD LAMINATE COMPOSITIONS

(71) Applicant: Designer Molecules, Inc., San Diego, CA (US)

(72) Inventor: Farhad G. Mizori, San Diego, CA (US)

(21) Appl. No.: 17/905,167

(22) PCT Filed: Dec. 3, 2020
(86) PCT No.: PCT/US2020/062961

§ 371 Date: Aug. 26, 2022

Related U.S. Application Data
(60) Provisional application No. 62/943,440, filed on Dec. 4, 2019.
(60) Provisional application No. 62/950,133, filed on Dec. 19, 2019.

(51) Int. Cl. C08J 5/24; C08G 73/10; B32B 15/20; B32B 15/08; B32B 7/12

(52) U.S. Cl. CPC C08J 5/249; C08G 73/10; B32B 15/20; B32B 15/08; B32B 7/12; C08J 2333/24; C08J 2371/12; B32B 2457/08; B32B 2260/046; B32B 2260/021

(57) ABSTRACT

Curable polyimides and compositions thereof with very good dielectric properties are provided. Prepregs of these compositions laminated with copper foil to prepare copper clad laminates having Tg>150 C and Df<0.0025 are also provided.

### RELATED APPLICATIONS

This application claims the benefit of priority under 35 USC § 119 of U.S. Provisional Application Ser. No. 62/943,440 (filed Dec. 4, 2019) and 62/950,133 (filed Dec. 19, 2019), the entire disclosures of which are incorporated herein by reference.

### FIELD OF THE INVENTION

This present invention relates to curable polyimides resins, with low dielectric constants and low dielectric dissipation factors. In particular, the invention is directed to flexible polyimide resins with curable maleimide moieties. In certain aspects, the invention is directed to maleimide-terminated polyimide resins and compositions thereof that can be dissolved in a suitable solvent and can be used to make prepregs in combination with glass fabric. The invention also relates copper-clad laminates formed from prepregs of the invention that are heated and cured to form a dielectric and adhesive layer.

### BACKGROUND OF THE INVENTION

Due to a rapid increase in communication information, there is a strong demand for miniaturization, weight reduction and speed of electronic devices for high-density mounting. The electronics industry has put a greater demand for low dielectric, electrically insulating materials and polymers that are adapted for operation in a high frequency environment.

The polymeric materials used in high power devices must satisfy critical thermal, environmental, and electrical requirements to meet the required performance criteria for microelectronics applications. The desired attributes include thermal stability, low moisture uptake, high breakdown voltage (low leakage current), low dielectric constant and low dissipation factor. The use of polymers meeting these performance criteria facilitate advanced electronic packaging techniques, resulting in improved system performance and reliability.

To ensure the proper operation of a high-power electronic circuit, isolation between adjacent conductors is necessary. High voltage arcing and leakage currents are typical problems encountered in high voltage circuits that are exacerbated at high frequencies. To counter these effects, a suitable dielectric material must display low values for dielectric constant and dissipation factor (loss tangent) and a high value for breakdown voltage.

Maleimide functionalized compounds have been known for many decades. Bismaleimides (BMI resins) are considered among the top tier of high performance maleimide resins. These compounds have been used extensively in electronics, aerospace and other industries that require high temperature reliability.

U.S. Pat. Nos. 7,884,174 B2 and 7,157,587 B2 (the contents of which are incorporated by reference herein in their entireties) disclose the synthesis of a new class of thermosetting elastomers. The physical properties of the disclosed maleimide-capped polyimide resins range from low melting solids to viscous liquids. Also described are polyimides functionalized with other curable moieties. Such functionalized, curable polyimides compounds (including those containing maleimides and other curable moieties) possess inherent properties required of high-performance elastomers: hydrophobicity, hydrolysis resistance, liquid state at room temperature or low-melt viscosities of solids, very high temperature resistance, and low modulus. Many of these compounds have low dielectric constants and low dielectric dissipation factors.

Maleimides are also very flexible because of the number of methods available to polymerize these materials. Due to the electron deficient nature of the maleimide double bond these compounds can undergo free-radical polymerization using standard peroxide initiators with a variety of curable reactive diluents.

Copper clad laminates are the basic building blocks of high-performance electronic circuits and are subject to increasingly stringent physical requirements.

A circuit board will go through many high temperature assembly operations including soldering, and high temperatures may be encountered during the normal operation, therefore the glass transition temperature (T_{g}) of the composition needs to be sufficiently high to prevent any delamination at temperatures the circuit board will encounter during assembly and operation. Typically, a T_{g} of at least 150° C. is required; and increasingly, the minimum T_{g} must be 170° C. to 200° C. or even higher.

Again, due to the high temperature operations, the coefficient of thermal expansion (CTE) of the composition needs to be very low to prevent delamination. A CTE of less than 50 ppm is generally required. However, a CTE of about 17 ppm is preferred, to match the CTE of copper.

Preferred compositions need to be soluble in non-toxic organic solvents that have boiling points of less than 100° C., and form very high solids (>50%), non-viscous liquids. These criteria and necessary for making prepregs. Very high solids and thin liquids allow a greater amount of resin to interpenetrate and saturate fiber supports such as glass fabric. Low boiling solvents evaporate quickly and efficiently, thereby preventing outgassing downstream, e.g. during lamination processes and end use.

The dielectric constant (Dk) of polymeric compositions must be lower than 3.5, and preferably lower than 3.0. Dielectric dissipation factor (Df) requirements depend on the frequencies that will be encountered in the specific uses of the materials. Acceptable Dfs range from 0.02 for general use circuit boards to less than 0.0025 for extreme low-loss materials used in very high frequency applications such as radar antenna.

The dielectric dissipation factor (Df) is dependent on several factors. The most important is the polarizability of the thermoset. Highly polar materials have very high Df values. For example, readily available epoxy resins have good mechanical properties and adhesion; however, they are not generally suitable for high frequency applications since they are very polar and have Df values in the 0.01 to 0.02 range. Non-polar materials or materials that are symmetrical tend to have much lower Df values. A composition that is hydrophilic will tend to absorb moisture, thereby allowing the Dk and the Df to increase dramatically in the environment.

Thus, there is a continuing need for polymers, such as polyimides, that have increasingly stringent dielectric properties to meet the needs of high-performance, high-energy, high frequency electronics applications.

### SUMMARY OF THE INVENTION

The present invention provides matrix formulations for preparing prepregs, copper clad laminates and flexible copper clad laminate, comprising at least one curable polyimide compound having a structure according to Formula I:

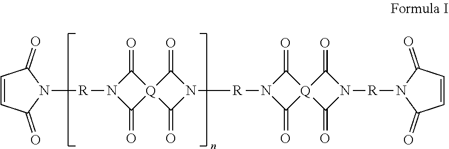

where each R is independently selected from the group consisting of substituted or unsubstituted aliphatic, cycloaliphatic, alkenyl, aromatic, and heteroaromatic; each Q is independently selected from the group consisting of substituted or unsubstituted aliphatic, cycloaliphatic, and alkenyl; and n is and integer having the value 0-10.

In certain embodiments, the at least one curable polyimide compound is the product of a condensation of a diamine with an anhydride.

The diamine for preparing the curable polyimide compound can be, for example, 4,4′-methylenebis(2,6-diethylaniline); tricyclodecane diamine (TCD-diamine); Bisaniline-P; 2.2-bis[4-(4-aminophenoxy)phenyl] hexafluoropropane; 1,10-diaminodecane; 1,12-diaminododecane; dimer diamine; hydrogenated dimer diamine; 1,2-diamino-2-methylpropane; 1,2-diaminocyclohexane; 1,2-diaminopropane; 1,3-diaminopropane; 1,4-diaminobutane; 1,5-diaminopentane; 1,7-diaminoheptane; 1,8-diaminomenthane; 1,8-diaminooctane; 1,9-diaminononane; 3,3′-diamino-N-methyldipropylamine; diaminomaleonitrile; 1,3-diaminopentane; 9,10-diaminophenanthrene; 4,4′-diaminooctafluorobiphenyl; 3,5-diaminobenzoic acid; 3,7-diamino-2-methoxyfluorene; 4,4′-diaminobenzophenone; 3,4-diaminobenzophenone; 3,4-diaminotoluene; 2,6-diaminoanthroquinone; 2,6-diaminotoluene; 2,3-diaminotoluene; 1,8-diaminonaphthalene; 2,4-diaminotoluene; 2,5-diaminotoluene; 1,4-diaminoanthroquinone; 1,5-diaminoanthroquinone; 1,5-diaminonaphthalene; 1,2-diaminoanthroquinone; 2,4-cumenediamine; 1,3-bisaminomethylbenzene; 1,3-bisaminomethylcyclohexane; 2-chloro-1,4-diaminobenzene; 1,4-diamino-2,5-dichlorobenzene; 1,4-diamino-2,5-dimethylbenzene; 4,4′-diamino-2,2′-bistrifluoromethylbiphenyl; bis(amino-3-chlorophenyl)ethane; bis(4-amino-3,5-dimethylphenyl)methane; bis(4-amino-3,5-diisopropylphenyl)methane; bis(4-amino-3,5-methyl-isopropylphenyl)methane; bis(4-amino-3,5-diethylphenyl)methane; bis(4-amino-3-ethylphenyl)methane; diaminofluorene; 4,4′-(9-Fluorenylidene)dianiline; diaminobenzoic acid; 2,3-diaminonaphthalene; 2,3-diaminophenol; -5-methylphenyl)methane; bis(4-amino-3-methylphenyl)methane; bis(4-amino-3-ethylphenyl)methane; 4,4′-diaminophenylsulfone; 3,3′-diaminophenylsulfone; 2,2-bis(4,-(4-aminophenoxy)phenyl)sulfone; 2,2-bis(4-(3-aminophenoxy)phenyl)sulfone; 4,4′-oxydianiline; 4,4′-diaminodiphenyl sulfide; 3,4′-oxydianiline; 2,2-bis(4-(4-aminophenoxy)phenyl)propane; 1,3-bis(4-aminophenoxy)benzene; 4,4′-bis(4-aminophenoxy)biphenyl; 4,4′-diamino-3,3′-dihydroxybiphenyl; 4,4′-diamino-3,3′-dimethylbiphenyl; 4,4′-diamino-3,3′-dimethoxybiphenyl; Bisaniline M; Bisaniline P; 9,9-bis(4-aminophenyl)fluorene; o-tolidine sulfone; methylene bis(anthranilic acid); 1,3-bis(4-aminophenoxy)-2,2-dimethylpropane; 1,3-bis(4-aminophenoxy)propane; 1,4-bis(4-aminophenoxy)butane; 1,5-bis(4-aminophenoxy)butane; 2,3,5,6-tetramethyl-1,4-phenylenediamine; 3,3′, 5,5′-tetramehylbenzidine; 4,4′-diaminobenzanilide; 2,2-bis(4-aminophenyl)hexafluoropropane; polyoxyalkylenediamines; 1,3-cyclohexanebis(methylamine); m-xylylenediamine; p-xylylenediamine; bis(4-amino-3-methylcyclohexyl)methane; 1,2-bis(2-aminoethoxy)ethane; 3(4),8(9)-bis(aminomethyl)tricyclo(5.2.1.0^{2,6})decane; or a combination thereof. Specifically contemplated diamines used to prepare the polyimides of the invention include: 4,4′-methylenebis(2,6-diethylaniline); PRIAMINE™ 1075 (dimer diamine); PRIAMINE™ 1074 (dimer diamine); Bisaniline-P; tricyclodecane diamine (TCD-diamine); 2.2-bis[4-(4-aminophenoxy)phenyl]hexafluoropropane, and combinations thereof.

The anhydride for preparing the curable polyimide compound can be, for example, Bisphenol-A-dianhydride; biphenyl tetracarboxylic dianhydride; pyromellitic dianhydride; maleic anhydride; polybutadiene-graft-maleic anhydride; polyethylene-graft-maleic anhydride; polyethylene-alt-maleic anhydride; polymaleic anhydride-alt-1-octadecene; polypropylene-graft-maleic anhydride; poly(styrene-co-maleic anhydride); maleic anhydride; succinic anhydride; 1,2,3,4-cyclobutanetetracarboxylic dianhydride; 1,4,5,8-naphthalenetetracarboxylic dianhydride; 3,4,9,10-perylenentetracarboxylic dianhydride; bicyclo(2.2.2)oct-7-ene-2,3,5,6-tetracarboxylic dianhydride; diethylenetriaminepentaacetic dianhydride; ethylenediaminetetraacetic dianhydride; 3,3′, 4,4′-benzophenone tetracarboxylic dianhydride; 3,3′, 4,4′-biphenyl tetracarboxylic dianhydride; 4,4′-oxydiphthalic anhydride; 3,3′, 4,4′-diphenylsulfone tetracarboxylic dianhydride; 2,2′-bis(3,4-dicarboxyphenyl)hexafluoropropane dianhydride; 4,4′-bisphenol A diphthalic anhydride; 5-(2,5-dioxytetrahydro)-3-methyl-3-cyclohexene-1,2-dicarboxylic anhydride; ethylene glycol bis(trimellitic anhydride); hydroquinone diphthalic anhydride; allyl nadic anhydride; 2-octen-1-ylsuccinic anhydride; phthalic anhydride; 1,2,3,6-tetrahydrophthalic anhydride; 3,4,5,6-tetrahydrophthalic anhydride; 1,8-naphthalic anhydride; glutaric anhydride; dodecenylsuccinic anhydride; hexadecenylsuccinic anhydride; hexahydrophthalic anhydride; methylhexahydrophthalic anhydride; tetradecenylsuccinic anhydride or a combination thereof. Specifically contemplated anhydrides used to prepare the polyimides of the invention include: Bisphenol-A-dianhydride; biphenyl tetracarboxylic dianhydride; pyromellitic dianhydride; and maleic anhydride and combinations thereof.

The curable polyimide compound can be selected from

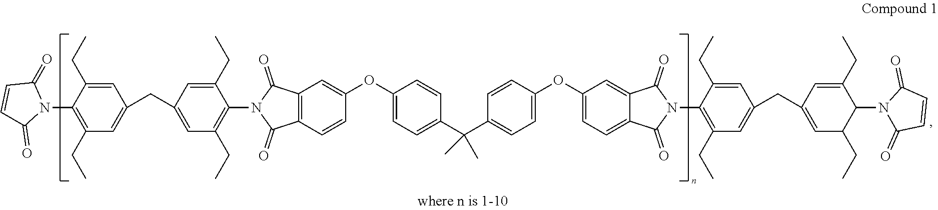

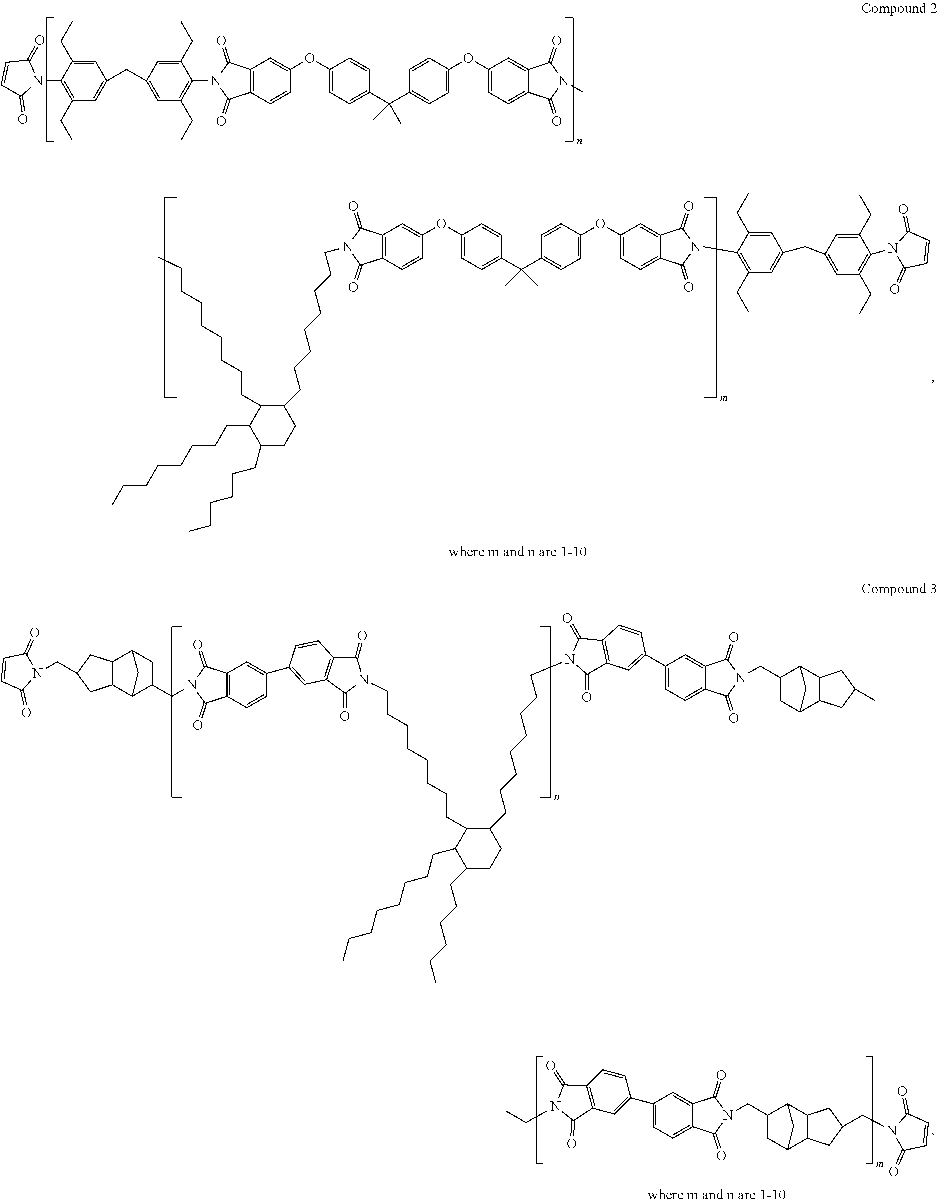

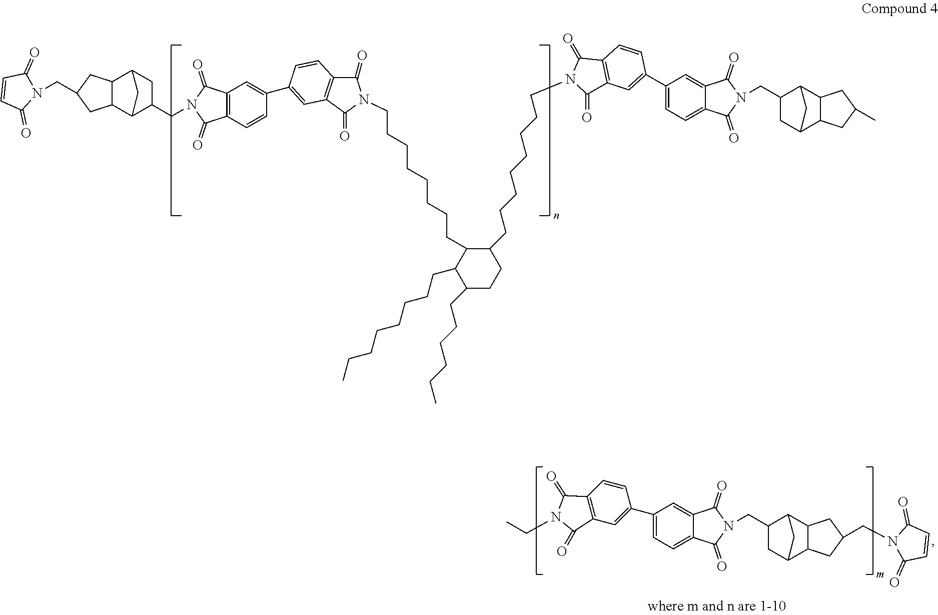

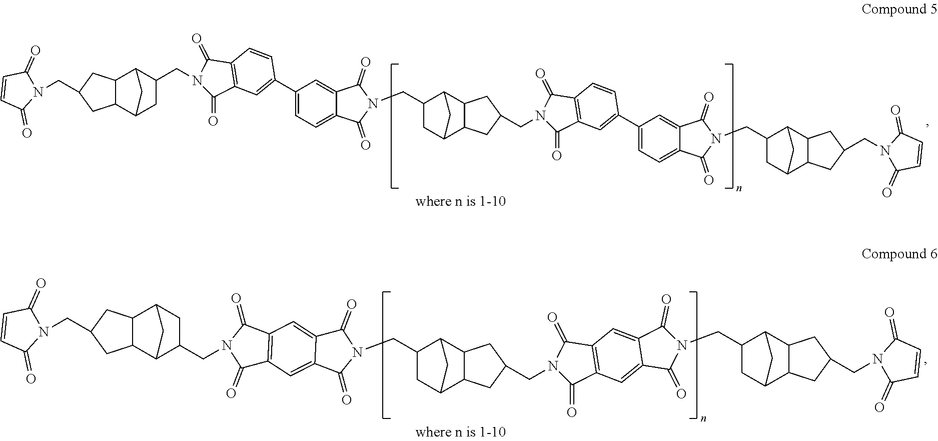

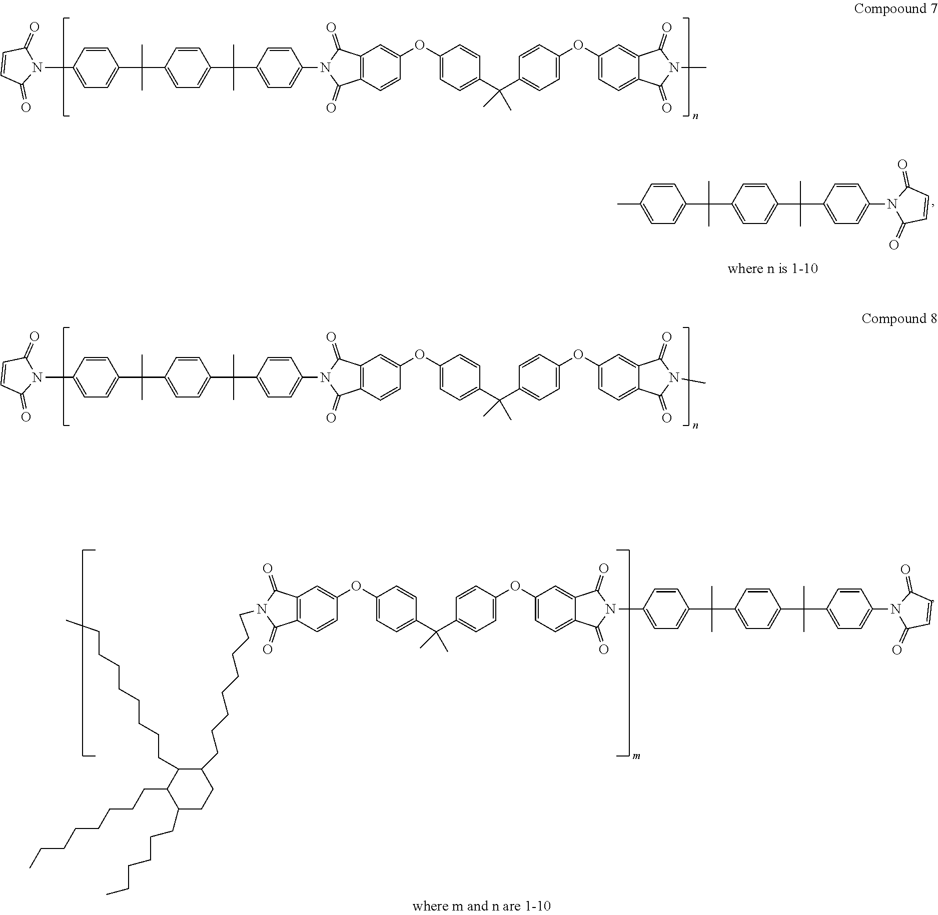

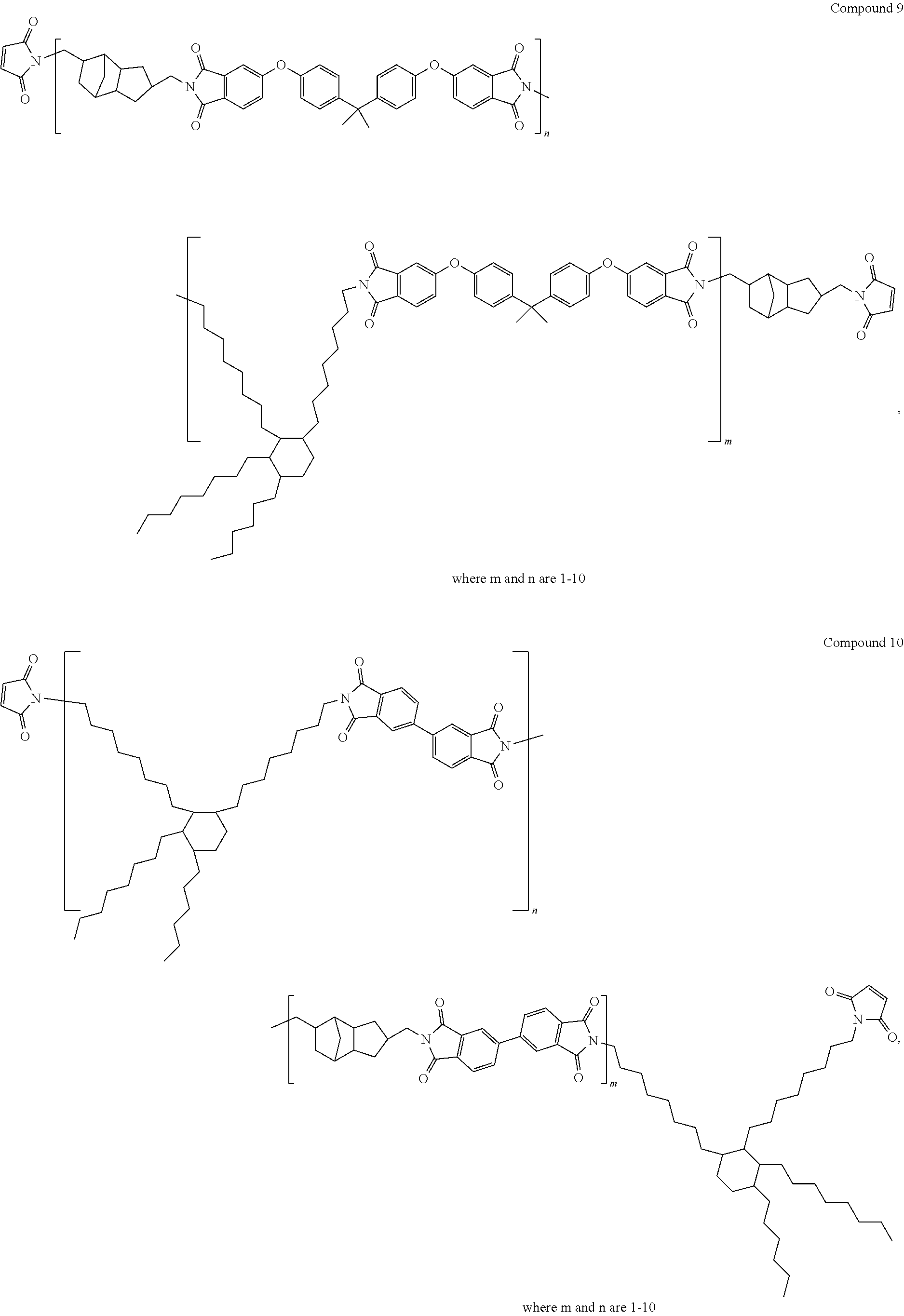

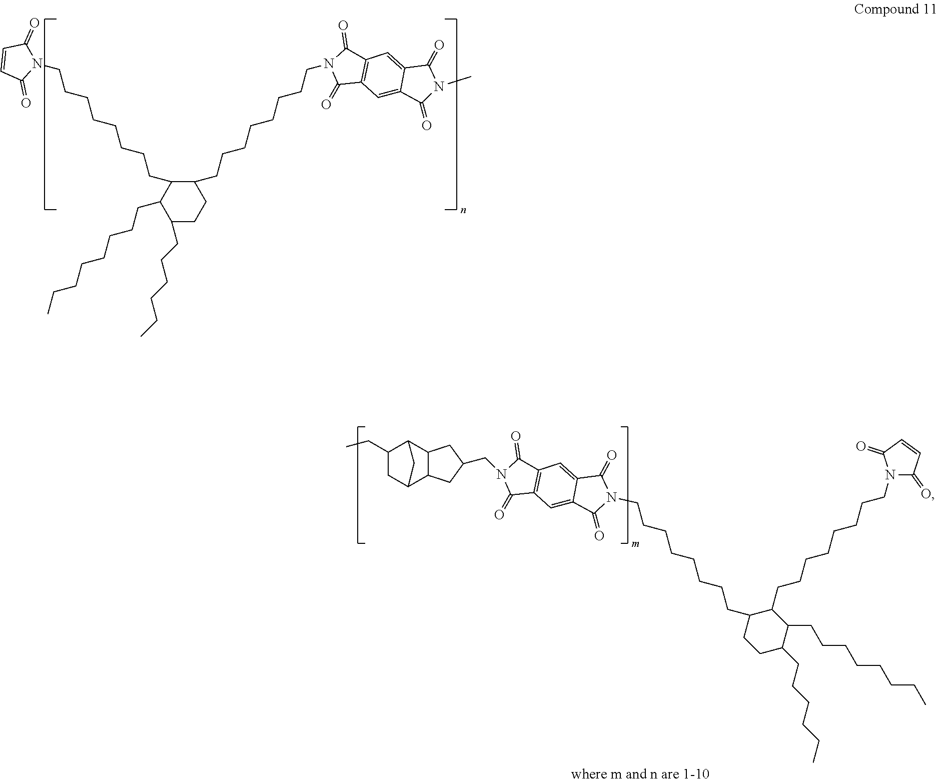

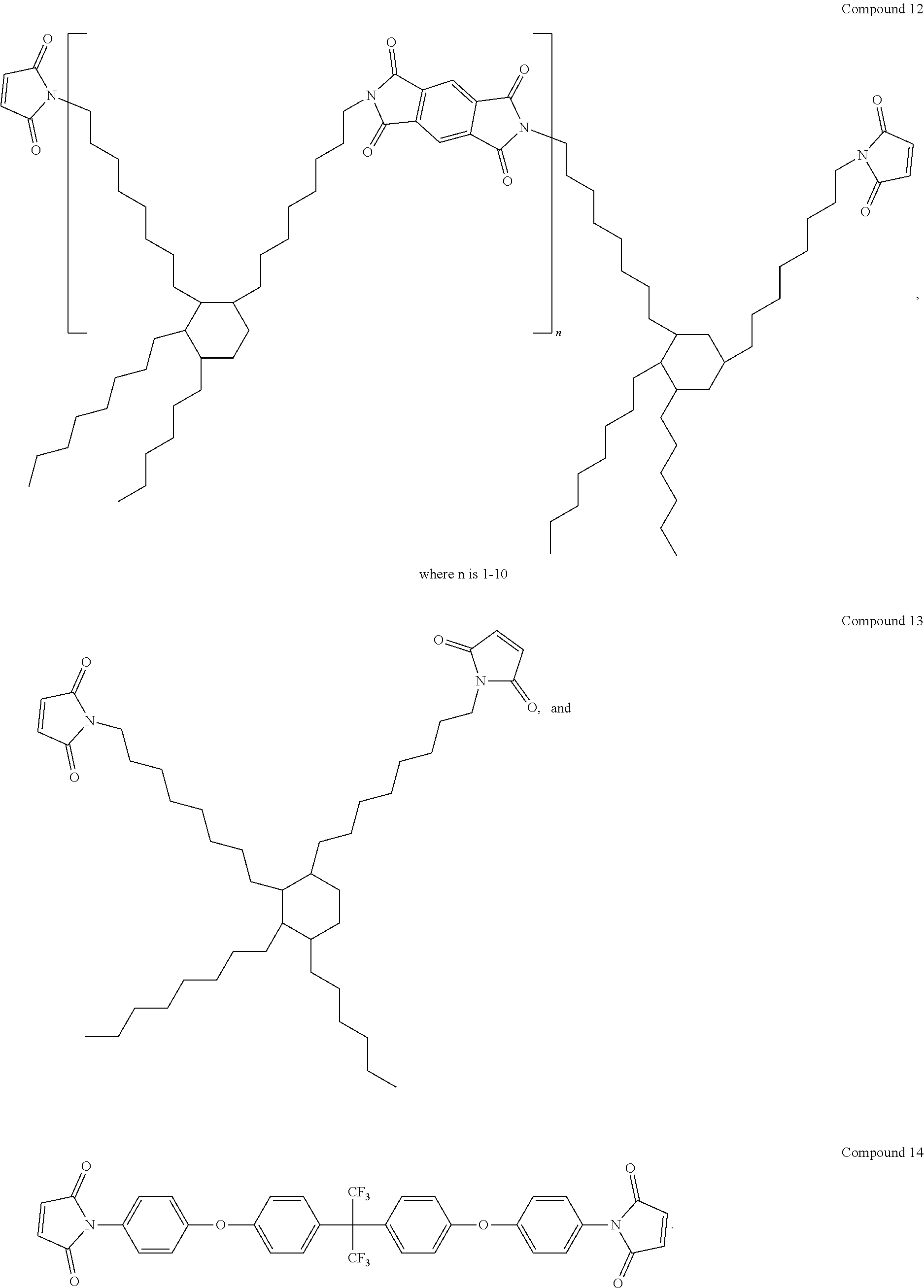

In certain matrix formulations of the invention, curable polyimide compound is selected Compounds 1, 3, 4, 6, 8, 9, 10, 11, 12, 13, 14 and combinations thereof. In other embodiments, the curable polyimide compound is selected Compounds 1, 3, 6, 7, 8, 9, 11, 12, and 13.

Specific combinations of polyimide compounds include Compounds 1 and 3; 1 and 11; 1 and 13; 1 and 14; 1, 3, and 11; 1, 3 and 13; 1, 3, and 14; 1, 11, and 14; 1, 11, and 13; 1, 13 and 14; 3 and 7; 3 and 11; 3 and 12; 3 and 13; 3, 7 and 11; 3, 7 and 12; 3, 7 and 13; 3, 11 and 12; 3, 11 and 13; 3, 12 and 13; 4 and 10; 4 and 11; 4 and 14; 4, 10 and 11; 4, 10 and 14; 4, 11 and 14; 6 and 11; 6 and 13; 7 and 8; 7 and 11; 7 and 12; 7 and 13; 7, 8 and 11; 7, 8 and 12; 7, 8 and 13; 7, 11 and 12; 7, 12 and 13; 8 and 10; 9 and 11; 9 and 13; 9 and 14; 9, 11 and 13; 9, 11 and 14; 9, 13 and 14; 10 and 14; and 11 and 12. In other embodiments, the polyimide is a combination of Compounds 1 and 13; Compounds 1 and 3; Compounds 9 and 13; Compounds 1 and 11; Compounds 3 and 12; Compounds 6 and 11; Compounds 7 and 13; Compounds 7, 8 and 12; or Compounds 1, 3 and 13. More specifically, the polyimide can be a combination of Compound 9 and 13.

In some embodiments, the polyimide or combination of polyimides in the matrix formulation can further include polyphenylene ether (PPE).

The matrix formulation can also include one or more of a reactive additive, coupling agent, adhesion promoter, cross-linker, initiator, catalyst or a combination thereof. The reactive additive can be selected from bismaleimide resins, citraconimide resins, benzoxazine resins, reactive ester resins (e.g., cyanate ester resins), phenolic resins, carboxyl resins, tackifier resins, polyphenylene oxide (PPO) resins and polyphenylene ether (PPE) resins, allylic resins, vinyl resins, vinyl ethers resins, vinyl ether resins, acrylic resins, epoxy resins, or a combination of these.

The reactive additive can be:

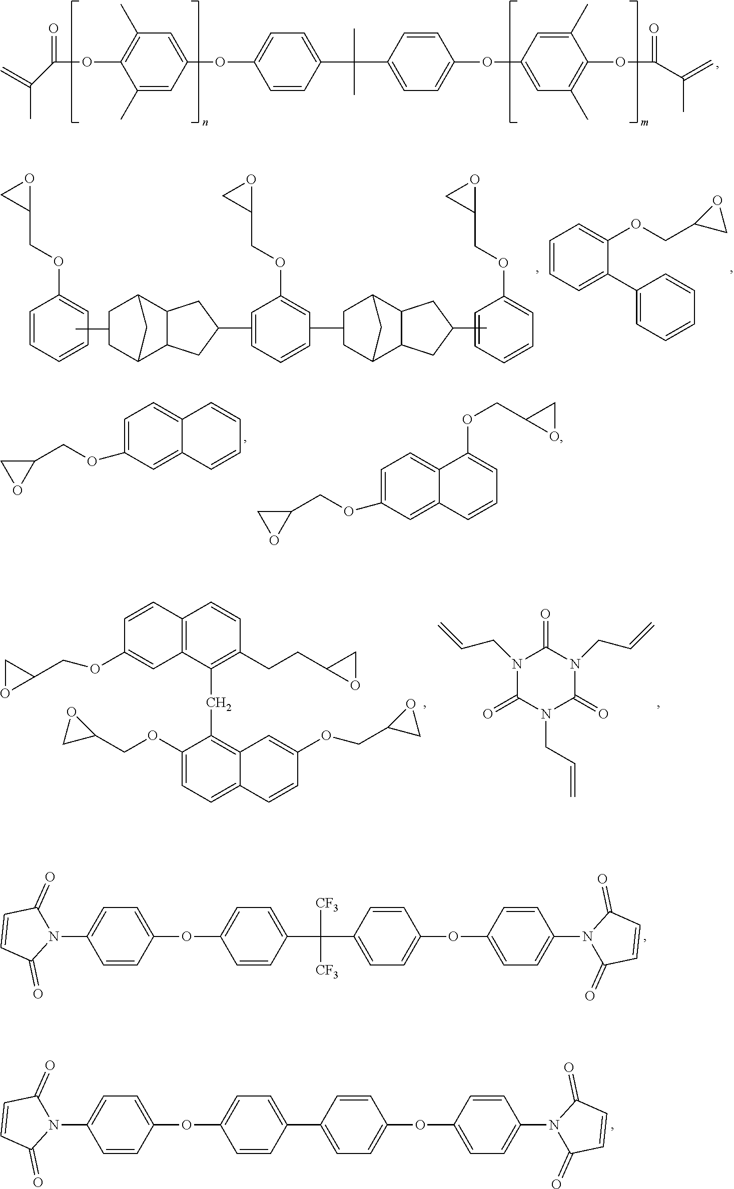

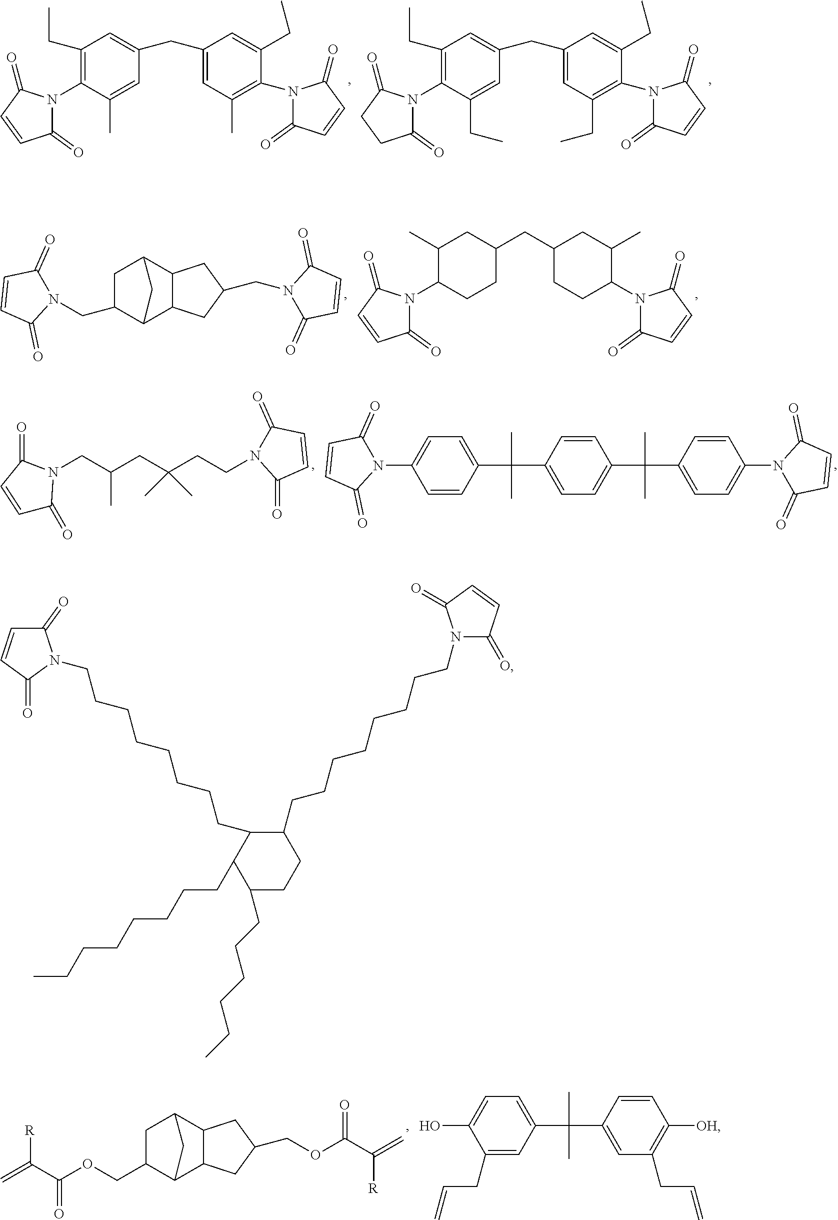

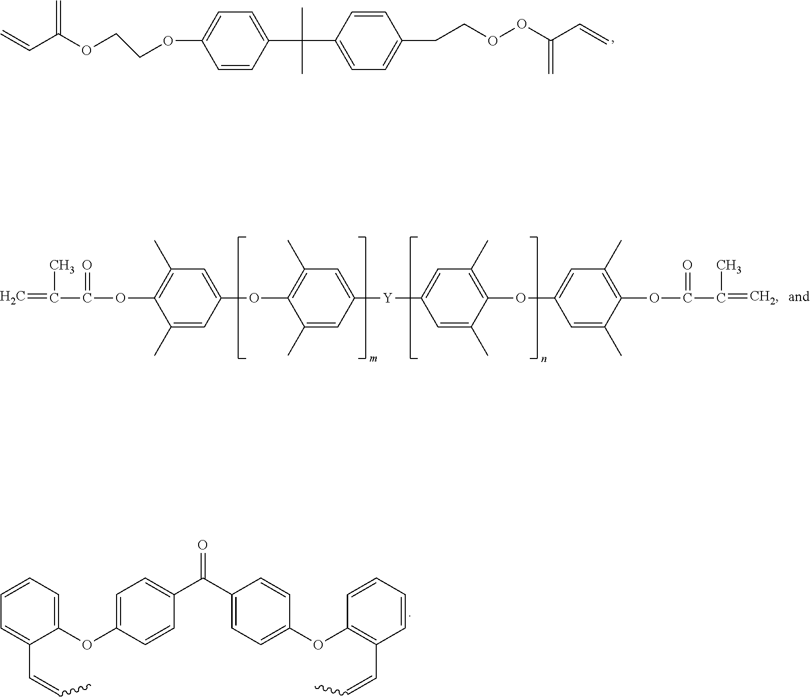

In certain embodiments, the reactive additive is:

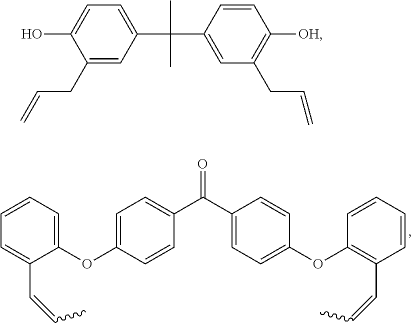

or a combination thereof

The coupling agent can be selected from the group consisting of organosilanes, organotitanates, organoboranes, organozirconates and combinations thereof; or it can be selected from silane coupling agents, titanium coupling agents, zirconium coupling agents, boranes, reactive anhydrides, salts of fatty acids and combinations thereof. Specific silane coupling agents contemplated for the matrix formulations of the invention include 2-(3,4 epoxycyclohexyl) ethyltrimethoxysilane, N-Phenyl-3-aminopropyltrimethoxysilane), or combinations thereof.

The cross-linker is can be tricyclodencane dimethanol-diacrylate, triallyl-isocyanurate or a combination thereof.

The initiator can include dicumyl peroxide (DCP), 2-phenylimidazole (2-PZ) and combinations thereof.

The at least one catalyst can be a free-radical generator catalyst (e.g. an organoperoxide), an anionic initiator catalyst (e.g. an imidazole), cationic initiator catalysts (e.g. a Lewis acid) or carbenium ion salt catalysts, or a combination thereof.

The matrix formulations of the invention can also include one or more fillers, such as silica, polytetrafluoroethylene (PTFE), carbon (e.g. carbon nanotubes), graphite, alumina, boron nitride and combinations thereof.

The matrix formulation can also include one or more fire retardant, such as organophosphonates and organophosphinates (e.g. aluminum diethyl phosphinate).

The invention also provides prepregs that include a matrix formulation described herein combined with a fiber support, such as woven or non-woven fabric. The fiber support can include one or more fibers selected from quartz glass fiber, carbon fiber, PTFE glass coated fiber, E-glass fiber, S-glass fiber, HDPE fiber, aramid fiber, or combinations thereof.

The invention also provides methods for preparing a prepreg including the steps of: providing a reinforcing fiber; and immersing the reinforcing fiber in a matrix formulation described herein, thereby impregnating the reinforcing fiber and thereby preparing a prepreg. Thereafter, the prepreg can be drained to remove excess liquid formulation; and dried.

In certain embodiments of the invention, such prepregs have T_{g} of 150° C. or greater. In other embodiments, the of the prepreg is 160° C. or greater; or 170° C. or greater.

The prepreg of claim 36, wherein the prepreg has a low Df after exposure to humidity for 24 hours, such as a Df lower than 0.0025 after exposure to humidity for 24 hours.

The present invention also provides methods for preparing a copper-clad laminate (CCL) that include the free-radical generator catalyst steps of providing a prepreg described above, and disposing copper on one or both sides of the prepreg, which disposing can be by electroplating or by laminating copper foil to one or the both sides of the prepreg. The invention thus provides CCL that includes a reinforcing fiber impregnated with a composition a matrix composition described above, which has copper disposed on one or both sides, and those which are prepared by the method described above.

In certain embodiments, the CCL has a T_{g}>150° C., >160° C. or >170° C., and has a low Df (e.g. <0.0025) after exposure to humidity for 24 hours.

The present invention also provides methods for preparing printed circuit boards (PCBs) by providing a CCL described herein, and etching circuit traces in the copper disposed on the one or the both sides of the CCL, as well as preparing printed circuit boards thus prepared.

Also provided are methods for preparing a flexible copper-clad laminate (FCCL) including providing a film comprising a matrix formulation described herein, applying an adhesive (e.g. an adhesive film) to one of both sides of the film and laminating copper foil to the adhesive. In certain embodiments, the FCCL further comprises adhesive layers between each copper foil and the film. In other embodiments, the film is an adhesive film. The invention also provides an FCCL thus prepared.

The invention further provides methods for preparing thin, flexible electronic circuits, from the FCCL of the invention by etching circuit traces in the copper foil on one or both sides of the FCCL, as well as thin, flexible electronic circuits that include a layer of adhesive film comprising a cured film that includes the matrix formulation described herein with etched copper circuit traces on one or both sides of the adhesive film.

### BRIEF DESCRIPTION OF THE DRAWINGS

FIG. 1 is a schematic flow diagram illustrating the process of making a printed circuit board including preparing a prepreg, laminating copper onto the prepreg, and etching a circuit pattern on the copper-cladding. Arrows A-E indicate steps in the process.

FIG. 2 is a cross-sectional view through the structures at plane XVII of FIG. 1.

FIG. 3A is a schematic flow diagram illustrating the process of producing a one-sided flexible copper-clad laminate (FCCL) according to one embodiment of the invention that includes an adhesive layer. Arrows A and B indicate steps in the process.

FIG. 3B is a schematic flow diagram illustrating the process of producing a one-sided flexible copper-clad laminate (FCCL) according an embodiment of the invention that includes layers of adhesive. Arrows A and B indicate steps in the process.

FIG. 4A is a schematic flow diagram illustrating the process of producing a one-sided flexible copper-clad laminate (FCCL) according to one embodiment of the invention that omits an adhesive layer. Arrows A and B indicate steps in the process.

FIG. 4B is a schematic flow diagram illustrating the process of producing a one-sided flexible copper-clad laminate (FCCL) according an embodiment of the invention that excludes layers of adhesive. Arrows A and B indicate steps in the process.

### DETAILED DESCRIPTION

It is to be understood that both the foregoing general description and the following detailed description are exemplary and explanatory only and are not restrictive of the invention claimed. As used herein, the use of the singular includes the plural unless specifically stated otherwise. It is to be understood that as used in the specification and in the claims, “a” or “an” can mean one or more, depending upon the context in which it is used. Thus, reference to “a compound” can mean that at least one compound molecule is used, but typically refers to a plurality of compound molecules, which may be the same or different species. For example, “a compound having a structure according to the following Formula I” can refer to a single molecule or a plurality of molecules encompassed by the formula, as well all or a subset of the species the formula describes. As used herein, “or” means “and/or” unless stated otherwise. Furthermore, use of the term “including” as well as other forms, such as “includes,” and “included,” is not limiting.

The section headings used herein are for organizational purposes only and are not to be construed as limiting the subject matter described.

Unless specific definitions are provided, the nomenclatures utilized in connection with, and the laboratory procedures and techniques of analytical chemistry, synthetic organic and inorganic chemistry described herein are those known in the art, such as those set forth in “IUPAC Compendium of Chemical Terminology: IUPAC Recommendations (The Gold Book)” (McNaught ed.; International Union of Pure and Applied Chemistry, 2^{nd} Ed., 1997) and “Compendium of Polymer Terminology and Nomenclature: IUPAC Recommendations 2008” (Jones et al., eds; International Union of Pure and Applied Chemistry, 2009). Standard chemical symbols are used interchangeably with the full names represented by such symbols. Thus, for example, the terms “hydrogen” and “H” are understood to have identical meaning. Standard techniques may be used for chemical syntheses, chemical analyses, and formulation.

### Definitions

“About” as used herein, means that a number referred to as “about” comprises the recited number plus or minus 1-10% of that recited number. For example, “about” 100 degrees can mean 95-105 degrees or as few as 99-101 degrees depending on the situation. Whenever it appears herein, a numerical range such as “1 to 20” refers to each integer in the given range; e.g., “1 to 20 carbon atoms” means that an alkyl group can contain only 1 carbon atom, 2 carbon atoms, 3 carbon atoms, etc., up to and including 20 carbon atoms (although the term “alkyl” also includes instances where no numerical range of carbon atoms is designated). Where “about” modifies a range expressed in non-integers, it means the recited number plus or minus 1-10% to the same degree of significant figures expressed. For example, about 1.50 to 2.50 mM can mean as little as 1.35 mM or as much as 2.75 mM or any amount in between in increments of 0.01. Where a range described herein includes decimal values, such as “1.2% to 10.5%”, the range refers to each decimal value of the smallest increment indicated in the given range; e.g. “1.2% to 10.5%” means that the percentage can be 1.2%, 1.3%, 1.4%, 1.5%, etc. up to and including 10.5%; while “1.20% to 10.50%” means that the percentage can be 1.20%, 1.21%, 1.22%, 1.23%, etc. up to and including 10.50%.

As used herein, the term “substantially” refers to a great extent or degree. More specifically, “substantially all” or equivalent expressions, typically refers to at least about 90%, frequently at least about 95%, often at least 99%, and more often at least about 99.9%. “Not substantially” refers to less than about 10%, frequently less than about 5%, and often less than about 1% such as less than 5%, less than 4%, less than 3%, less than 2%, or less than 1%. “Substantially free” or equivalent expressions, typically refers to less than about 10%, frequently less than about 5%, often less than about 1%, and in certain aspects less than about 0.1%.

“Adhesive” or “adhesive compound” as used herein, refers to any substance that can adhere or bond two items together. Implicit in the definition of an “adhesive composition” or “adhesive formulation” is the fact that the composition or formulation is a combination or mixture of more than one species, component or compound, which can include adhesive monomers, oligomers, and/or polymers along with other materials, whereas an “adhesive compound” refers to a single species, such as an adhesive polymer or oligomer.

More specifically, adhesive composition refers to un-cured mixtures in which the individual components in the mixture retain the chemical and physical characteristics of the original individual components of which the mixture is made. Adhesive compositions are typically malleable and may be liquids, pastes, gels, films or another form that can be applied to an item so that it can be bonded to another item.

“Cured adhesive,” “cured adhesive composition” or “cured adhesive compound” refers to adhesive components and mixtures obtained from reactive curable original compounds or mixtures thereof which have undergone a chemical and/or physical changes such that the original compounds or mixtures are transformed into a solid, substantially non-flowing material. A typical curing process may involve crosslinking.

“Curable” means that an original compounds or composition can be transformed into a solid, substantially non-flowing material by means of chemical reaction, crosslinking, radiation crosslinking, or a similar process. Thus, adhesive compounds and compositions of the invention are curable, but unless otherwise specified, the original compounds and compositions are not cured.

As used herein, terms “functionalize”, “functionalized” and “functionalization” refer to the addition or inclusion of a moiety (“functional moiety” or “functional group”) to a molecule that imparts a specific property, often the ability of the functional group to react with other molecules in a predictable and/or controllable way. In certain embodiments of the invention, functionalization is imparted to a terminus of the molecule through the addition or inclusion of a terminal group, X. In other embodiments, internal and/or pendant functionalization can be included in the polyimides of the invention. In some aspects of the invention, the functional group is a “curable group” or “curable moiety”, which is a group or moiety that allows the molecule to undergo a chemical and/or physical change such that the original molecule is transformed into a solid, substantially non-flowing material. “Curable groups” or “curable moieties” may facilitate crosslinking.

“Thermoplastic”, as used herein, refers to the ability of a compound, composition or other material (e.g. a plastic) to dissolve in a suitable solvent or to melt to a liquid when heated and to freeze to a solid, often brittle and glassy, state when cooled sufficiently.

“Thermoset”, as used herein, refers to the ability of a compound, composition or other material, to irreversibly “cure”, resulting in a single three-dimensional network that has greater strength and less solubility compared to the un-cured material. Thermoset materials are typically polymers that may be cured, for example, through heat (e.g. above 200° C.), via a chemical reaction (e.g. epoxy ring-opening, free-radical polymerization) or through irradiation (with e.g., visible light, UV light, electron beam radiation, ion-beam radiation, or X-ray irradiation).

Thermoset materials, such as thermoset polymers are resins, are typically liquid or malleable forms prior to curing, and therefore may be molded or shaped into their final form, and/or used as adhesives. Curing transforms the thermoset resin into a rigid, infusible and insoluble solid or rubber by a cross-linking process. Energy and/or catalysts are typically added to the uncured thermoset that cause the thermoset molecules to react at chemically active sites (e.g., unsaturated or epoxy sites), thereby linking the thermoset molecules into a rigid, 3-dimensional structure. The cross-linking process forms molecules with higher molecular weight and resulting higher melting point. During the reaction, when the molecular weight of the polymer has increased to a point such that the melting point is higher than the surrounding ambient temperature, the polymer becomes a solid material.

“Cross-linking,” as used herein, refers to the attachment of two or more oligomer or longer polymer chains by bridges of an element, a molecular group, a compound, or another oligomer or polymer. Crosslinking may take place upon heating or exposure to light; some crosslinking processes may also occur at room temperature or a lower temperature. As cross-linking density is increased, the properties of a material can be changed from thermoplastic to thermosetting.

As used herein, “B-stageable” refers to the properties of an adhesive having a first solid phase followed by a tacky rubbery stage at elevated temperature, followed by yet another solid phase at an even higher temperature. The transition from the tacky rubbery stage to the second solid phase is thermosetting. However, prior to thermosetting, the material behaves similarly to a thermoplastic material. Thus, such adhesives allow for low lamination temperatures while providing high thermal stability.

The term “photoimageable”, as used herein, refers to the ability of a compound or composition to be selectively cured only in areas exposed to light. The exposed areas of the compound are thereby rendered cured and insoluble, while the unexposed area of the compound or composition remains un-cured and therefore soluble in a developer solvent. Typically, this operation is conducted using ultraviolet light as the light source and a photomask as the means to define where the exposure occurs. The selective patterning of dielectric layers on a silicon wafer can be carried out in accordance with various photolithographic techniques known in the art. In one method, a photosensitive polymer film is applied over the desired substrate surface and dried. A photomask containing the desired patterning information is then placed in close proximity to the photoresist film. The photoresist is irradiated through the overlying photomask by one of several types of imaging radiation including UV light, e-beam electrons, x-rays, or ion beam. Upon exposure to the radiation, the polymer film undergoes a chemical change (cross-links) with concomitant changes in solubility. After irradiation, the substrate is soaked in a developer solution that selectively removes the non-cross-linked or unexposed areas of the film.

The term “monomer” refers to a molecule that can undergo polymerization or copolymerization thereby contributing constitutional units to the essential structure of a macromolecule (i.e., a polymer).

The term “pre-polymer” refers to a monomer or combination of monomers that have been reacted to a molecular mass state intermediate between that of the monomer and higher molecular weight polymers. Pre-polymers are capable of further polymerization via reactive groups they contain, to a fully cured high molecular weight state. Mixtures of reactive polymers with un-reacted monomers may also be referred to a “resin”. The term “resin”, as used herein, refers to a substance containing pre-polymers, typically with reactive groups. In general, resins are pre-polymers of a single type or class, such as epoxy resins and bismaleimide resins.

“Polymer” and “polymer compound” are used interchangeably herein, to refer generally to the combined products of a single chemical polymerization reaction. Polymers are produced by combining monomer subunits into a covalently bonded chain. Polymers that contain only a single type of monomer are known as “homopolymers,” while polymers containing a mixture of two or more different monomers are known as “copolymers”.

The term “copolymers” includes products that are obtained by copolymerization of two monomer species, those obtained from three monomers species (terpolymers), those obtained from four monomers species (quaterpolymers), and those obtained from five or more monomer species. It is well known in the art that copolymers synthesized by chemical methods include, but are not limited to, molecules with the following types of monomer arrangements:
alternating copolymers, which contain regularly alternating monomer residues;
periodic copolymers, which have monomer residue types arranged in a repeating sequence;
random copolymers, which have a random sequence of monomer residue types;
statistical copolymers, which have monomer residues arranged according to a known statistical rule;
block copolymers, which have two or more homopolymer subunits linked by covalent bonds. The blocks of homopolymer within block copolymers, for example, can be of any length and can be blocks of uniform or variable length. Block copolymers with two or three distinct blocks are called diblock copolymers and triblock copolymers, respectively; and
star copolymers, which have chains of monomer residues having different constitutional or configurational features that are linked through a central moiety.

The skilled artisan will appreciate that a single copolymer molecule may have different regions along its length that can be characterized as an alternating, periodic, random, etc. A copolymer product of a chemical polymerization reaction may contain individual polymeric molecules and fragments that each differ in the arrangement of monomer units. The skilled artisan will further be knowledgeable in methods for synthesizing each of these types of copolymers, and for varying reaction conditions to favor one type over another.

Furthermore, the length of a polymer chain according to the present invention will typically vary over a range or average size produced by a particular reaction. The skilled artisan will be aware, for example, of methods for controlling the average length of a polymer chain produced in a given reaction and also of methods for size-selecting polymers after they have been synthesized.

Unless a more restrictive term is used, “polymer” is intended to encompass homopolymers, and copolymers having any arrangement of monomer subunits as well as copolymers containing individual molecules having more than one arrangement. With respect to length, unless otherwise indicated, any length limitations recited for the polymers described herein are to be considered averages of the lengths of the individual molecules in polymer.

“Thermoplastic elastomer” or “TPE”, as used herein refers to a class of copolymers that consist of materials with both thermoplastic and elastomeric properties.

“Hard blocks” or “hard segments” as used herein refer to a block of a copolymer (typically a thermoplastic elastomer) that is hard at room temperature by virtue of a high melting point (Tm) or T_{g}. By contrast, “soft blocks” or “soft segments” have a T_{g} below room temperature.

As used herein, “oligomer” or “oligomeric” refers to a polymer having a finite and moderate number of repeating monomers structural units. Oligomers of the invention typically have 2 to about 100 repeating monomer units; frequently 2 to about 30 repeating monomer units; and often 2 to about 10 repeating monomer units; and usually have a molecular weight up to about 3,000.

The skilled artisan will appreciate that oligomers and polymers may, depending on the availability of polymerizable groups or side chains, subsequently be incorporated as monomers in further polymerization or crosslinking reactions.

As used herein, “aliphatic” refers to any alkyl, alkenyl, cycloalkyl, or cycloalkenyl moiety.

“Aromatic hydrocarbon” or “aromatic” as used herein, refers to compounds having one or more benzene rings.

“Alkane,” as used herein, refers to saturated straight chain, branched or cyclic hydrocarbons having only single bonds. Alkanes have general formula CₙH₂ₙ₊₂.

“Cycloalkane,” refers to an alkane having one or more rings in its structure.

As used herein, “alkyl” refers to straight or branched chain hydrocarbyl groups having from 1 up to about 500 carbon atoms. “Lower alkyl” refers generally to alkyl groups having 1 to 6 carbon atoms. The terms “alkyl” and “substituted alkyl” include, respectively, substituted and unsubstituted C₁-C₅₀₀ straight chain saturated aliphatic hydrocarbon groups, substituted and unsubstituted C₂-C₂₀₀ straight chain unsaturated aliphatic hydrocarbon groups, substituted and unsubstituted C₄-C₁₀₀ branched saturated aliphatic hydrocarbon groups, substituted and unsubstituted C₁-C₅₀₀ branched unsaturated aliphatic hydrocarbon groups.

For example, the definition of “alkyl” includes but is not limited to: methyl (Me), ethyl (Et), propyl (Pr), butyl (Bu), pentyl, hexyl, heptyl, octyl, nonyl, decyl, undecyl, ethenyl, propenyl, butenyl, pentenyl, hexenyl, heptenyl, octenyl, nonenyl, decenyl, undecenyl, isopropyl (i-Pr), isobutyl (i-Bu), tert-butyl (t-Bu), sec-butyl (s-Bu), isopentyl, neopentyl, cyclopropyl, cyclobutyl, cyclopentyl, cyclohexyl, cycloheptyl, cyclooctyl, cyclopentenyl, cyclohexenyl, cycloheptenyl, cyclooctenyl, methylcyclopropyl, ethylcyclohexenyl, butenylcyclopentyl, tricyclodecyl, adamantyl, and norbornyl.

“Substituted” refers to compounds and moieties bearing substituents that include but are not limited to alkyl (e.g. C₁₋₁₀ alkyl), alkenyl, alkynyl, hydroxy, oxo, alkoxy, mercapto, cycloalkyl, substituted cycloalkyl, heterocyclic, substituted heterocyclic, aryl, substituted aryl (e.g., aryl C₁₋₁₀ alkyl or aryl C₁₋₁₀ alkyloxy), heteroaryl, substituted heteroaryl (e.g., heteroarylC₁₋₁₀ alkyl), aryloxy, C₁₋₁₀ alkyloxy C₁₋₁₀ alkyl, aryl C₁₋₁₀ alkyloxyC₁₋₁₀ alkyl, C₁₋₁₀ alkylthioC₁₋₁₀ alkyl, aryl C₁₋₁₀ alkylthio C₁₋₁₀ alkyl, C₁₋₁₀ alkylamino C₁₋₁₀ alkyl, aryl C₁₋₁₀ alkylamino C₁₋₁₀ alkyl, N-aryl-N—C₁₋₁₀ alkylamino C₁₋₁₀ alkyl, C₁₋₁₀ alkylcarbonyl C₁₋₁₀ alkyl, aryl C₁₋₁₀ alkylcarbonyl C₁₋₁₀ alkyl, C₁₋₁₀ alkylcarboxy C₁₋₁₀ alkyl, aryl C₁₋₁₀ alkylcarboxy C₁₋₁₀ alkyl, C₁₋₁₀ alkylcarbonylamino C₁₋₁₀ alkyl, and aryl C₁₋₁₀ alkylcarbonylamino C₁₋₁₀ alkyl, substituted aryloxy, halo, haloalkyl (e.g., trihalomethyl), cyano, nitro, nitrone, amino, amido, carbamoyl, ═O, ═CH—, —C(O)H, —C(O)O—, —C(O)—, —S—, —S(O)₂, —OC(O)—O—, —NR—C(O), —NR—C(O)—NR, —OC(O)—NR, where R is H or lower alkyl, acyl, oxyacyl, carboxyl, carbamate, sulfonyl, sulfonamide, sulfuryl, C₁₋₁₀ alkylthio, aryl C₁₋₁₀ alkylthio, C₁₋₁₀ alkylamino, aryl C₁₋₁₀ alkylamino, N-aryl-N—C₁₋₁₀ alkylamino, C₁₋₁₀ alkyl carbonyl, aryl C₁₋₁₀ alkylcarbonyl, C₁₋₁₀ alkylcarboxy, aryl C₁₋₁₀ alkylcarboxy, C₁₋₁₀ alkyl carbonylamino, aryl C₁₋₁₀ alkylcarbonylamino, tetrahydrofuryl, morpholinyl, piperazinyl, and hydroxypyronyl.

In addition, as used herein “C₃₆” and “C₃₆ moiety” refer to all possible structural isomers of a 36-carbon aliphatic moiety, including branched isomers and cyclic isomers with up to three carbon-carbon double bonds in the backbone. One non-limiting example of a C₃₆ moiety is the moiety comprising a cyclohexane-based core and four long “arms” attached to the core, as demonstrated by the following structure:

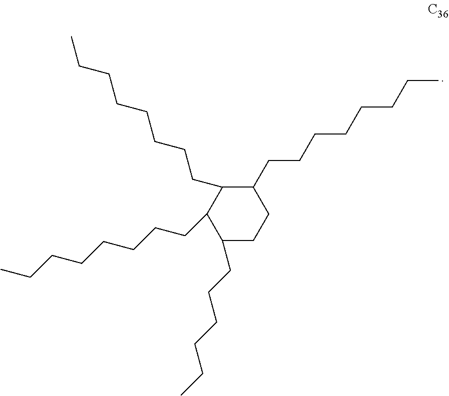 [SMILES: CCCCCCCCC1CCC(CCCCCC)C(CCCCCCCC)C1CCCCCCCC]

As used herein, “cycloalkyl” refers to cyclic ring-containing groups containing about 3 to about 20 carbon atoms, typically 3 to about 15 carbon atoms. In certain embodiments, cycloalkyl groups have about 4 to about 12 carbon atoms, and in yet further embodiments, cycloalkyl groups have about 5 to about 8 carbon atoms. “Substituted cycloalkyl” refers to cycloalkyl groups further bearing one or more substituents as set forth above.

As used herein, the term “aryl” refers to an unsubstituted, mono-, di- or trisubstituted monocyclic, polycyclic, biaryl aromatic groups covalently attached at any ring position capable of forming a stable covalent bond, certain preferred points of attachment being apparent to those skilled in the art (e.g., 3-phenyl, 4-naphtyl and the like). “Substituted aryl” refers to aryl groups further bearing one or more substituents as set forth above.

Specific examples of moieties encompassed by the definition of “aryl” include but are not limited to, phenyl, biphenyl, naphthyl, dihydronaphthyl, tetrahydronaphthyl, indenyl, indanyl, azulenyl, anthryl, phenanthryl, fluorenyl, and pyrenyl.

As used herein, “arylene” refers to a divalent aryl moiety. “Substituted arylene” refers to arylene moieties bearing one or more substituents as set forth above.

As used herein, “alkylaryl” refers to alkyl-substituted aryl groups and “substituted alkylaryl” refers to alkylaryl groups further bearing one or more substituents as set forth above.

As used herein, “arylalkyl” refers to aryl-substituted alkyl groups and “substituted arylalkyl” refers to arylalkyl groups further bearing one or more substituents as set forth below. Examples include, but are not limited to, (4-hydroxyphenyl)ethyl and (2-aminonaphthyl) hexenyl.

As used herein, “arylalkenyl” refers to aryl-substituted alkenyl groups and “substituted arylalkenyl” refers to arylalkenyl groups further bearing one or more substituents as set forth above.

As used herein, “arylalkynyl” refers to aryl-substituted alkynyl groups and “substituted arylalkynyl” refers to arylalkynyl groups further bearing one or more substituents as set forth above.

As used herein, “aroyl” refers to aryl-carbonyl species such as benzoyl and “substituted aroyl” refers to aroyl groups further bearing one or more substituents as set forth above.

As used herein, “hetero” refers to groups or moieties containing one or more non-carbon heteroatoms, such as N, O, Si and S. Thus, for example “heterocyclic” refers to cyclic (i.e., ring-containing) groups having e.g. N, O, Si or S as part of the ring structure, and having 3 to 14 carbon atoms. “Heteroaryl” and “heteroalkyl” moieties are aryl and alkyl groups, respectively, containing e.g. N, O, Si or S as part of their structure. The terms “heteroaryl”, “heterocycle” or “heterocyclic” refer to a monovalent unsaturated group having a single ring or multiple condensed rings, from 1 to 8 carbon atoms and from 1 to 4 hetero atoms selected from nitrogen, sulfur or oxygen within the ring.

The definition of heteroaryl includes but is not limited to thienyl, benzothienyl, isobenzothienyl, 2,3-dihydrobenzothienyl, furyl, pyranyl, benzofuranyl, isobenzofuranyl, 2,3-dihydrobenzofuranyl, pyrrolyl, pyrrolyl-2,5-dione, 3-pyrrolinyl, indolyl, isoindolyl, 3H-indolyl, indolinyl, indolizinyl, indazolyl, phthalimidyl (or isoindoly-1,3-dione), imidazolyl. 2H-imidazolinyl, benzimidazolyl, pyridyl, pyrazinyl, pyradazinyl, pyrimidinyl, triazinyl, quinolyl, isoquinolyl, 4H-quinolizinyl, cinnolinyl, phthalazinyl, quinazolinyl, quinoxalinyl, 1,8-naphthyridinyl, pteridinyl, carbazolyl, acridinyl, phenazinyl, phenothiazinyl, phenoxazinyl, chromanyl, benzodioxolyl, piperonyl, purinyl, pyrazolyl, triazolyl, tetrazolyl, thiazolyl, isothiazolyl, benzthiazolyl, oxazolyl, isoxazolyl, benzoxazolyl, oxadiazolyl, thiadiazolyl, pyrrolidinyl-2,5-dione, imidazolidinyl-2,4-dione, 2-thioxo-imidazolidinyl-4-one, imidazolidinyl-2,4-dithione, thiazolidinyl-2,4-dione, 4-thioxo-thiazolidinyl-2-one, piperazinyl-2,5-dione, tetrahydro-pyridazinyl-3,6-dione, 1,2-dihydro-[1,2,4,5]tetrazinyl-3,6-dione, [1,2,4,5]tetrazinanyl-3,6-dione, dihydro-pyrimidinyl-2,4-dione, pyrimidinyl-2,4,6-trione, 1H-pyrimidinyl-2,4-dione, 5-iodo-1H-pyrimidinyl-2,4-dione, 5-chloro-1H-pyrimidinyl-2,4-dione, 5-methyl-1H-pyrimidinyl-2,4-dione, 5-isopropyl-1H-pyrimidinyl-2,4-dione, 5-propynyl-1H-pyrimidinyl-2,4-dione, 5-trifluoromethyl-1H-pyrimidinyl-2,4-dione, 6-amino-9H-purinyl, 2-amino-9H-purinyl, 4-amino-1H-pyrimidinyl-2-one, 4-amino-5-fluoro-1H-pyrimidinyl-2-one, 4-amino-5-methyl-1H-pyrimidinyl-2-one, 2-amino-1,9-dihydro-purinyl-6-one, 1,9-dihydro-purinyl-6-one, 1H-[1,2,4]triazolyl-3-carboxylic acid amide, 2,6-diamino-N₆-cyclopropyl-9H-purinyl, 2-amino-6-(4-methoxyphenylsulfanyl)-9H-purinyl, 5,6-dichloro-1H-benzoimidazolyl, 2-isopropylamino-5,6-dichloro-1H-benzoimidazolyl, 2-bromo-5,6-dichloro-1H-benzoimidazolyl, and the like.

Furthermore, the term “saturated heterocyclic” refers to an unsubstituted, mono-, di- or trisubstituted monocyclic, polycyclic saturated heterocyclic group covalently attached at any ring position capable of forming a stable covalent bond, certain preferred points of attachment being apparent to those skilled in the art (e.g., 1-piperidinyl, 4-piperazinyl and the like).

Hetero-containing groups may also be substituted. For example, “substituted heterocyclic” refers to a ring-containing group having 3 to 14 carbon atoms that contains one or more heteroatoms and also bears one or more substituents, as set forth above.

Hetero-containing groups may also be substituted. For example, “substituted heterocyclic” refers to a ring-containing group having in the range of 3 up to 14 carbon atoms that contains one or more heteroatoms and bears one or more substituents, as set forth above.

As used herein, the term “phenol” includes compounds having one or more phenolic functions per molecule, as illustrated below:

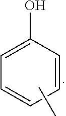

The terms aliphatic, cycloaliphatic and aromatic, when used to describe phenols, refers to phenols to which aliphatic, cycloaliphatic and aromatic residues or combinations of these backbones are attached by direct bonding or ring fusion.

As used herein, “alkenyl,” “alkene” or “olefin” refers to straight or branched chain unsaturated hydrocarbyl groups having at least one carbon-carbon double bond and having about 2 to 500 carbon atoms. In certain embodiments, alkenyl groups have about 5 to about 250 carbon atoms, 5 to about 100 carbon atoms, 5 to about 50 carbon atoms or 5 to about 25 carbon atoms. In other embodiments, alkenyl groups have about 6 to about 500 carbon atoms, 8 to about 500 carbon atoms, 10 to about 500 carbon atoms or 20 to about 500 carbon atoms or 50 to about 500 carbon atoms. In yet further embodiments, alkenyl groups have about 6 to about 100 carbon atoms, 10 to about 100 carbon atoms, 20 to about 100 carbon atoms or 50 to about 100 carbon atoms, while in other embodiments, alkenyl groups have about 6 to about 50 carbon atoms, 6 to about 25 carbon atoms, 10 to about 50 carbon atoms, or 10 to about 25 carbon atoms. “Substituted alkenyl” refers to alkenyl groups further bearing one or more substituents as set forth above.

As used herein, “alkylene” refers to a divalent alkyl moiety, and “oxyalkylene” refers to an alkylene moiety containing at least one oxygen atom instead of a methylene (CH₂) unit. “Substituted alkylene” and “substituted oxyalkylene” refer to alkylene and oxyalkylene groups further bearing one or more substituents as set forth above.

As used herein, “alkynyl” refers to straight or branched chain hydrocarbyl groups having at least one carbon-carbon triple bond and having 2 to about 100 carbon atoms, typically about 4 to about 50 carbon atoms, and frequently about 8 to about 25 carbon atoms. “Substituted alkynyl” refers to alkynyl groups further bearing one or more substituents as set forth below.

As used herein, “oxiranylene or “epoxy” refer to divalent moieties having the structure:

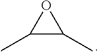

The term “epoxy” also refers to thermosetting epoxide polymers that cure by polymerization and crosslinking when mixed with a catalyzing agent or “hardener,” also referred to as a “curing agent” or “curative.” Epoxies of the present invention include, but are not limited to aliphatic, cycloaliphatic, glycidyl ether, glycidyl ester, glycidyl amine epoxies, and the like, and combinations thereof.

As used herein, “acyl” refers to alkyl-carbonyl species.

As used herein, the term “oxetane” refers to a compound bearing at least one moiety having the structure:

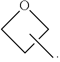

“Allyl” as used herein, refers to refers to a compound bearing at least one moiety having the structure:

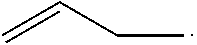

As used herein, “vinyl ether” refers to a compound bearing at least one moiety having the structure:

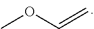

As used herein, the term “vinyl ester” refers to a compound bearing at least one moiety having the structure:

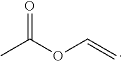

As used herein, “styrene” and “styrenic” refer to compound bearing at least one moiety having the structure:

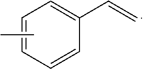

“Fumarate” as used herein, refers to a compound bearing at least one moiety having the structure:

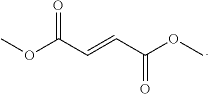

“Propargyl” as used herein, refers to a compound bearing at least one moiety having the structure:

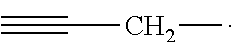

“Cyanate ester” as used herein, refers to a compound bearing at least one moiety having the structure:

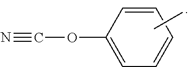

As used herein, “norbornyl” refers to a compound bearing at least one moiety having the structure:

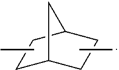

“Imide” as used herein, refers to a functional group having two carbonyl groups bound to a primary amine or ammonia. The general formula of an imide of the invention is:

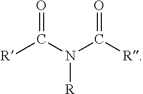

“Polyimides” are polymers of imide-containing monomers. Polyimides are typically linear or cyclic. Non-limiting examples of linear and cyclic (e.g. an aromatic heterocyclic polyimide) polyimides are shown below for illustrative purposes.

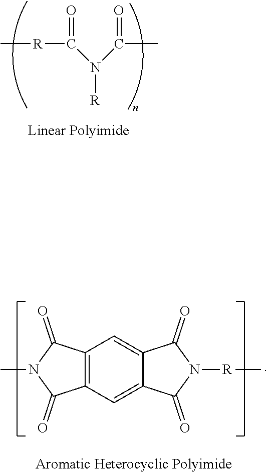

“Maleimide,” as used herein, refers to an N-substituted maleimide having the formula as shown below:

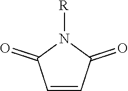

where R is an aromatic, heteroaromatic, aliphatic, or polymeric moiety.

“Bismaleimide” or “BMI”, as used herein, refers to compound in which two imide moieties are linked by a bridge, i.e. a compound a polyimide having the general structure shown below:

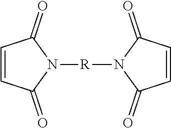

where R is an aromatic, heteroaromatic, aliphatic, or polymeric moiety.

BMIs can cure through an addition rather than a condensation reaction, thus avoiding problems resulting from the formation of volatiles. BMIs can be cured by a vinyl-type polymerization of a pre-polymer terminated with two maleimide groups.

As used herein, the term “acrylate” refers to a compound bearing at least one moiety having the structure:

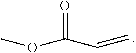

As used herein, the term “acrylamide” refers to a compound bearing at least one moiety having the structure:

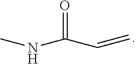

As used herein, the term “methacrylate” refers to a compound bearing at least one moiety having the structure:

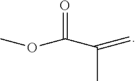

As used herein, the term “methacrylamide” refers to a compound bearing at least one moiety having the structure:

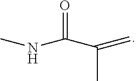

As used herein, “maleate” refers to a compound bearing at least one moiety having the structure:

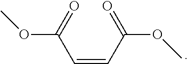

As used herein, the terms “citraconimide” and “citraconate” refer to a compound bearing at least one moiety having the structure:

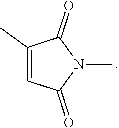

“Itaconimide” and “itaconate”, as used herein, refer to a compound bearing at least one moiety having the structure:

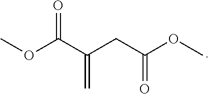

As used herein, “benzoxazine” refers to moieties including the following bicyclic structure:

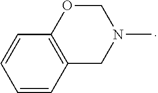

As used herein, the term “acyloxy benzoate” or “phenyl ester” refers to a compound bearing at least one moiety having the structure:

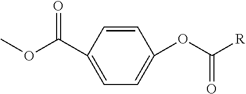

where R is H, lower alkyl, or aryl.

As used herein, the terms “halogen,” “halide,” or “halo” include fluorine, chlorine, bromine, and iodine.

As used herein, “siloxane” refers to any compound containing a Si—O moiety. Siloxanes may be either linear or cyclic. In certain embodiments, siloxanes of the invention include 2 or more repeating units of Si—O. Exemplary cyclic siloxanes include hexamethylcyclotrisiloxane, octamethylcyclotetrasiloxane, decamethylcyclopentasiloxane, dodecamethylcyclohexasiloxane and the like.

As used herein, a “primary amine terminated difunctional siloxane bridging group” refers to a moiety having the structural formula:

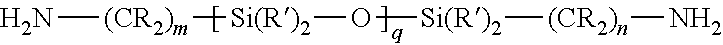

where each R is H or Me, each R′ is independently H, lower alkyl, or aryl; each of m and n is an integer having the value between 1 to about 10, and q is an integer having the value between 1 and 100.

As used herein, the term “free radical initiator” refers to any chemical species which, upon exposure to enough energy (e.g., light, heat, or the like), decomposes into parts, which are uncharged, but every one of such part possesses at least one unpaired electron.

“Photoinitiation” as used herein, refers to polymerization initiated by light. In most cases, photoinduced polymerization, utilizes initiators to generate radicals, which can be one of two types: “Type I Photoinitiators” (unimolecular photoinitiators), which undergo homolytic bond cleavage upon absorption of light; and “Type II Photoinitiators” (bimolecular photoinitiators), consisting of a photoinitiator such as benzophenone or thioxanthone and a coinitiator such as alcohol or amine.

As used herein, the term “coupling agent” refers to chemical species that are capable of bonding to a mineral surface and which also contain polymerizably reactive functional group(s) to enable interaction with the adhesive composition. Coupling agents thus facilitate linkage of the die-attach paste to the substrate to which it is applied.

“Diamine,” as used herein, refers generally to a compound or mixture of compounds, where each species has 2 amine groups.

“Anhydride” as used herein, refers to a compound bearing at least one moiety having the structure:

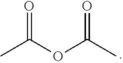

“Dianhydride,” as used herein, refers generally to a compound or mixture of compounds, where each species has 2 anhydride groups.

The term “solvent,” as used herein, refers to a liquid that dissolves a solid, liquid, or gaseous solute, resulting in a solution. “Co-solvent” refers to a second, third, etc. solvent used with a primary solvent.

As used herein, “polar protic solvents” are solvents that contain an O—H or N—H bond, while “polar aprotic solvents” do not contain an O—H or N—H bond.

“Glass transition temperature” or “T_{g}”, is used herein to refer to the temperature at which an amorphous solid, such as a polymer, becomes brittle on cooling, or soft on heating. More specifically, it defines a pseudo second order phase transition in which a supercooled melt yields, on cooling, a glassy structure and properties similar to those of crystalline materials e.g. of an isotropic solid material.

“Low glass transition temperature” or “Low T_{g}” as used herein, refers to a T_{g} at or below about 50° C. “High glass transition temperature” or “High T_{g}” as used herein, refers to a T_{g} of at least about 60° C., at least about 70° C., at least about 80° C., at least about 100° C. “Very high glass transition temperature” and “very high T_{g}” as used herein, refers to a T_{g} of at least about 150° C., at least about 175° C., at least about 200° C., at least about 220° C. or higher. High glass transition temperature compounds and compositions of the invention typically have a T_{g} in the range of about 70° C. to about 300° C.

“Modulus” or “Young's modulus” as used herein, is a measure of the stiffness of a material. Within the limits of elasticity, modulus is the ratio of the linear stress to the linear strain, which can be determined from the slope of a stress-strain curve created during tensile testing.

The “Coefficient of Thermal Expansion” or “CTE” is a term of art describing a thermodynamic property of a substance. The CTE relates a change in temperature to the change in a material's linear dimensions. As used herein “α₁ CTE” or “α₁” refers to the CTE before the T_{g}, while “α₂ CTE” refers to the CTE after the T_{g}.

“Low Coefficient of Thermal Expansion” or “Low CTE” as used herein, refers to an CTE of less than about 50 ppm/° C., typically less than about 30 ppm/° C. or less than about 10 ppm/° C.

“Thermogravimetric analysis” or “TGA” refers to a method of testing and analyzing a material to determine changes in weight of a sample that is being heated in relation to change in temperature.

“Decomposition onset” or “Td” refers to a temperature when the loss of weight in response to the increase of the temperature indicates that the sample is beginning to degrade. “Td (5%)” is the temperature at which 5% of sample has degraded. When measured in an air environment “air” is typically noted in the Td (5%) abbreviation such as “Td (5%), air”.

“Breakdown voltage”, as used herein, refers to the minimum voltage that causes a portion of an insulator to become electrically conductive. “High breakdown voltage” is at least about 100 V to at least about 900 V, such as 200V, 300V, 400V, 500V, 600V, 700V, 800V, 900V, 1,000V or higher.

“Electric power” is the rate, per unit time, at which electrical energy is transferred by an electric circuit. It is the rate of doing work. In electric circuits, power is measured in Watts (W) and is a function of both voltage and current:

P=IE

where P=power (in watts); I=current (in amperes) and E=voltage (in volts). Since Electric power generally generates heat “high power” is often used to refer to devices and applications that generate heat in excess of 100° C.

“High frequency” or “HF”, as used herein, refers to the range of radio frequency electromagnetic waves between 3 and 30 megahertz (MHz).

“Dielectric”, as used herein, refers to an insulating material that has the property of transmitting electric force without conduction. When a dielectric material is placed in an electric field, electric charges do not flow through the material as they do in an electrical conductor but only slightly shift from their average equilibrium positions causing dielectric polarization. Because of dielectric polarization, positive charges are displaced in the direction of the field and negative charges shift in the direction opposite to the field. This creates an internal electric field that reduces the overall field within the dielectric itself.

As used herein the term “dielectric constant”, “relative permittivity”, and abbreviation “Dk”, is the ratio of the permittivity (a measure of electrical resistance) of a substance to the permittivity of free space (which is given a value of 1). In simple terms, the lower the Dk of a material, the better it will act as an insulator. As used herein, “low dielectric constant” refers to materials with a Dk less than that of silicon dioxide, which has Dk of 3.9. Thus, “low dielectric constant refers” to a Dk of less than 3.9, typically, less than about 3.5, and most often less than about 3.0.

As used herein the term “dissipation dielectric factor”, “dissipation dielectric constant”, and abbreviation “Df” are used herein to refer to a measure of loss-rate of energy in a thermodynamically open, dissipative system. In simple terms, Df is a measure of how inefficient the insulating material of a capacitor is. It typically measures the heat that is lost when an insulator such as a dielectric is exposed to an alternating field of electricity. The lower the Df of a material, the better its efficiency. “Low dissipation dielectric factor” typically refers to a Df of less than about 0.01 at 1 GHz frequency, frequently less than about 0.005 at 1 GHz frequency, and most often 0.001 or lower at 1 GHz frequency.

“Low-loss” and “ultra-low loss” PCBs are those that require dielectric materials with Df value of less than 0.0025. All printed circuit board (PCB) materials exhibit both conduction and dielectric loss. “Low-loss” and “ultra-low loss” PCBs minimize both of these types of losses and typically can only be obtained with dielectric materials with Df value of less than 0.0025. The conduction losses are primarily resistive losses in the conduction layers and leakage of charge through the dielectric. The dielectric losses result from the varying field produced from the alternating electric field causing movement of the material's molecular structure generating heat. Dielectrics are materials that are poor conductors of electric current. They are insulators because they have few free electrons available to carry current. However, when subjected to an electric field, polarization occurs whereby positive and negative charges are displaced relative to the electric field. This polarization reduces the electric field in the dielectric thus causing part of the applied field to be lost. The effect of the polarization or dipole moment in a dielectric is quantified as “loss tangent” and describes the dielectric's inherent dissipation of an applied electric field. The loss tangent derives from the tangent of the phase angle between the resistive and reactive components of a system of complex permittivity. The property is dimensionless and is often referred to a “Loss Factor” “Dissipation Factor” and “Dielectric Loss”.

“Interlayer Dielectric Layer” or “ILD” refer to a layer of dielectric material disposed over a first pattern of conductive traces, separating it from a second pattern of conductive traces, which can be stacked on top of the first. Often, ILD layers are patterned or drilled to provide openings (referred to as “vias”, short for “vertical interconnect access” channels) allowing electrical contact between the first and second patterns of conductive traces in specific regions or in layers of a multilayer printed circuit board. Other regions of such ILD layers are devoid of vias to strategically prevent electrical contact between the conductive traces of first and second patterns or layers.

In electronics, “leakage” is the gradual transfer of electrical energy across a boundary normally viewed as insulating, such as the spontaneous discharge of a charged capacitor, magnetic coupling of a transformer with other components, or flow of current across a transistor in the “off” state or a reverse-polarized diode. Another type of leakage can occur when current leaks out of the intended circuit, instead flowing through some alternate path. This sort of leakage is undesirable because the current flowing through the alternate path can cause damage, fires, RE noise, or electrocution.

“Leakage current” as used herein, refers to the gradual loss of energy from a charged capacitor, primarily caused by electronic devices attached to the capacitor, such as transistors or diodes, which conduct a small amount of current even when they are turned off. “Leakage current” also refers any current that flows when the ideal current is zero. Such is the case in electronic assemblies when they are in standby, disabled, or “sleep” mode (standby power). These devices can draw one or two microamperes while in their quiescent state compared to hundreds or thousands of milliamperes while in full operation. These leakage currents are becoming a significant factor to portable device manufacturers because of their undesirable effect on battery run time for the consumer.

“Thermoplastic”, as used herein, refers to the ability of a compound, composition or other material (e.g. a plastic) to dissolve in a suitable solvent or to melt to a liquid when heated and to freeze to a solid, often brittle and glassy, state when cooled sufficiently.

“Thixotropy” as used herein, refers to the property of a material which enables it to stiffen or thicken in a relatively short time upon standing, but upon agitation or manipulation to change to low-viscosity fluid; the longer the fluid undergoes shear stress, the lower its viscosity. Thixotropic materials are therefore gel-like at rest but fluid when agitated and have high static shear strength and low dynamic shear strength.

“Prepreg” or “pre-preg”, as used herein, refers to a composite material prepared from fibers pre-impregnated with a polymer matrix. Typically, the polymer matrix is partially-cured.

Printed circuit boards are composed of multi-layer copper clad laminates (CCL). The present invention provides compositions with very low dielectric properties are impregnated into glass fabric to make prepregs. Multi-layers of these prepregs can be laminated together under pressure and heat to produce a composite that can be used to make copper clad laminates.

Polyimides with terminal reactive moieties have previously been described (see e.g., U.S. Pat. Nos. 7,884,174; 7,157,587; and 8,513,375). The discovery of imide-extended maleimide compounds in liquid form or as low melting solids has enabled the formulator to use these compounds as additives in a variety of formulations to impart toughness, high temperature resistance, and hydrolysis resistance. Such imide-extended maleimide compounds can be represented according to the following Formula I:

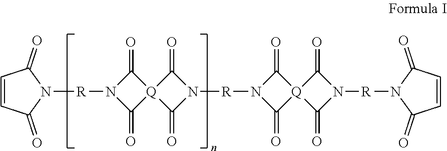

where R is substituted or unsubstituted aliphatic, cycloaliphatic, alkenyl, aromatic, heteroaromatic; Q is substituted or unsubstituted aliphatic, cycloaliphatic, alkenyl, aromatic, heteroaromatic; and n is an integer having the value from 1-10.

The polyimides of the present invention are synthesized by combining a diamine with a (di)anhydride according to the following general Scheme 1, (which depicts an optional end-terminal functionalization with a maleimide group):

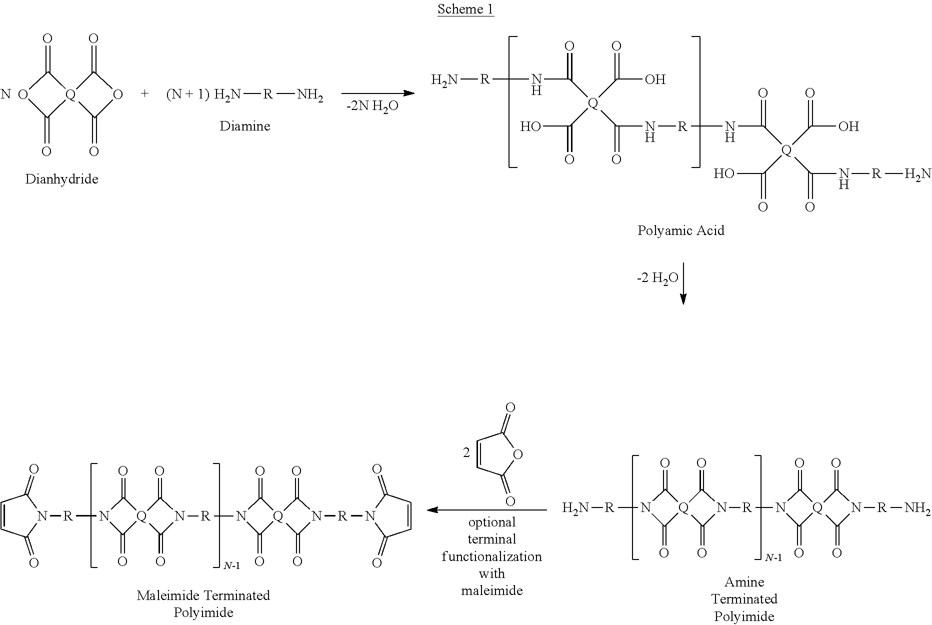

A wide variety of diamines are contemplated for use in the practice of the invention, such as for example, 1,10-diaminodecane; 1,12-diaminododecane; dimer diamine; hydrogenated dimer diamine; 1,2-diamino-2-methylpropane; 1,2-diaminocyclohexane; 1,2-diaminopropane; 1,3-diaminopropane; 1,4-diaminobutane; 1,5-diaminopentane; 1,7-diaminoheptane; 1,8-diaminomenthane; 1,8-diaminooctane; 1,9-diaminononane; 3,3′-diamino-N-methyldipropylamine; diaminomaleonitrile; 1,3-diaminopentane; 9,10-diaminophenanthrene; 4,4′-diaminooctafluorobiphenyl; 3,5-diaminobenzoic acid; 3,7-diamino-2-methoxyfluorene; 4,4′-diaminobenzophenone; 3,4-diaminobenzophenone; 3,4-diaminotoluene; 2,6-diaminoanthroquinone; 2,6-diaminotoluene; 2,3-diaminotoluene; 1,8-diaminonaphthalene; 2,4-diaminotoluene; 2,5-diaminotoluene; 1,4-diaminoanthroquinone; 1,5-diaminoanthroquinone; 1,5-diaminonaphthalene; 1,2-diaminoanthroquinone; 2,4-cumenediamine; 1,3-bisaminomethylbenzene; 1,3-bisaminomethylcyclohexane; 2-chloro-1,4-diaminobenzene; 1,4-diamino-2,5-dichlorobenzene; 1,4-diamino-2,5-dimethylbenzene; 4,4′-diamino-2,2′-bistrifluoromethylbiphenyl; bis(amino-3-chlorophenyl)ethane; bis(4-amino-3,5-dimethylphenyl)methane; bis(4-amino-3,5-diisopropylphenyl)methane; bis(4-amino-3,5-methyl-isopropylphenyl)methane; bis(4-amino-3,5-diethylphenyl)methane; bis(4-amino-3-ethylphenyl)methane; diaminofluorene; 4,4′-(9-Fluorenylidene)dianiline; diaminobenzoic acid; 2,3-diaminonaphthalene; 2,3-diaminophenol; -5-methylphenyl)methane; bis(4-amino-3-methylphenyl)methane; bis(4-amino-3-ethylphenyl)methane; 4,4′-diaminophenylsulfone; 3,3′-diaminophenylsulfone; 2,2-bis(4,-(4-aminophenoxy)phenyl)sulfone; 2,2-bis(4-(3-aminophenoxy)phenyl)sulfone; 4,4′-oxydianiline; 4,4′-diaminodiphenyl sulfide; 3,4′-oxydianiline; 2,2-bis(4-(4-aminophenoxy)phenyl)propane; 1,3-bis(4-aminophenoxy)benzene; 4,4′-bis(4-aminophenoxy)biphenyl; 4,4′-diamino-3,3′-dihydroxybiphenyl; 4,4′-diamino-3,3′-dimethylbiphenyl; 4,4′-diamino-3,3′-dimethoxybiphenyl; Bisaniline M; Bisaniline P; 9,9-bis(4-aminophenyl)fluorene; o-tolidine sulfone; methylene bis(anthranilic acid); 1,3-bis(4-aminophenoxy)-2,2-dimethylpropane; 1,3-bis(4-aminophenoxy)propane; 1,4-bis(4-aminophenoxy)butane; 1,5-bis(4-aminophenoxy)butane; 2,3,5,6-tetramethyl-1,4-phenylenediamine; 3,3′, 5,5′-tetramehylbenzidine; 4,4′-diaminobenzanilide; 2,2-bis(4-aminophenyl)hexafluoropropane; polyoxyalkylenediamines; 1,3-cyclohexanebis(methylamine); m-xylylenediamine; p-xylylenediamine; bis(4-amino-3-methylcyclohexyl)methane; 1,2-bis(2-aminoethoxy)ethane; 3(4),8(9)-bis(aminomethyl)tricyclo(5.2.1.0^{2,6})decane; and any other diamines or polyamines that will be known to those skilled in the art.

A wide variety of anhydrides are contemplated for use in the practice of the invention, such as, for example, polybutadiene-graft-maleic anhydride; polyethylene-graft-maleic anhydride; polyethylene-alt-maleic anhydride; polymaleic anhydride-alt-1-octadecene; polypropylene-graft-maleic anhydride; poly(styrene-co-maleic anhydride); pyromellitic dianhydride; maleic anhydride, succinic anhydride; 1,2,3,4-cyclobutanetetracarboxylic dianhydride; 1,4,5,8-naphthalenetetracarboxylic dianhydride; 3,4,9,10-perylenentetracarboxylic dianhydride; bicyclo(2.2.2)oct-7-ene-2,3,5,6-tetracarboxylic dianhydride; diethylenetriaminepentaacetic dianhydride; ethylenediaminetetraacetic dianhydride; 3,3′, 4,4′-benzophenone tetracarboxylic dianhydride; 3,3′, 4,4′-biphenyl tetracarboxylic dianhydride; 4,4′-oxydiphthalic anhydride; 3,3′, 4,4′-diphenylsulfone tetracarboxylic dianhydride; 2,2′-bis(3,4-dicarboxyphenyl)hexafluoropropane dianhydride; 4,4′-bisphenol A diphthalic anhydride; 5-(2,5-dioxytetrahydro)-3-methyl-3-cyclohexene-1,2-dicarboxylic anhydride; ethylene glycol bis(trimellitic anhydride); hydroquinone diphthalic anhydride; allyl nadic anhydride; 2-octen-1-ylsuccinic anhydride; phthalic anhydride; 1,2,3,6-tetrahydrophthalic anhydride; 3,4,5,6-tetrahydrophthalic anhydride; 1,8-naphthalic anhydride; glutaric anhydride; dodecenylsuccinic anhydride; hexadecenylsuccinic anhydride; hexahydrophthalic anhydride; methylhexahydrophthalic anhydride; tetradecenylsuccinic anhydride; and the like. Inclusion of mono-anhydrides results in the chain termination.

Copper clad laminates used in very high frequency environments, such as radar antenna applications require compositions that have extremely low dielectric dissipation factor, typically under 0.0025 @ 10 GHz. Furthermore, a T_{g} of at least 150° C. to 200° C. is required. Moreover, a low CTE of 20-50 ppm is required.

Many of the maleimide-terminated polyimides have properties, including high thermal stability; low ionic impurities; low dielectric constant; good mechanical properties, and good chemical resistance that make them suitable for high performance applications. Certain compounds have been synthesized that contain groups that have very low Df values (under 0.002) in combination with compounds that have high T_{g} (>150° C.) and low CTE (under 50 ppm) values. The molecular weight of the base resin has also been determined to be very important in these applications. When the molecular weight (MW) is too low (i.e., under 3,000 Daltons), the compositions can be very brittle and difficult to drill or fabricate without chipping. When the MW is too high (i.e., over 15,000 Daltons) the material can be very difficult to dissolve in a suitable solvent and typically produces a very viscous solution that is difficult to impregnate glass cloth.

The diamine used to make the polyimides that been shown to be the best in terms of obtaining low Df values is the dimer diamine. This diamine is a branched aliphatic material with very low polarity and the more that is used in the synthesis the better the Df values get. Unfortunately, this group also tends to dramatically lower the T_{g} of the resin.

We have found that the dimer diamine can be used in certain percentages to help lower the Df value of the polyimide

The curable polyimides of the invention are contemplated for use as a dielectric layer between copper foils, such as in a copper clad laminate.

The invention compositions are contemplated for use in high frequency electronics applications, such as CCL, radar antenna, capacitors, wire coatings and insulators.

The invention formulations may contain reactive additives as well. These can be in solid form or reactive diluent. For examples, various bismaleimide resins, citraconimide resins, benzoxazine resins, reactive ester resins (e.g., cyanate ester resins), phenolic resins, carboxyl resins, tackifier resins, polyphenylene oxide (PPO) resins and polyphenylene ether (PPE) resins, allylic resins, vinyl resins, vinyl ethers resins, vinyl ether resins, acrylic resins, epoxy resins, and combinations thereof, can be added to the formulations to obtain higher T_{g}, lower CTE also help provide tack for increased adhesion to various surfaces.

The following structures are non-limiting examples of reactive additives that are contemplated for use in the practice of the invention:

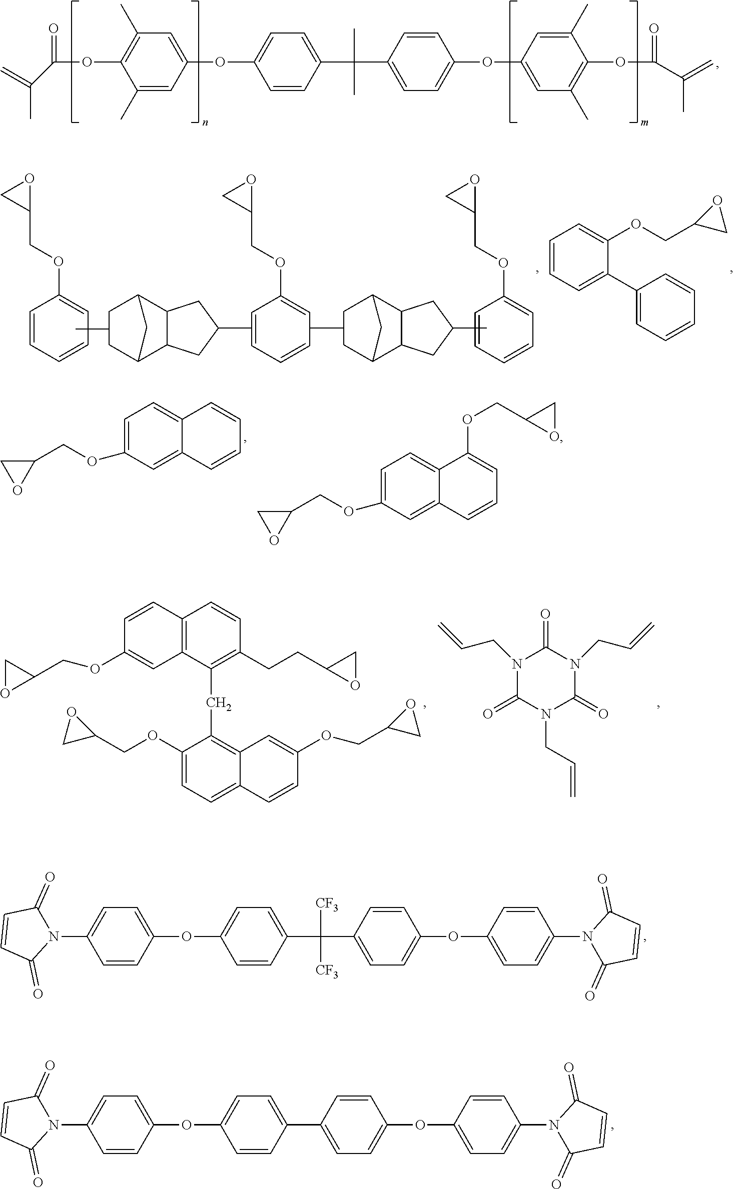

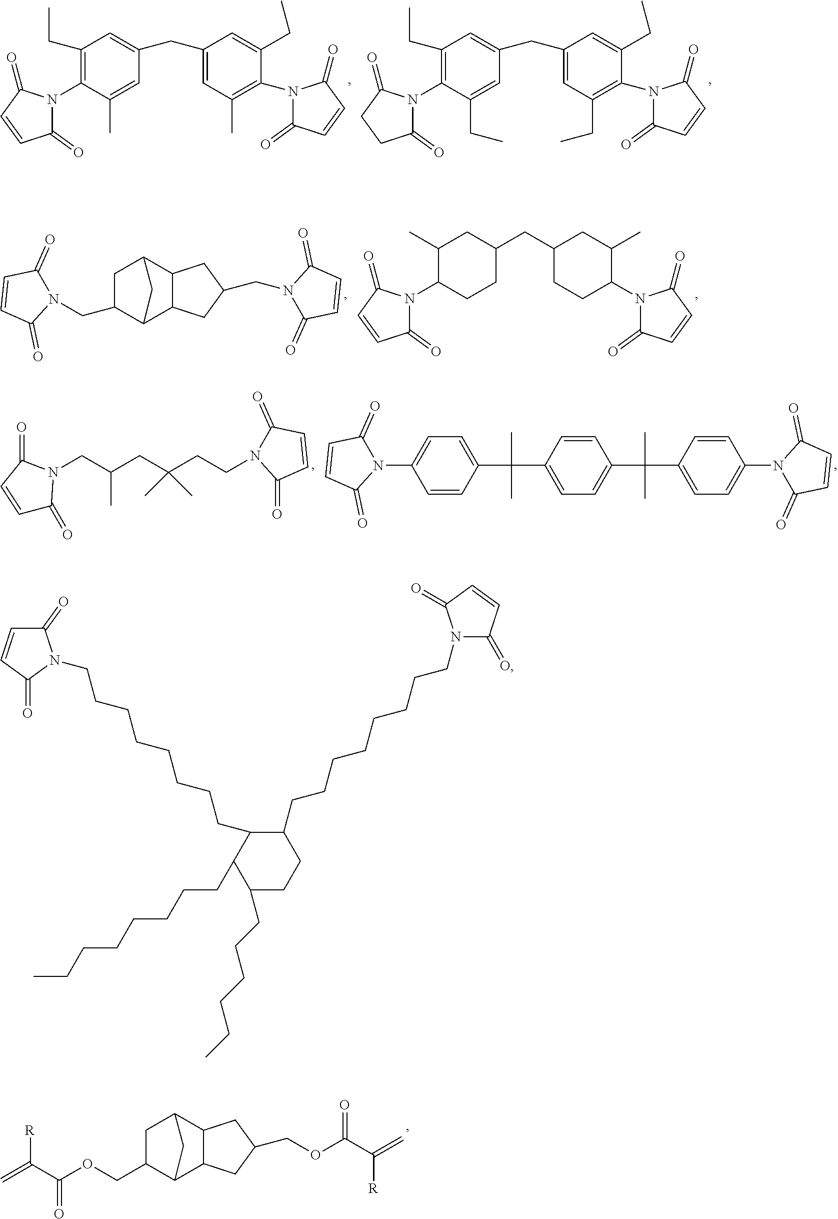

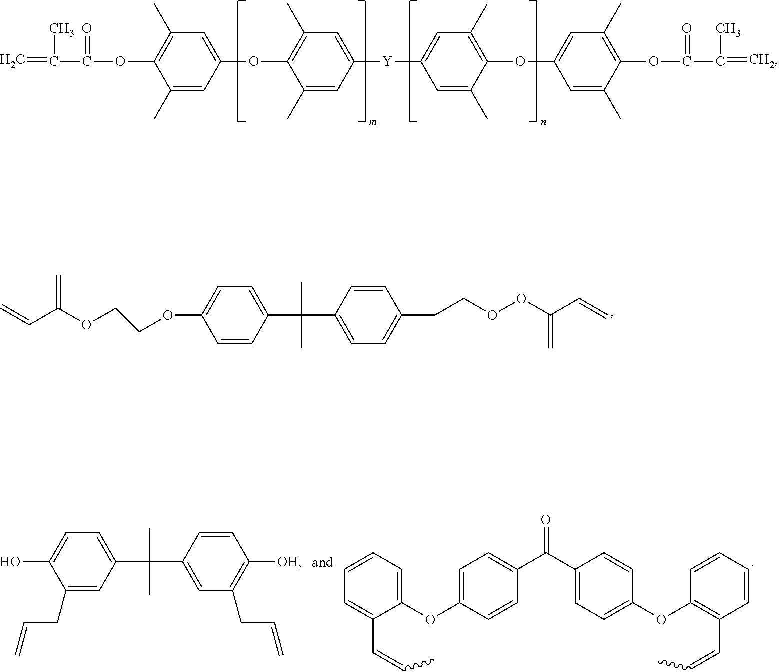

The invention specifically contemplates the inclusion of epoxy resins, anionic initiators and coupling agents in a formulation that can be cured to form a low Dk and low Df dielectric layer and adhesive for laminating copper foil.

In addition, various coupling agents and adhesion promoters may be necessary to obtain adhesion of the said polyimides to various surfaces, typically enhancing the adhesion of the polymeric material to an inorganic substrate. In certain embodiments, the coupling agent is selected from organosilanes, organotitanates, organoboranes, and organozirconates. Coupling agents and adhesion promoters contemplated for use in the practice of the invention include, but are not limited to, silane coupling agents (such as 2-(3,4 epoxycyclohexyl) ethyltrimethoxysilane and N-Phenyl-3-aminopropyltrimethoxysilane), titanium coupling agents, zirconium coupling agents, boranes, reactive anhydrides (e.g., maleated RICON®), salts of fatty acids, and other coupling agents know to the skilled artisan.

In some cases, fire retardants may be necessary to make the product non-flammable. The industry standard is UL94 rating system and a VO flammability rating is desired in many industrial applications. The fire retardants contemplated for use in the practice of the invention include the following non-limiting examples: Various brominated compounds; various metal hydroxides (antimony hydroxide, aluminum hydroxide, magnesium hydroxide); Nitrogen based melamine compounds; and most valuable and readily used phosphorous type flame retardants. The organophosphorus type flame retardants are the most useful. These compounds include but are not limited to compounds such as: triphenyl phosphate; bisphenol-A diphenyl phosphate; tricresylphosphate; dimethyl methyl phosphonate; and aluminum diethyl phosphinate.

Catalyst may be used to increase the rate of polymerization of the invention compounds. These catalysts include, but are not limited to, free-radical generators (such as organic peroxides), anionic initiator catalysts (such as imidazoles), cationic initiator catalysts (such as Lewis acids), and carbenium ion salt catalysts.

Certain fillers may be incorporated into the resin composition solution into which the fibers (e.g. glass fiber fabric) are impregnated. Such fillers include, but are limited to, materials such as silica, polytetrafluoroethylene (PTFE), boron nitride, alumina, graphite and carbon (e.g., carbon nanotubes).

The invention compositions are dissolved in suitable solvents such as aromatic solvents, ketones, ethers, and esters in high concentrations, typically greater than 50% solids. The solution or slurry is then impregnated into certain fabrics and dried to form prepregs. The fabrics contemplated for use in the practice of the invention include but are not limited to the following: quartz glass fabric; carbon fiber; PTFE glass coated fabric; E-glass; S-glass; HDPE fabric (high density polyethylene); Aramid fabric (LMR Kevlar, DuPont) and the like.

The prepregs are then stacked with copper foil on both sides and laminated using pressure and heat to form the composite copper clad laminates. These copper clad laminates are used in the fabrication of printed circuit boards.

### Prepregs, Copper-Clad Laminates and Printed Circuit Boards

The present invention provides compositions and methods for making prepregs (reinforcement fiber pre-impregnated with a resin), copper-clad laminates and printed circuit boards. Also provided are prepregs, copper-clad laminates and printed circuit boards comprising polyimides of the invention.

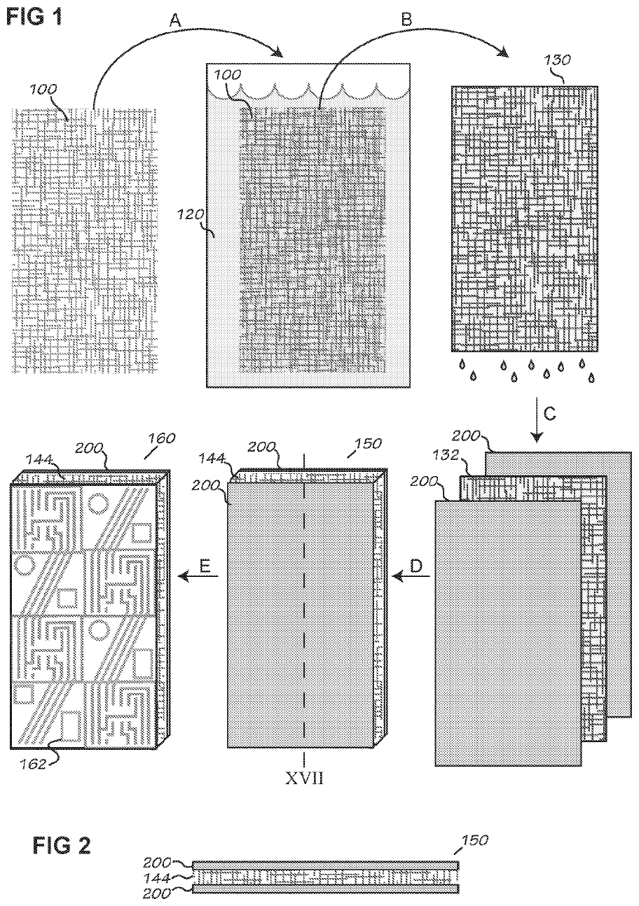

The process for preparing prepregs, copper-clad laminates and printed circuit boards is illustrated in FIG. 1. Steps in the process are indicate by arrows. The process begins with a reinforcing fiber 100 such as, fiberglass or carbon fiber. The fiber can be in the form of a woven or unwoven fabric, or single strands of fiber that will be held together by the polymer. The fiber 100 is immersed in a liquid formulation 120 containing an uncured polyimide compound or composition described herein (step A), thereby impregnating the fiber with the polyimide formulation to form a prepreg. The wet prepreg 130 is then drained and dried to remove solvent (step B). Conveniently, the dried prepreg 132 can then be stored until needed.

The dried prepreg will typically be coated on one or both side with a layer of copper to form a copper-clad laminate (CCL). The copper can be applied by electroplating or by laminating thin copper foil to the prepreg. FIG. 1 illustrates preparation of a double-sided copper-clad laminate using copper foil 200. Thus, in step C, the dried prepreg 132 is assembled in a sandwich fashion with a sheet of copper foil 200 on either side. Optionally, layers of adhesive can be interleaved between the foil to increase adhesion (not shown). This is likely unnecessary because polyimides of the invention have strong adhesive properties. In some embodiments, adhesion promoters can be added to formulation 120 to increase bonding of the foil to the prepreg. In step D, the foil 200 is laminated to the prepreg 132 using heat and pressure. Advantageously, polyimides of the invention can be cured using heat. FIG. 2 shows a cross section of CCL 150 having a central core of fiber-reinforced, cured polyimide 144, laminated to copper foil 200 on each side.

Circuit patterns 162 can then be formed on either or both sides (double-sided CCL) of the CCL 150 by photolithography to from a printed circuit board (PCB). 160. The resulting PCB exhibits the high structural strength and very high thermo-oxidative resistance necessary for contemporary electronics applications.

### Flexible Copper-Clad Laminates

The compounds and compositions of the invention are useful in any application that requires high temperature stability, adhesion and flexibility, such as copper-clad laminates. Copper-clad laminates are materials similar to the fiber-reinforced copper clad laminates shown in FIGs. 1 and 2, which are made from layers of a polymer dielectric material sandwiched between copper foil. In many cases multi-layers of these materials impregnated into glass fiber are laminated together under pressure and heat to produce a composite that can be used to make printed wiring boards.

To make copper-clad laminate a piece of flexible film is typically cut from a large roll of film, adhesive is applied to one or both sides of the film and then copper foil is placed on both sides, this is followed by lamination process using heat and pressure. Alternatively, a solution containing the polymeric materials along with co-reactants can be doctor bladed onto long copper sheet on a conveyor belt and dried or B-staged. A second layer of copper foil is placed on top and laminated between hot rollers. The triple-layer copper-clad laminate can go through an oven curing process or be laminated under pressure and heat to form the product.

In both cased the material during the B-staged process must be flat and flexible. Curling of single sided copper foil is a significant problem to be avoided. Also, a brittle B-staged film is difficult to work with and not desirable in the application.

The invention polyimide material is curable with epoxies and other resins; therefore, it does not require the use of adhesive layers. The invention curable polyimide material is cast from solution to form a thin film that needs to be flexible and rollable. The material is then cut to size and placed between copper foils. Once heated during the lamination process, the material cures and adheres to the copper foil acting as a dielectric layer.

In certain embodiments, the invention polyimide material is flexible enough at the B-staged phase that it does not cause curling of the copper foil. The material on a single side of copper foil once dried, remains flat and allows for a process that is continuous and very manufacturable.

Ideally, an adhesive dielectric film is curable so that is has maximal adhesion to copper surfaces. Curable films achieve the maximal effect of adhesion promoters and coupling agents.

In order to produce a copper-clad laminate from the materials described herein, a continuous thin film of the uncured polyimide is cast; the polyimide is dried and wound into rolls. The rolls of polyimide are then cut to size and sandwiched between copper foils. Multi-layered material can also be prepared, followed by a lamination process under heat and pressure. The heat causes polymerization of the functionalized polyimide and adheres to the copper foil.

In one aspect, of the invention polyimide terminal groups are functionalized with polymerizable moieties, such as maleimide moieties.

Another process for forming copper-clad laminate requires the invention polyimides and formulations in solvent and doctor bladed onto a continuous moving thin copper sheet on a heated conveyor belt. On the continuous line, a second sheet of copper is applied on top of the dried B-staged material, followed by lamination between hot rollers to form a 3-layer copper-clad laminate. Further heating with pressure may be required to obtain a fully cured polymer and to assure high adhesion to both sides of the copper.

In particular, flexible copper-clad laminates (FCCLs) are increasingly used in electronics as they can provide the ultrathin profile demanded by increasing miniaturization. Moreover, circuitry is becoming prevalent in non-traditional situations, such as clothing, where the ability to conform to a three-dimensional shape other than a flat board is required.

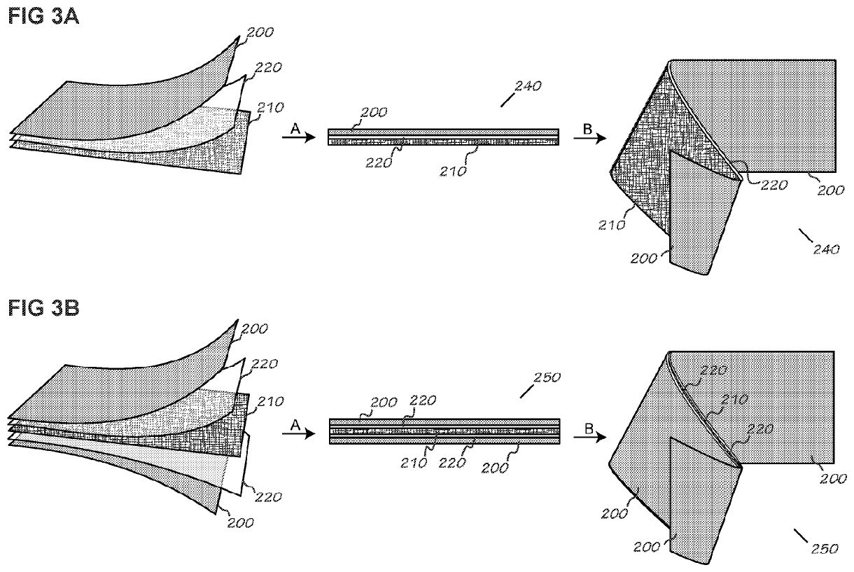

A process of forming FCCLs according to one embodiment of the invention is illustrated in FIGs. 3A and 3B for single- and double-sided FCCLs, respectively. The process is similar to preparing a prepreg-based CCL but is much thinner and lacks the rigidity of a prepreg. A thin and flexible film of polyimide polymer 210 prepared as described herein, is assembled with an adhesive layer 220 and copper foil 200 (FIG. 3A). The assembly is then laminated (step A) to form a single-sided copper-clad laminate 240. The FCCL can then be rolled, bent or formed as needed (step B), while providing the basis for thin, flexible circuitry that can be used in consumer electronics, clothing and other goods.

Double-sided FCCL production according to an embodiment of the invention, is illustrated in FIG. 3B. This process is identical to that illustrated in FIG. 3A, except that the adhesive layer 220 and copper foil 200 are placed on both sides of polymer film 210 to form a 5-layer assembly, which is then laminated (step A) to form a double-sided FCCL 250.

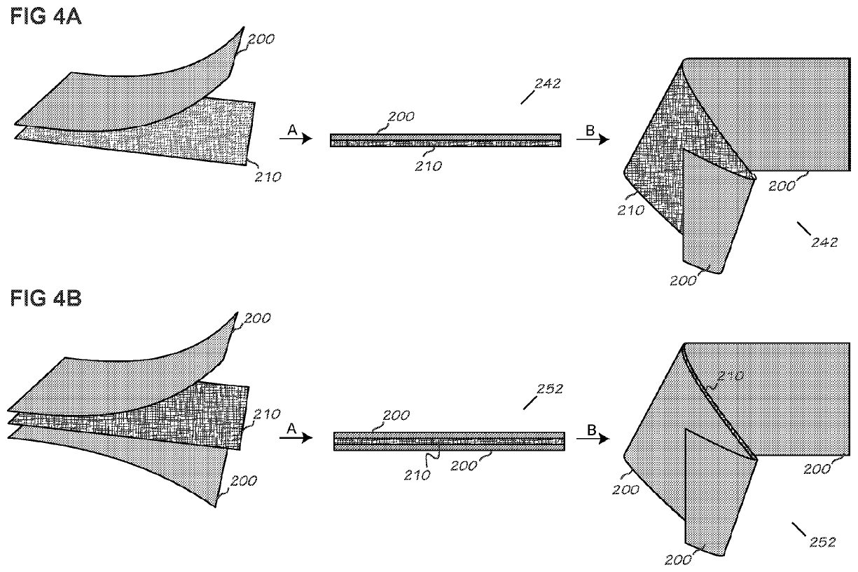

In another embodiment of the invention, adhesiveless processes for producing FCCL are provided as shown in FIGs. 4A and 4B. Single-sided FCCL (FIG. 4A) is prepared by contacting copper foil 200 with one side of a polyimide film 210 prepared as described herein. The film is then heat-cured (step A), onto the foil to form an adhesiveless FCCL 242, which is thinner and more flexible than FCCL that includes an extra layer (i.e., the adhesive layer). The single-sided, adhesiveless FCCL 242 can be rolled, bent, or formed into a desired shape before (step B) or after patterning (not shown).

Double-sided, adhesiveless FCCL can be prepared (FIG. 4B) in the same manner as the single-sided product, except that both sides of film 210 are contacted with foil 200 prior to curing (step B). The double-sided adhesiveless FCCL 252 according to this embodiment of the invention can similarly be rolled, shaped, and formed (step B).

In yet another FCCL embodiment of the invention eliminates the step of forming a polyimide polymer film prior to assembly. Instead, a liquid formulation of the polyimide polymer is applied directly to the copper foil. Application can be by any method known in the art, such as by pouring, dropping, brushing, rolling or spraying, followed by drying and heat-curing. To prepare a double sided FCCL according to this embodiment of the invention, polymer-coated foil is prepared, dried and then a second foil is contacted on the polymer side of the foil prior to curing.

Application of circuit traces to FCCL can be performed using standard photolithography processes developed for patterning printed circuit boards.

### EXAMPLES

### Materials and Methods

### Chemicals, Reagents and Materials.

Anisole was obtained from Kessler Chemicals (Bethlehem, Pa.). Methanol, isopropyl alcohol, acetone, toluene, N-methylpyrollidone (NMP) and heptane were obtained from Gallade Chemicals (Escondido, Calif.). 4,4′-Methylenebis(2,6-diethylaniline); 4,4′-(4,4′-Isopropylidenediphenoxy)-bis(phthalic anhydride) (Bisphenol-A-dianhydride); maleic anhydride; methanesulfonic acid; 1,3,5-Tri-2-propenyl-1,3,5-triazine-2,4,6(1H,3H,5H)-trione (1,3,5-Triallylisocyanurate or TAIC); and dicumyl peroxide (DCP) were obtained from Millipore-Sigma (Burlington, Mass.). PRIAMINE™ 1075 and PRIAMINE™ 1074 were obtained from Croda Chemical Company (Snaith, UK). Octahydro-4,7-Methano-1H-indenedimethylamine (tricyclodecane diamine (TCD-diamine) was obtained from OXEA Chemical Company (Oberhausen, Germany). 3,3′, 4,4′-biphenyl tetracarboxylic dianhydride; 2.2-bis[4-(4-aminophenoxy)phenyl] hexafluoropropane; t-butyl styrene (TBS) and α,α′-Bis(4-aminophenyl)-1,4-diisopropylbenzene (Bisaniline-P) were obtained from TCI America (Portland, Oreg.). Pyromellitic dianhydride was obtained from Hangzhou Bingo Chemical Company (Hangzhou, China). N-Methyl-2-Pyrrolidone was obtained from Univar Solutions (Downers Grove, Ill.). Biphenyl tetracarboxylic dianhydride was from Akron Polymer Systems (Akron, Ohio). AMBERLYST® 36 resin (polymer bound sulfonic acid catalyst) was obtained from Dow Chemical Company (Midland, Mich.) and was dried overnight in a recirculating oven at 100° C. prior to use. Tricyclodecane dimethanol diacrylate (SR833) was obtained from Sartomer Chemical Company (Exton, Pa.). PPE (NORYL™ SA9000; low molecular weight, bi-functional oligomer based on polyphenylene ether) was obtained from SABIC Innovative Plastics (Riyadh, Saudi Arabia). 4,4′-Bis(o-propenylphenoxy)-benzophenone (COPIMIDE® TM-123) and CUREZOL®-2PZ (2-phenylimidazole) were obtained from Evonik Industries (Essen, Germany). KBM-303 (2-(3,4 epoxycyclohexyl) ethyltrimethoxysilane) and KBM-573 (N-Phenyl-3-aminopropyltrimethoxysilane) were obtained from Shin-Etsu Chemical Company (Tokyo, Japan). 1,6-Bis(2,3-epoxypropoxy)naphthalene (HP-4032D) was obtained from DIC Corporation (Tokyo, Japan). Polytetrafluoroethylene (PTFE) was obtained from AGC Chemical Company (Tokyo, Japan). Fused Silica powder FB-5B was obtained from Denka Company (Tokyo, Japan). NE-glass fabric was obtained from Nittobo (Tokyo, Japan).

### Film Preparation.

The thin films were prepared from compounds or compositions by pouring a solution of approximately 25% (w/v) solids in anisole into square aluminum molds (12×12×0.2 cm) that had been treated with a mold release agent. The filled molds were placed in a vacuum chamber for 5 minutes to remove any dissolved gasses. The molds were then placed in an oven for about 5 hours at 100° C. to evaporate the solvent, leaving an uncured film. The molds were then transferred to an oven at 200° C. for 1 hour to fully cure the film. Once cooled, the 200 to 300 microns thick films were removed from the mold.

### Thermal Mechanical Analysis (TMA).

Glass transition temperature (T_{g}) and coefficient of thermal expansion (CTE) were determined using a Hitachi TMA-7100 Thermal Analysis System.

### Dynamic Mechanical Analysis (DMA)

Polymer formulations were prepared in a suitable solvent (e.g. anisole) and dispensed into a to 5-inch×5-inch stainless steel mold. The mixture was then vacuum degassing and the solvent (e.g. anisole) was allowed to slowly evaporate at 100° C. for ˜16 hours in an oven. The oven temperature was then ramped to 200° C., and held for 1 hour for curing, before cooling to room temperature. The resulting film (500+300 m) was then released from mold and cut into strips (6+1 mm x 23+1 mm) for measurement.

The strips were analyzed on a Rheometrics Solids Analyzer (RSA ii) (Rheometric Scientific Inc.; Piscataway, R J.) with a temperature ramp from 25 to 250° C. at a rate of 10° C./min under forced air using the Dynamic Temperature Ramp type test with a frequency of 6.28 rad/s. The autotension sensitivity was 1.0 g with max autotension displacement of 3.0 mm and max autotension rate of 0.01 mm/s. During the test, maximum allowed Force was 900.0×g and min allowed force is 3.0×g.

Storage modulus and loss modulus temperature were plotted against and temperature. The maximum loss modulus value found was defined as the glass transition (T_{g}).

### T_{g} (Glass Transition Temperature) and Modulus

These were measured with cured film by Rheometrics solid analyzer RSA-II and tensile mode. Film dimension was width 6+/−1 mm×length 23+/−1 mm×thickness 0.5+/−0.3 mm and measuring temperature was from 10° C. to 250 C with 5° C./min heating rate.

T_{g}, modulus, and CTE were to predict mechanical stability of dielectric material (polymer film) in various ranges of operating temperature.

### Peel Strength

This test was performed to determine adhesion strength of dielectric material (polymer film) on a copper surface. Samples were prepared by coating and drying test material on Cu foil. A second Cu foil was laminated onto the b-staged/dried dielectric layer in a Hogdog 120DX laminator at 100° C. with speed 3. Double sided Cu-dielectric material-Cu specimens were cured at 200° C. for 1 hour. Peel strength measurement was based on IPC-TM-650 2.4.9 by Instron (JEDEC Solid State Technology Association 2000, Arlington, Va.; viewed at www [dot] ipc [dot] org/TM/2.4.9e.pdf).

### Water Absorption

This test was performed by immersing a cured sample in deionized water for 24 hours at 23° C. Percent water absorption was calculated by measuring sample weight before and after immersion.

### Fourier-Transform Infrared Spectroscopy (FTIR)

Spectra were obtained using a Bruker Alpha II FTIR spectrometer.

### Gel Permeation Chromatography.

Analysis of polymer molecular weight was carried out using a SEC-MALS system (Size Exclusion Chromatography-Multi-angle light scattering detector) using polystyrene standards (MW 96,000; 77,100; 58,900; 35,400; 25,700; 12,500; 9,880; 6,140; 1,920; 953; 725; 570; 360; and 162) as reference for molecular weight (MW) calculation based on the retention time of the polymer samples compared to a standard curve. Samples were prepared by diluting 10 mg polymer compound in 1 mL of tetrahydrofuran (THF) solvent and placed in 2.0 mL amber glass vials with snap-top lids. Each sample was run on a Thermo Scientific Ultimate 3000 HPLC system (Thermo Scientific; Carlsbad, Calif.) running Chromeleon 7.2.10 software and a UV/VIS photodiode array detector. The columns used were 3 tandem Phenomenx Phenogel GPC columns with pore sizes of 1) 1000 A, 2) 500 A and 3) 100 A, which are preceded by a Phenomenx security guard column to filter out particulates. The mobile phase was THF with a flow rate of 0.350 ml/min. Each sample was run twice: 1) sample was run through the system for a chromatogram with a sample injection volume of 1 to 10 mL, depending on the compound; 2) the sample was run through the Ultimate 3000 HPLC system followed by Wyatt TREOS II multiangle light scattering detector and a Wyatt T-REX Optilab differential refractive index detector. The average molecular weight information was collected using Wyatt Astra 7.1.4 software.

### Dielectric Constant (Dk) and Dielectric Dissipation Factor (Df) Determination

The Dk and Df of samples were obtained from cured, thin films prepared as described above. The films were placed in a humidity chamber set at a temperature of 25° C.+5° C., and a of 50% 10% relative humidity for at least 24 hours prior to analysis. The Dk and Df were determined using an Anritsu MS46122B 20 GHz Vector Network Analyzer equipped with an AET 20 GHz TE mode cavity resonator.

### Example 1: Synthesis Compound 1

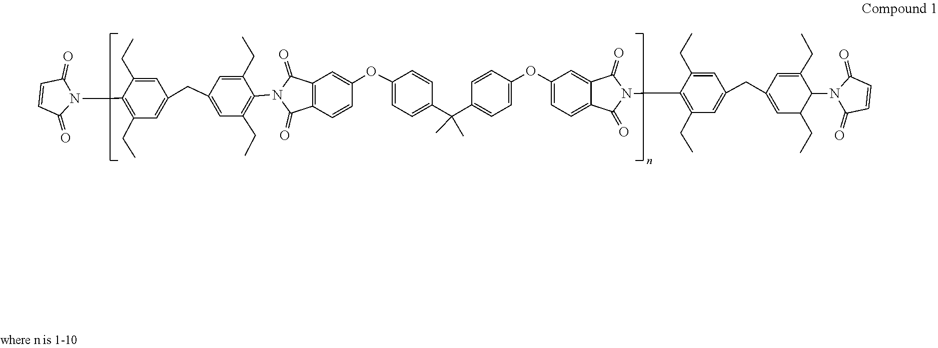

A 1 L reaction flask was charged with 0.50 mol (155.1 g) of 4,4′-methylenebis(2,6-diethylaniline) and 400 g of anisole was added to the flask to dissolve the solids. The solution was stirred at room temperature while 0.40 mol (208.0 g) of Bisphenol-A-dianhydride was added to the flask. The mixture was stirred while being heated to about 155° C. to obtain reflux. After about 1 hour, the theoretical yield of 14.4 mL water had been collected in a Dean-Stark trap. The solution was cooled to room temperature, followed by the addition of 0.24 mol (23.8 g; 20% excess) of maleic anhydride, and thereafter, followed by the addition of 20.0 g AMBERLYST® 36 acidic ion exchange resin. The mixture was again heated to reflux at about 155° C. for 3 hours to produce the maleimide-terminated polyimide, Compound 1.

The product was isolated according to the following procedure: The mixture was filtered through a polyester fabric to remove the AMBERLYST® 36 resin. The filtered solution was poured into a dropping funnel and added dropwise into a bucket of stirred methanol (˜6 L) to precipitate the product. The precipitated solid was filtered through a large Buchner funnel and rinsed with additional methanol. The filter cake was dried under vacuum on the Buchner funnel for about 1 hour, then the resulting solid powder removed to a tray and dried overnight in a recirculating oven at 100° C. The final Compound 1 product was obtained in 98% yield (355 g).

Characterization of Product: FTIR vₘₐₓ 2930, 1715, 1702, 1648, 1506, 1368, 1239, 850, 830, 750, 695, 666. ¹H NMR (DMSO) d 7.97 (s, 1H), 7.42 (m, 4H), 7.17 (m, 6H), 3.99 (s, 1H), 3.33 (s, 4H), 2.31 (m, 5H), 1.70 (s, 4H), 1.07 (m, 9H). ¹³C NMR (DMSO) d 166.9, 166.8, 163.2, 152.2, 147.2, 142.3, 133.7, 127.0, 126.6, 126.2, 124.7, 122.9, 119.9, 111.5, 42.0, 30.5, 24.1, 14.5.

Various physical properties of Compound 1 were measured as described above in MATERIALS AND METHODS. Thin films were analyzed to determine T_{g} (TMA), CTE (TMA), Dk and Df. The compound in tetrahydrofuran solution was used to determine average Molecular Weight (Daltons). The results are summarized below in Table 1.

TABLE 1
Properties of Compound 1

| Property | Value |
|---|---|
| Average Molecular Weight | −6,500 Da |
| Glass Transition Temperature (T_{g}) | 206° C. |
| Coefficient of Thermal Expansion (CTE) | 31 ppm/° C. |
| Dielectric Constant (Dk) @20 GHz | 2.69 |
| Dissipation Factor (Df) @20 GHz | 0.0080 |

### Example 2: Synthesis Compound 2

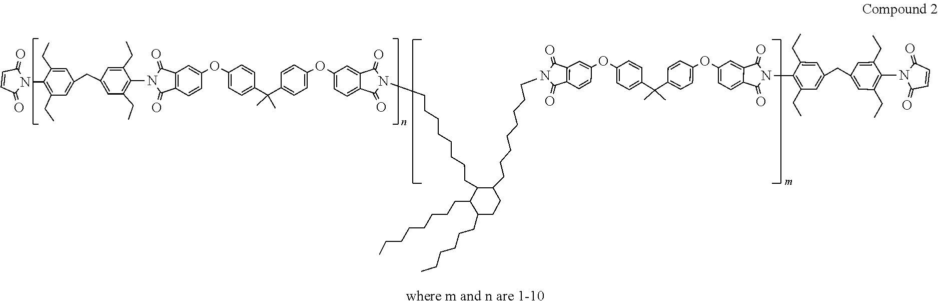

A 1 L reactor was charged with 0.24 mol (74.5 g) of 4,4′-methylenebis(2,6-diethylaniline), 0.06 mol (33.0 g) if PRIAMINE™ 1075 along with 400 g of anisole. The solution was stirred while 0.20 mol (102.0 g) of Bisphenol-A-dianhydride was added to the reactor. The mixture was heated to about 155° C. to obtain reflux, wherein the water produced during the imidization reaction was collected in a Dean-Stark trap. After approximately 1 hour, the reaction was complete with the collection of 7.2 mL of water. The solution was cooled to room temperature, and 0.240 mol (23.8 g) of maleic anhydride was added to the flask along with 25 g of AMBERLYST® 36 acidic ion exchange resin. The solution was heated to reflux for another 3 hours at 155° C. to form the maleimide-terminated oligomer with the condensation of 3.6 mL of water.

The mixture was filtered through a polyester fabric to remove the AMBERLYST® 36 resin. The solution is then added dropwise into a bucket of stirred methanol (˜6 L) to precipitate the oligomer. The precipitated solid was filtered using a large Buchner funnel and rinsed with additional methanol. The filter cake was dried with stirring on the funnel. The solid was then poured into a tray and dried overnight in a recirculating oven at 50° C. The Compound 2 product was isolated in 98% yield (213 g).

Characterization of Product: FTIR vₘₐₓ2937, 1713, 1599, 1471, 1366, 1235, 835, 693. ¹H NMR (DMSO) d 7.98 (s, 1H), 7.40 (m, 4H), 7.37 (m, 2H), 7.27 (m, 2H), 7.20 (m, 6H), 7.06 (m, 4H), 3.99 (m, 2H), 3.74 (s, 3H), 3.32 (s, 4H), 2.47 (m, 7H), 1.71 (s, 4H), 1.16 (m, 5H), 1.05 (m 12H), 0.90 (m, 2H). ¹³C NMR (DMSO) d 170.6, 166.9, 163.2, 159.1, 152.2, 147.2, 134.8, 129.4, 128.6, 126.5, 124.7, 122.9, 120.4, 119.9, 113.8, 111.5, 54.8, 39.5, 30.5, 24.1, 14.6.

Various physical properties of Compound 2 were measured as described above in MATERIALS AND METHODS. Thin films were analyzed to determine T_{g} (TMA), CTE (TMA), Dk and Df. The compound in tetrahydrofuran solution was used to determine average Molecular Weight (Daltons). The results are summarized below in Table 2.

TABLE 2
Properties of Compound 2

| Property | Value |
|---|---|
| Average Molecular Weight | 9,800 Da |
| Glass Transition Temperature (T_{g}) | 135° C. |
| Coefficient of Thermal Expansion (CTE) | 25 ppm/° C. |
| Dielectric Constant (Dk) @20 GHz | 2.69 |
| Dissipation Factor (Df) @20 GHz | 0.00494 |

### Example 3. Synthesis of Compound 3

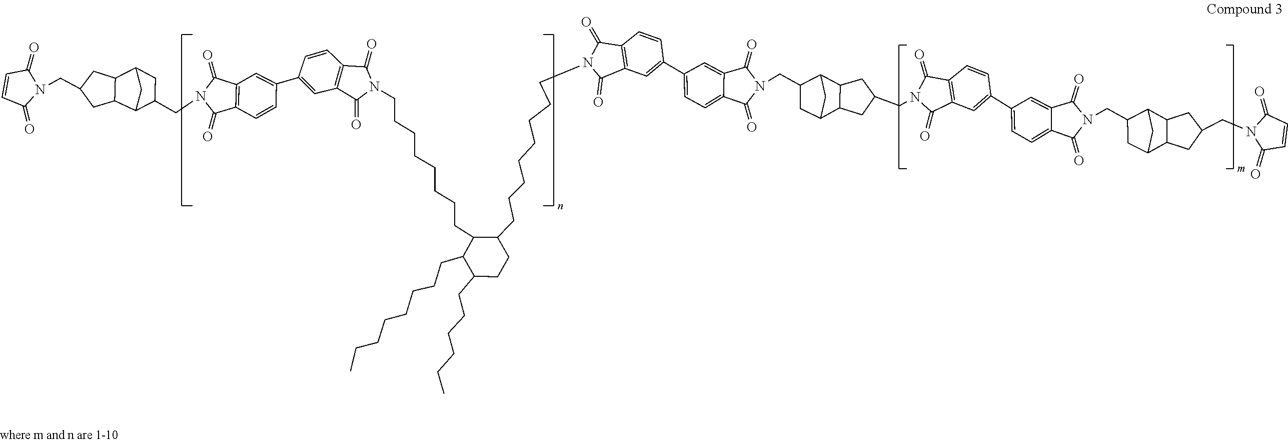

A 1 L reactor was charged with 0.320 mol (62.1 g) TCD-diamine, along with 0.08 mmol (44.0 g) of PRIAMINE™ 1075. The d 170.6 materials were dissolved in 300 g of N-methylpyrollidone (NMP) and 200 g of toluene, followed by the addition of 30 g of methanesulfonic acid. To the solution was added 0.300 mol (88.3 g) of biphenyl tetracarboxylic dianhydride. The mixture was stirred and heated to reflux to produce a homogeneous solution. After 2 hours of reflux at 115° C. approximately 11 mL of water had been collected in a Dean-Stark trap. The solution was cooled to room temperature followed by the addition of 0.240 mol (23.5 g) of maleic anhydride. The solution was heated again to reflux for about 6 hours until the theoretical yield of water (3.6 mL) had been collected in the Dean-Stark trap. The solution was poured into a separatory funnel and diluted with an additional 200 g toluene. The diluted solution washed three times with 300 g 10% aqueous ethanol. During the washing steps, the mixture was heated to 75° C. to aid separation of the aqueous layer. After washing, the solution was added dropwise into a stirred bath containing 6 L methanol to precipitate the product. The precipitate was filtered and washed with additional methanol. The white solid precipitate was dried in an oven overnight at 50° C., with approximately 90% yield (180 g) of the Compound 3 maleimide-terminated polyimide.

Characterization of Product: FTIR vₘₐₓ2922, 1702, 1622, 1435, 1391, 1344, 837, 739, 693. ¹H NMR (DMSO) d 8.26 (s, 1H), 7.98 (s, 1H), 7.26 (m, 1H), 7.17 (m, 2H), 7.0 (m, 1H), 3.30 (m, 22H), 2.69 (s, 2H), 2.29 (s, 3H), 2.18 (t, 2H), 1.91 (m, 4H), 1.46 (m, 4H), 1.23 (m, 8H), 0.86 (m 2H). ¹³C NMR (DMSO) d 171.0, 166.9, 134.4, 128.9, 128.2, 125.3, 48.4, 30.1, 29.0, 21.0, 17.2.

Various physical properties of Compound 3 were measured as described above in MATERIALS AND METHODS. Thin films were analyzed to determine T_{g} (TMA), CTE (TMA), Dk and Df. The compound in tetrahydrofuran solution was used to determine average Molecular Weight (Daltons). The results are summarized below in Table 3.

TABLE 3
Properties of Compound

| Property | Value |
|---|---|
| Average Molecular Weight | ~4,900 Da |
| Glass Transition Temperature (T_{g}) | 170° C. |
| Coefficient of Thermal Expansion (CTE) | 53 ppm/° C. |
| Dielectric Constant (Dk) @20 GHz | 2.53 |
| Dissipation Factor (Df) @20 GHz | 0.0045 |

### Example 4: Synthesis of Compound 4

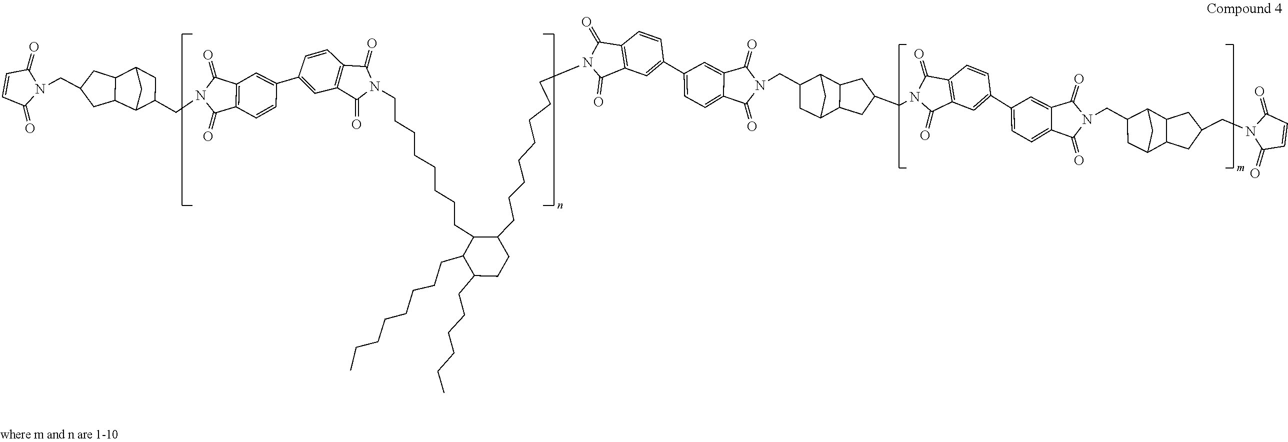

A 1 L reactor was charged with 0.300 mol (58.3 g) of TCD-diamine and 0.100 mol (54.9 g) of PRIAMINE™ 1075. To the reactor was added 300 g of NMP, 200 g of toluene and 30 g of methanesulfonic acid. The solution was stirred and 0.364 mol (107.1 g) of biphenyl tetracarboxylic dianhydride was added. The mixture was heated to reflux at 115° C. to form a homogeneous solution. After 2 hours, the theoretical yield of approximately 13 mL water had been collected in a Dean-Stark trap. The solution was then cooled to room temperature, followed by the addition of 0.086 mol (8.4 g) of maleic anhydride. The solution was again heated to reflux for about 6 hours to azeotropically remove water from the reaction. The solution was poured into a separatory funnel and diluted with an additional 500 g of toluene. The diluted solution washed three times with 300 g 10% aqueous ethanol. During the washing steps, the mixture was heated to 75° C. to aid separation of the aqueous layer. The product was recovered by precipitation into methanol as described in the previous EXAMPLES. After drying in a recirculating oven overnight at 50° C., 201 g of Compound 4 product was recovered at 95% yield.

Characterization of Product: FTIR vₘₐₓ2946, 1704, 1613, 1544, 1506, 1393, 839, 742, 695, 677. ¹H NMR (DMSO) d 8.26 (s, 1H), 7.98 (s, 1H), 7.26 (m, 1H), 7.17 (m, 2H), 7.0 (m, 1H), 3.30 (m, 32H), 2.69 (s, 4H), 2.29 (s, 4H), 2.18 (t, 3H), 1.91 (m, 6H), 1.46 (m, 6H), 1.23 (m, 12H), 0.86 (m 3H). ¹³C NMR (DMSO) d 171.0, 166.9, 134.4, 128.9, 128.2, 125.3, 48.4, 30.1, 29.0, 21.0, 17.2.

Various physical properties of Compound 4 were measured as described above in MATERIALS AND METHODS. Thin films were analyzed to determine T_{g} (TMA), CTE (TMA), Dk and Df. The compound in tetrahydrofuran solution was used to determine average Molecular Weight (Daltons). The results are summarized below in Table 4.

TABLE 4
Properties of Compound 4

| Property | Value |
|---|---|
| Average Molecular Weight | 15,200 Da |
| Glass Transition Temperature (T_{g}) | 142.5° C. |
| Coefficient of Thermal Expansion (CTE) | 47 ppm/° C. |
| Dielectric Constant (Dk) @20 GHz | 2.55 |
| Dissipation Factor (Df) @20 GHz | 0.00305 |

### Example 5: Synthesis of Compound 5

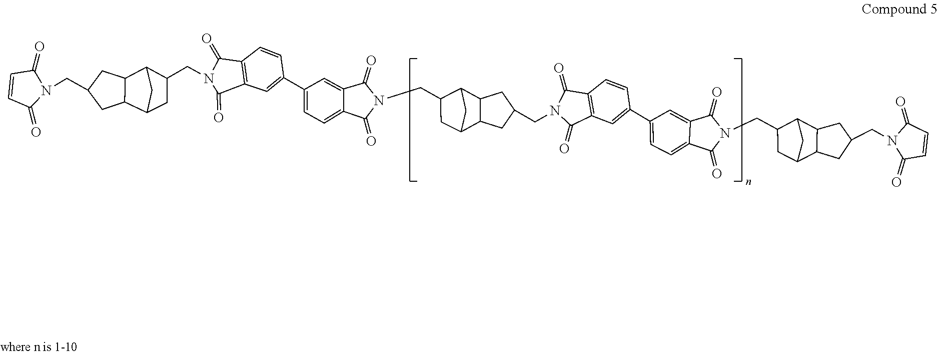

A 1 L reactor was charged with 0.500 mol (97.1 g) of TCD-diamine. Also added was a 300 g of NMP, 200 g of toluene and 30 g of methanesulfonic acid. The solution was stirred, and 0.400 mol (117.7 g) of biphenyl tetracarboxylic dianhydride was added. The mixture was heated to reflux at 115° C., producing water via condensation. After 2 hours, the theoretical yield of water (approximately 14.4 mL) had been collected in a Dean-Stark trap. The solution was cooled to room temperature, followed by the addition of 0.24 mol (23.8 g) of maleic anhydride. The solution was again heated to reflux for about 6 hours to azeotropically remove water from the reaction. The solution was poured into a separatory funnel and diluted with an additional 500 g of toluene. The diluted solution was washed three times with 300 g 10% aqueous ethanol. During the washing steps, the mixture was heated to 75° C. to aid separation of the aqueous layer. The product was recovered by precipitation into methanol as described in the previous EXAMPLES. The product was recovered at 95% yield (200 g) after drying in a recirculating oven overnight at 50° C.

Characterization of Product: FTIR vₘₐₓ2942, 1702, 1622, 1433, 1393, 842, 739, 697. ¹H NMR (DMSO) d 8.23 (s, 1H), 7.94 (s, 2H), 7.0 (s, 1H), 3.32 (m, 4H), 2.39 (m, 1H), 2.06 (m, 3H), 1.36 (m, 5H), 0.90 (m, 1H). ¹³C NMR (DMSO) d 171.3, 167.6, 144.2, 134.4, 123.7, 122.0, 48.8, 45.0, 40.8, 32.6, 28.8, 28.1, 24.5, 23.6, 17.2.

Various physical properties of Compound 5 were measured as described above in MATERIALS AND METHODS. Thin films were analyzed to determine T_{g} (TMA), CTE (TMA), Dk and Df. The compound in tetrahydrofuran solution was used to determine average Molecular Weight (Daltons). The results are summarized below in Table 5.

TABLE 5
Properties of Compound 5

| Property | Value |
|---|---|
| Average Molecular Weight | ~5,100 Da |
| Glass Transition Temperature (T_{g}) | 178° C. |
| Coefficient of Thermal Expansion (CTE) | 32 ppm/° C. |
| Dielectric Constant (Dk) @20 GHz | 2.58 |
| Dissipation Factor (Df) @20 GHz | 0.00565 |

### Example 6: Synthesis of Compound 6

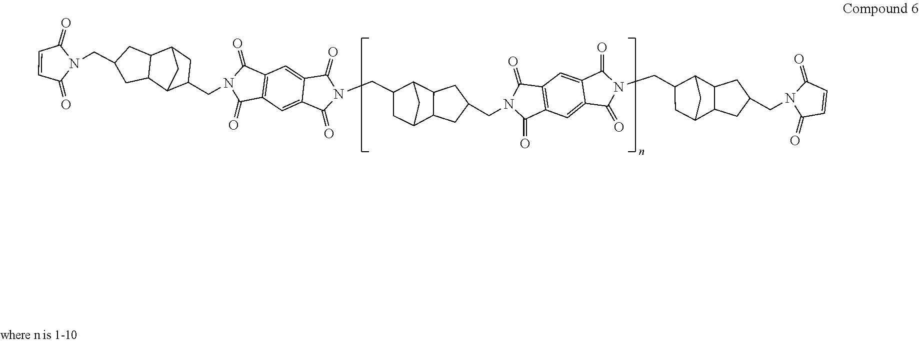

A 1 L reactor was charged with 0.500 mol (97.1 g) of TCD-diamine. Also added was 300 g of NMP, 200 g of toluene and 30 g of methanesulfonic acid. The solution was stirred, and 0.400 mol (87.3 g) of pyromellitic dianhydride was added. The mixture was heated to reflux at 115° C., producing water via condensation. After 2 hours, the theoretical yield of water (approximately 14.4 mL) had been collected in a Dean-Stark trap. The solution was cooled to room temperature, followed by the addition of 0.24 mol (23.8 g) of maleic anhydride. The solution was again heated to reflux for about 6 hours to azeotropically remove water from the reaction. The solution was poured into a separatory funnel and diluted with an additional 500 g of toluene. The diluted solution washed three times with 300 g 10% aqueous ethanol. During the washing steps, the mixture was heated to 75° C. to aid separation of the aqueous layer. The product was recovered by precipitation into methanol as described in previous EXAMPLES. Compound 6 was recovered at 94% yield (170 g) after drying in a recirculating oven overnight at 50° C.

Characterization of Product: FTIR vₘₐₓ2942, 1706, 1646, 1393, 1344, 828, 728, 695. ¹H NMR (DMSO) d 8.16 (s, 1H), 7.0 (s, 1H), 3.46 (m, 2H), 3.24 (m, 4H), 3.15 (m, 1H), 2.29 (m, 2H), 1.97 (m, 4H), 1.56 (m, 4H), 1.15 (m, 4H), 0.95 (m, 1H). ¹³C NMR (DMSO) d 171.3, 167.6, 144.2, 134.4, 123.7, 121.9, 49.5, 45.0, 38.3, 28.8, 28.0, 27.8, 24.5, 23.6, 17.2.

Various physical properties of Compound 6 were measured as described above in MATERIALS AND METHODS. Thin films were analyzed to determine T_{g} (TMA), CTE (TMA), Dk and Df. The compound in tetrahydrofuran solution was used to determine average Molecular Weight (Daltons). The results are summarized below in Table 6.

TABLE 6
Properties of Compound 6

| Property | Value |
|---|---|
| Average Molecular Weight | ~5,200 Da |
| Glass Transition Temperature (T_{g}) | 173° C. |
| Coefficient of Thermal Expansion (CTE) | 47 ppm/° C. |
| Dielectric Constant (Dk) @20 GHz | 2.48 |
| Dissipation Factor (Df) @20 GHz | 0.0065 |

### Example 7: Synthesis of Compound 7

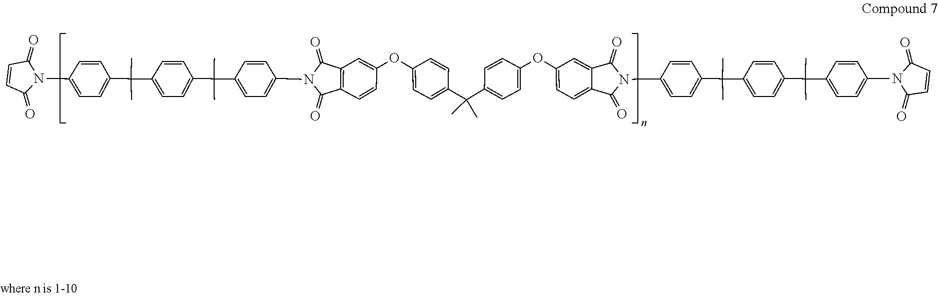

A 1 L reactor was charged with 0.500 mol (172.1 g) of Bisaniline-P. Also added was 300 g of NMP, 200 g of toluene and 30 g of methanesulfonic acid. The solution was stirred and 0.400 mol (117.7 g) of Bisphenol-A dianhydride was added. The mixture was heated to reflux at 115° C., producing water via condensation. After 2 hours, the theoretical yield of water (approximately 14.4 mL) had been collected in a Dean-Stark trap. The solution was cooled to room temperature, followed by the addition of 0.24 mol (23.8 g) of maleic anhydride. The solution was again heated to reflux for about 6 hours to azeotropically remove water from the reaction. The solution was poured into a separatory funnel and diluted with an additional 500 g of toluene. The diluted solution was washed three times with 300 g 10% aqueous ethanol. During the washing steps, the mixture was heated to 75° C. to aid separation of the aqueous layer. The product was recovered by precipitation into methanol as described earlier. After drying in a recirculating oven overnight at 100° C., Compound 7 was obtained at 98% yield (287 g).

Characterization of Product: FTIR vₘₐₓ2930, 1713, 1702, 1560, 1508, 1364, 846, 835, 686, 640. ¹H NMR (DMSO) d 7.92 (s, 1H), 7.43 (m, 9H), 7.33 (m, 6H), 1.64 (m, 12H). ¹³C NMR (DMSO) d 166.3, 162.7, 152.6, 150.0, 147.0, 134.1, 129.2, 128.5, 126.6, 126.2, 126.0, 125.8, 122.8, 119.6, 118.9, 111.5, 42.0, 30.5, 30.2.

Various physical properties of Compound 7 were measured as described above in MATERIALS AND METHODS. Thin films were analyzed to determine T_{g} (TMA), CTE (TMA), Dk and Df. The compound in tetrahydrofuran solution was used to determine average Molecular Weight (Daltons). The results are summarized below in Table 7.

TABLE 7
Properties of Compound 7

| Property | Value |
|---|---|
| Average Molecular Weight | ~12,300 Da |
| Glass Transition Temperature (T_{g}) | 206° C. |
| Coefficient of Thermal Expansion (CTE) | 23 ppm/° C. |
| Dielectric Constant (Dk) @20 GHz | 2.78 |
| Dissipation Factor (Df) @20 GHz | 0.0078 |

### Example 8: Synthesis of Compound 8

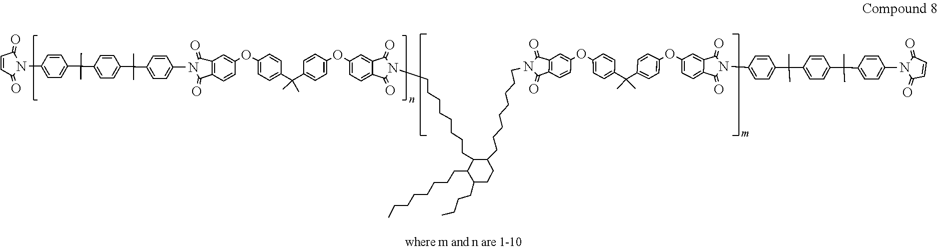

A 1 L reactor was charged with 0.240 mol (82.6 g) of Bisaniline-P, 0.060 mol (33.0 g) of PRIAMINE™ 1075 and 400 g of anisole. The solution was stirred and 0.250 mol (130.0 g) of Bisphenol-A dianhydride was added. The mixture was heated to reflux at 155° C., producing water via condensation. After 1 hour, the theoretical yield of water (approximately 9 mL) had been collected in a Dean-Stark trap. The solution was cooled to room temperature, followed by the addition of 0.12 mol (11.8 g) of maleic anhydride and 20 g of AMBERLYST® 36 acidic ion exchange resin. The mixture was again heated to reflux at 155° C. for about 2 hours to azeotropically remove water from the reaction. The AMBERLYST® resin was removed from the solution by filtration through a polyester fabric to produce a clear solution. The product was recovered by precipitation into methanol as described in the previous EXAMPLES. The yellow powder was dried overnight in a recirculating oven at 50° C. The yield of Compound 8 was approximately 95% (228 g).

Characterization of Product: FTIR vₘₐₓ2935, 1702, 1651, 1506, 1362, 857, 833, 693. ¹H NMR (DMSO) d 7.96 (s, 1H), 7.43 (m, 9H), 7.33 (m, 6H), 3.32 (m, 22H), 2.25 (m, 5H), 1.77 (m, 4H), 1.70 (m, 4H), 1.65 (m, 4H), 1.21 (m, 8H), 0.86 (m, 2H). ¹³C NMR (DMSO) d 166.3, 162.7, 152.5, 150.0, 147.0, 134.2, 129.2, 128.5, 126.6, 126.2, 126.0, 125.8, 122.8, 119.6, 118.9, 111.5, 48.4, 30.1, 29.0, 21.0, 17.2.

Various physical properties of Compound 8 were measured as described above in MATERIALS AND METHODS. Thin films were analyzed to determine T_{g} (TMA), CTE (TMA), Dk and Df. The compound in tetrahydrofuran solution was used to determine average Molecular Weight (Daltons). The results are summarized below in Table 8.

TABLE 8
Properties of Compound 8

| Property | Value |
|---|---|
| Average Molecular Weight | ~13,900 Da |
| Glass Transition Temperature (T_{g}) | 140° C. |
| Coefficient of Thermal Expansion (CTE) | 45 ppm/° C. |
| Dielectric Constant (Dk) @20 GHz | 2.69 |
| Dissipation Factor (Df) @20 GHz | 0.00375 |

### Example 9: Synthesis of Compound 9

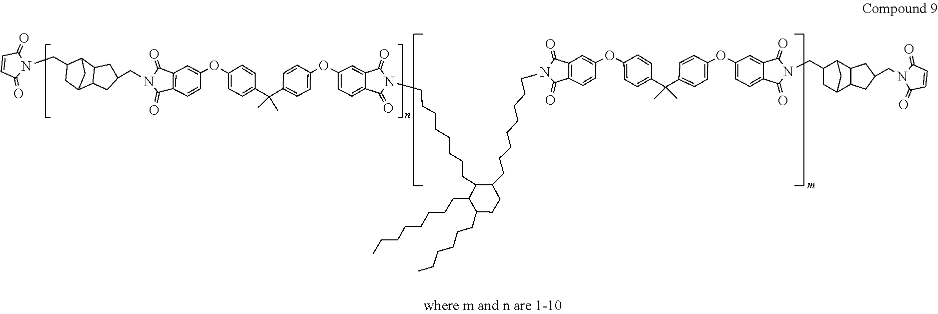

A 1 L reactor was charged with 0.320 mol (62.2 g) of tricyclodecane diamine, and 0.08 mol (44.0 g) of PRIAMINE™ 1075. Also added was a 300 g of NMP, 200 g of toluene and 30 g of methanesulfonic acid. The solution was stirred and 0.300 mol (156.0 g) of bisphenol-A dianhydride was added. The mixture was heated to reflux at 115° C., producing water via condensation. After 2 hours, the theoretical yield of water (approximately 10.8 mL) had been collected in a Dean-Stark trap. The solution was cooled down to room temperature, followed by the addition of 0.24 mol (23.8 g) of maleic anhydride. The solution was again heated to reflux for about 6 hours to azeotropically remove water from the reaction. The solution was poured into a separatory funnel and diluted with an additional 500 g of toluene. The diluted solution washed three times with 300 g 10% aqueous ethanol. During the washing steps, the mixture was heated to 75° C. to aid separation of the aqueous layer. The product was recovered by precipitation into methanol in previous EXAMPLES. After drying in a recirculating oven overnight at 100° C., Compound 9 was obtained at 96% yield (256 g).

Characterization of Product: FTIR vₘₐₓ2926, 1715, 1604, 1502, 1391, 1246, 1173, 853, 748, 695. ¹H NMR (DMSO) d 7.85 (s, 1H), 7.25 (m, 3H), 7.18 (m, 1H), 7.16 (m, 1H), 7.11 (m, 3H), 6.78 (m, 2H), 3.32 (m, 28H), 2.69 (s, 1H), 2.29 (s, 2H), 2.03 (m, 1H), 1.92 (m, 2H), 1.89 (m, 6H), 1.80 (m, 4H), 1.75 (m, 9H), 1.03 (s, 3H), 0.86 (m, 2H). ¹³C NMR (DMSO) d 171.3, 167.4, 162.5, 152.5, 146.9, 134.3, 128.8, 128.2, 122.4, 119.9, 111.3, 61.9, 48.5, 32.6, 30.5, 28.9, 21.0, 17.2.

Various physical properties of Compound 9 were measured as described above in MATERIALS AND METHODS. Thin films were analyzed to determine T_{g} (TMA), CTE (TMA), Dk and Df. The compound in tetrahydrofuran solution was used to determine average Molecular Weight (Daltons). The results are summarized below in Table 9.

TABLE 9
Properties of Compound 9

| Property | Value |
|---|---|
| Average Molecular Weight | ~13,300 Da |
| Glass Transition Temperature (T_{g}) | 143° C. |
| Coefficient of Thermal Expansion (CTE) | 41 ppm/° C. |
| Dielectric Constant (Dk) @20 GHz | 2.55 |
| Dissipation Factor (Df) @20 GHz | 0.00302 |

### Example 10: Synthesis of Compound 10

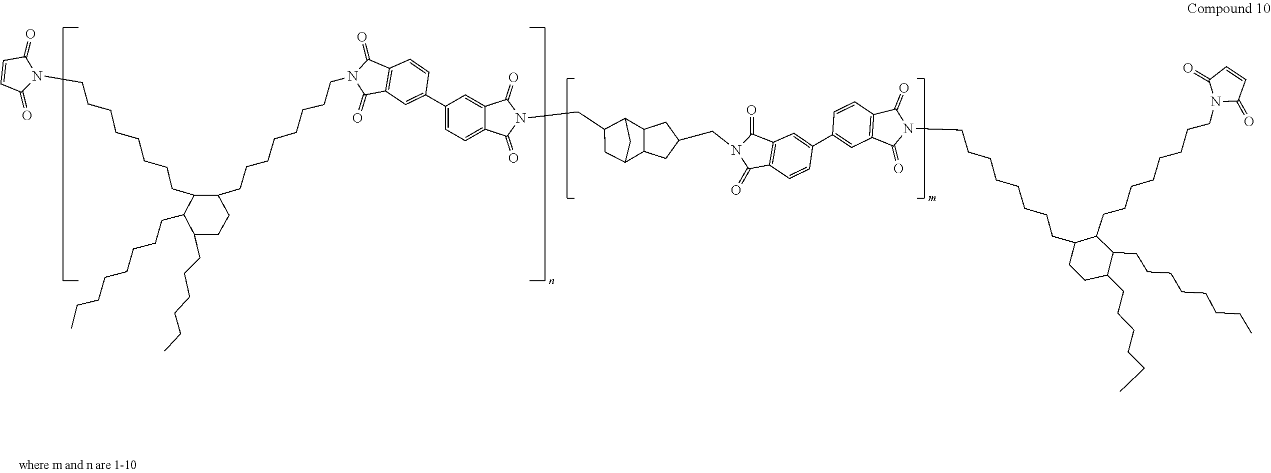

A 1 L reactor was charged with 0.400 mol (77.7 g) of TCD-diamine. Also added was a 300 g of NMP, 200 g of toluene and 30 g of methanesulfonic acid. The solution was stirred and 0.500 mol (147.1 g) of biphenyl tetracarboxylic dianhydride was added. The mixture was heated to reflux at 115° C., producing water and an anhydride-terminated polyimide via condensation. After 2 hours, the theoretical yield of water (approximately 14.4 mL) had been collected in a Dean-Stark trap. The solution was cooled to 100° C., followed by the addition of 0.20 mol (109.8 g) of PRIAMINE™ 1075. The solution was again heated to reflux for another 2 hours to azeotropically remove water (approximately 3.6 mL) and produce an amine-terminated polyimide. The solution was cooled to room temperature followed by the addition of 0.240 mol (23.8 g) of maleic anhydride. The solution was again heated to reflux at 115° C. for 6 hours to complete the synthesis of the maleimide-terminated polyimide with the azeotropic removal of 3.6 mL of water. The solution was poured into a separatory funnel and diluted with an additional 500 g of toluene. The diluted solution washed three times with 300 g 10% aqueous ethanol. During the washing steps, the mixture was heated to 75° C. to aid separation of the aqueous layer. The product was recovered by precipitation into isopropyl alcohol as described in the previous EXAMPLES. Compound 10 was obtained at 90% yield (298 g) after drying in a recirculating oven overnight at 50° C.

Characterization of Product: FTIR vₘₐₓ2922, 1704, 1619, 1435, 1388, 1342, 846, 739, 693. ¹H NMR (DMSO) d 8.26 (s, 1H), 7.96 (s, 1H), 7.26 (m, 2H), 7.18 (m, 2H), 4.35 (m, 6H), 3.42 (m, 12H), 3.32 (m, 24H), 2.69 (s, 2H), 2.49 (m, 4H), 2.30 (m, 2H), 1.91 (m, 2H), 1.24 (m, 6H), 1.07 (m, 22H), 0.86 (m, 2H). ¹³C NMR (DMSO) d 172.7, 169.2, 137.3, 128.9, 128.2, 125.3, 61.9, 55.9, 48.5, 30.0, 28.9, 25.5, 21.0, 18.5, 17.2.

Various physical properties of Compound 10 were measured as described above in MATERIALS AND METHODS. Thin films were analyzed to determine T_{g} (TMA), CTE (TMA), Dk and Df. The compound in tetrahydrofuran solution was used to determine average Molecular Weight (Daltons). The results are summarized below in Table 10.

TABLE 10
Properties of Compound 10

| Property | Value |
|---|---|
| Average Molecular Weight | ~10,100 Da |
| Glass Transition Temperature (T_{g}) | 142° C. |
| Coefficient of Thermal Expansion (CTE) | 53 ppm/° C. |
| Dielectric Constant (Dk) @20 GHz | 2.48 |
| Dissipation Factor (Df) @20 GHz | 0.00365 |

### Example 11: Synthesis of Compound 11

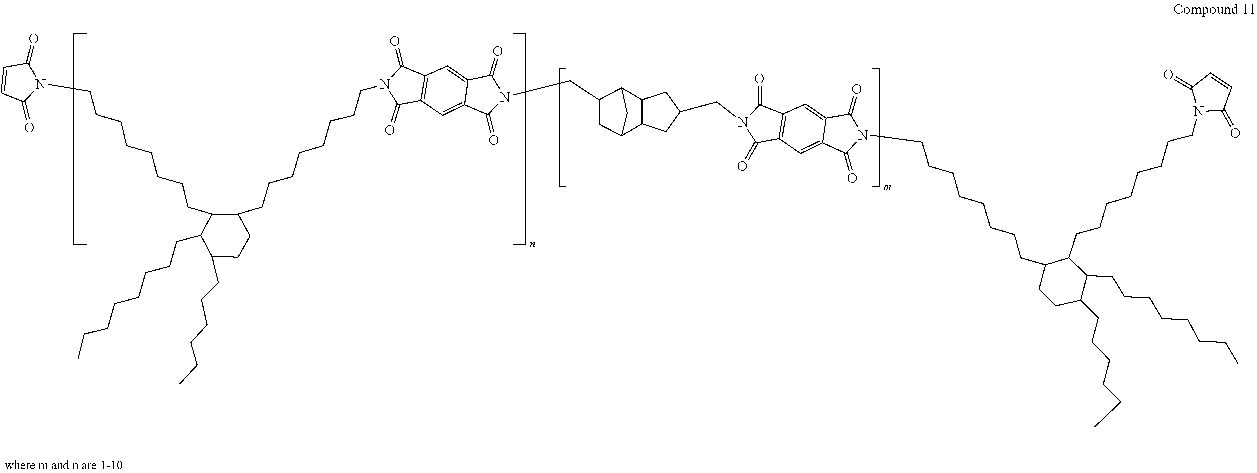

A 1 L reactor was charged with 0.300 mol (58.3 g) of TCD-diamine. Also added was a 300 g of NMP, 200 g of toluene and 30 g of methanesulfonic acid. The solution was stirred and 0.400 mol (87.3 g) of pyromellitic dianhydride was added. The mixture was heated to reflux at 115° C., producing water and an anhydride-terminated polyimide via condensation. After 2 hours, the theoretical amount of water (approximately 10.8 mL) was collected in a Dean-Stark trap. The solution was cooled to 100° C., followed by the addition of 0.20 mol (109.8 g) of PRIAMINE™ 1075. The solution was again heated to reflux for another 2 hours to azeotropically remove water from the reaction (approximately 3.6 mL) and produce an amine-terminated polyimide. The solution was cooled to room temperature followed by the addition of 0.240 mol (23.8 g) of maleic anhydride. The solution was again heated to reflux at 115° C. for 6 hours to complete the synthesis of a maleimide-terminated polyimide with the azeotropic removal of 3.6 mL of water. The solution was poured into a separatory funnel and diluted with an additional 500 g of toluene. The diluted solution washed three times with 300 g 10% aqueous ethanol. During the washing steps, the mixture was heated to 75° C. to aid separation of the aqueous layer. The product was collected by precipitation into isopropyl alcohol as described in previous EXAMPLES. Compound 11 was obtained at 90% yield (230 g) after drying in a recirculating oven overnight at 50° C.

Characterization of Product: FTIR vₘₐₓ2922, 1713, 1602, 1502, 1388, 1348, 1246, 1175, 828, 726, 695. ¹H NMR (DMSO) d 8.16 (s, 1H), 7.0 (s, 1H), 3.46 (m, 2H), 3.24 (m, 4H), 3.32 (m, 24H), 2.69 (m, 2H), 2.49 (m, 4H), 2.30 (m, 2H), 1.91 (m, 2H), 1.23 (m, 6H), 1.07 (m, 22H), 0.90 (m, 2H). ¹³C NMR (DMSO) d 171.3, 167.6, 144.2, 134.4, 123.9, 49.6, 30.0, 28.9, 25.5, 21.0, 18.5, 17.2.

Various physical properties of Compound 11 were measured as described above in MATERIALS AND METHODS. Thin films were analyzed to determine T_{g} (TMA), CTE (TMA), Dk and Df. The compound in tetrahydrofuran solution was used to determine average Molecular Weight (Daltons). The results are summarized below in Table 11.

TABLE 11
Properties of Compound 11

| Property | Value |
|---|---|
| Average Molecular Weight | ~7,500 Da |
| Glass Transition Temperature (T_{g}) | 124° C. |
| Coefficient of Thermal Expansion (CTE) | 73 ppm/° C. |
| Dielectric Constant (Dk) @20 GHz | 2.25 |
| Dissipation Factor (Df) @20 GHz | 0.0030 |

### Example 12: Synthesis of Compound 12

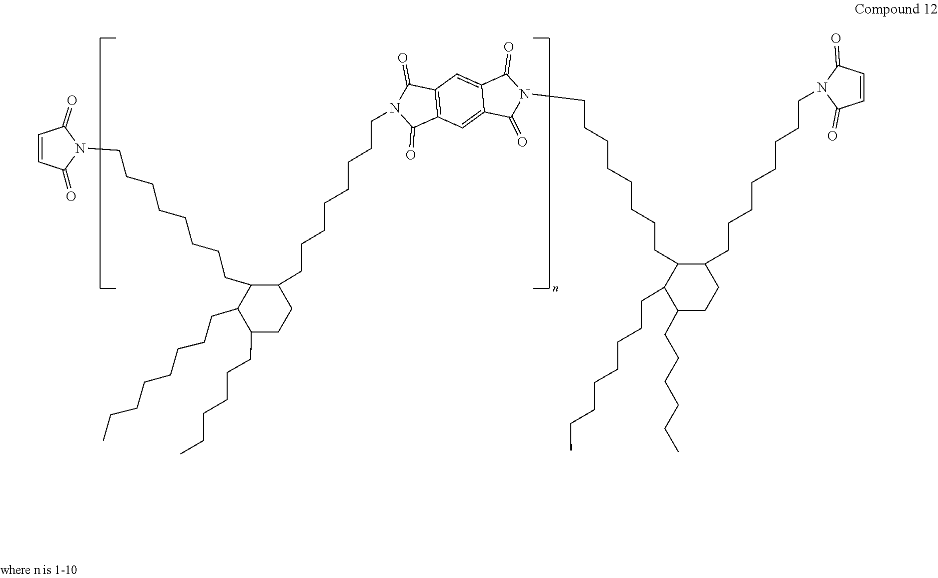

A 1 L reactor was charged with 0.300 mol (164.7 g) of PRIAMINE™ 1075. Also added was a 300 g of NMP, 200 g of toluene and 30 g of methanesulfonic acid. The solution was stirred and 0.240 mol (52.4 g) of pyromellitic dianhydride was added. The mixture was heated to reflux at 115° C., producing water and an amine-terminated polyimide via condensation. After 2 hours, the theoretical yield of water (approximately 8.7 mL), was collected in a Dean-Stark trap. The solution was cooled to room temperature followed by the addition of 0.144 mol (14.1 g) of maleic anhydride. The solution was again heated to reflux at 115° C. for 6 hours to complete the synthesis of a maleimide-terminated polyimide with the azeotropic removal of 2.2 mL of water. The solution was poured into a separatory funnel and diluted with 500 g of toluene. The diluted solution washed three times with 300 g 10% aqueous ethanol. During the washing steps the mixture was heated to 75° C. to aid separation of the aqueous layer. The product was collected by precipitation into acetone as described in the previous EXAMPLES. The product was obtained in 70% yield (153 g) after drying in a recirculating oven overnight at 50° C.

Characterization of Product: FTIR vₘₐₓ2922, 1713, 1602, 1508, 1388, 1348, 1246, 1175, 828, 726, 695. 1H NMR (CDCl3) d 8.25 (s, 1H), 7.92 (s, 1H), 3.96 (t, 1H), 3.55 (t, 1H), 1.63 (m, 5H), 1.26 (m, 58H), 0.89 (m, 2H). 13C NMR (CDCl3) d 171.2, 168.2, 135.8, 133.7, 125.2, 45.6, 44.8, 42.3, 39.7, 39.6, 31.6, 31.2, 29.7, 29.6, 23.8, 22.2, 21.8, 14.7.

Various physical properties of Compound 12 were measured as described above in MATERIALS AND METHODS. Thin films were analyzed to determine T_{g} (TMA), CTE (TMA), Dk and Df. The compound in tetrahydrofuran solution was used to determine average Molecular Weight (Daltons). The results are summarized below in Table 12.

TABLE 12
Properties of Compound 12

| Property | Value |
|---|---|
| Average Molecular Weight | ~7,000 Da |
| Glass Transition Temperature (T_{g}) | 50° C. |
| Coefficient of Thermal Expansion (CTE) | 220 ppm/° C. |
| Dielectric Constant (Dk) @20 GHz | 2.20 |
| Dissipation Factor (Df) @20 GHz | 0.0018 |

### Example 13: Synthesis of Compound 13

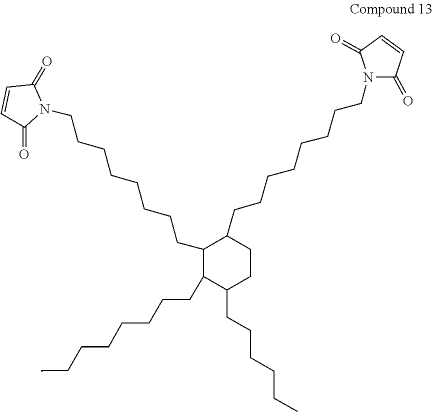 [SMILES: CCCCCCCCC1C(CCCCCC)CCC(CCCCCCCCN2C(=O)C=CC2=O)C1CCCCCCCCN1C(=O)C=CC1=O]

A 1 L reactor was charged with 0.400 mol (219.6 g) of PRIAMINE™ 1074. Also added was a 300 g of NMP, 200 g of toluene and 30 g of methanesulfonic acid. To the solution, 0.960 mol (94.1 g) of maleic anhydride was added. The solution was heated to reflux at 115° C. for 8 hours to complete the synthesis of bismaleimide resin with the azeotropic removal of 14.4 mL of water. The solution was poured into a separatory funnel and diluted with an additional 500 g of toluene. The diluted solution washed three times with 300 g 10% aqueous ethanol. During the washing steps, the mixture was heated to 75° C. to aid separation of the aqueous layer. The washed solution was placed on the rotary evaporator and the toluene was completely removed under vacuum. The dark remaining sludge was dissolved in 3 L of heptane and allowed to sit for about 3 hours at room temperature during which time a very dark oily layer settled to the bottom of the flask below a clear upper layer. The clear heptane layer was separated, and vacuum filtered through 50 g of fumed silica gel to clarify the solution. The heptane was removed using a rotary evaporator leaving 196 g of light-yellow liquid Compound 13 at 70% yield.

Characterization of Product: FTIR vₘₐₓ2930, 1713, 1560, 1508, 1364, 835, 695. 1H NMR (CDCl3) d 7.86 (s, 4H), 3.96 (t, 4H), 1.63 (m, 6H), 1.28 (m, 56H), 0.88 (m, 6H). 13C NMR (CDCl3) d 171.2, 135.8, 46.5, 41.5, 34.1, 31.8, 29.6, 30.2, 28.1, 26.7, 22.7, 14.7.

Various physical properties of Compound 13 were measured as described above in MATERIALS AND METHODS. Thin films were analyzed to determine T_{g} (TMA), CTE (TMA), Dk and Df. Molecular Weight (Daltons) was calculated from the structural formula of Compound 13. The results are summarized below in Table 13.

TABLE 13
Properties of Compound 13

| Property | Value |
|---|---|
| Molecular Weight | 689 Da |
| Glass Transition Temperature (T_{g}) | 20° C. |
| Coefficient of Thermal Expansion (CTE) | 220 ppm/° C. |
| Dielectric Constant (Dk) @20 GHz | 2.20 |
| Dissipation Factor (Df) @20 GHz | 0.0019 |

### Example 14: Synthesis of Compound 14

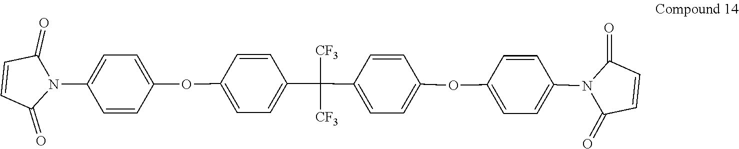 [SMILES: O=C1C=CC(=O)N1c1ccc(Oc2ccc(C(c3ccc(Oc4ccc(N5C(=O)C=CC5=O)cc4)cc3)(C(F)(F)F)C(F)(F)F)cc2)cc1]

A 1 L reactor was charged with 0.250 mol (130.5 g) of 2.2-bis[4-(4-aminophenoxy)phenyl]hexafluoropropane. Also added was a 300 g of NMP, 200 g of toluene and 30 g of methanesulfonic acid. To the solution, 0.60 mol (58.8 g) of maleic anhydride was added. The solution was heated to reflux at 115° C. for 8 hours to complete the synthesis of bismaleimide resin with the azeotropic removal of 9 mL of water. The solution was poured into a separatory funnel and diluted with an additional 500 g toluene. The diluted solution washed three times with 300 g 10% aqueous ethanol. During the washing steps, the mixture was heated to 75° C. to aid separation of the aqueous layer. The washed solution was placed in a dropping funnel and dropwise added to 4 L of stirred methanol to precipitate the product. The solid was vacuum filtered using a Buchner funnel and dried overnight at 50° C. in a recirculating oven. Compound 14 was obtained as slightly tan powder at 75% yield (128 g).

Characterization of Product: FTIR vₘₐₓ1715, 1597, 1504, 1399, 1244, 1204, 1175, 855, 828, 693. 1H NMR (DMSO) d 7.88 (s, 4H), 7.24 (m, 4H), 7.14 (m, 4H), 7.0 (m, 4H). 13C NMR (DMSO) d 162.1, 154.5, 149.8, 138.8, 127.5, 125.8, 122.2, 115.5, 109.2, 66.2.

Various physical properties of Compound 14 were measured as described above in MATERIALS AND METHODS. Thin films were analyzed to determine T_{g} (TMA), CTE (TMA), Dk and Df. Molecular Weight (Daltons) was calculated from the structural formula of Compound 14. The results are summarized below in Table 14.

TABLE 14
Properties of Compound 14

| Property | Value |
|---|---|
| Molecular Weight | 678 Da |
| Glass Transition Temperature (T_{g}) | 229° C. |
| Coefficient of Thermal Expansion (CTE) | 25 ppm/° C. |
| Dielectric Constant (Dk) @20 GHz | 2.69 |
| Dissipation Factor (Df) @20 GHz | 0.0055 |

### Example 15: Initial Formulations

Four initial formulations (I, II, III and IV) were prepared from varying amounts of Compound 12 (BMI-3000J; Designer Molecules, Inc, San Diego, Calif.) with additional components in the amounts listed in Table 15A, below.

TABLE 15A
COMPOSITION OF INITIAL FORMULATIONS

| | Formulation Number | | | |
|---|---|---|---|---|
| Component (%) | I | II | III | IV |
| BMI | | | | |
| Compound 12 | 86.95 | 84.6 | 84.6 | 67.68 |
| Benzophenone | | | | |
| CTM-123 | 7.05 | 9.4 | | |
| Compound 11 | | | | 16.92 |
| Epoxy | | | | |
| HP-4032D | | | 9.4 | 9.4 |
| Coupling Agent | | | | |
| KBM-303 | 2 | 2 | 2 | 2 |
| KBM-573 | 2 | 2 | 2 | 2 |
| Initiator | | | | |
| DCP | 2 | 2 | | |
| 2-PZ | | | 2 | 2 |

HP-4032D = 1,6-Bis(2,3-epoxypropoxy)naphthalene
KBM-303 = 2-(3,4 epoxycyclohexyl) ethyltrimethoxy silane
KBM-573 = N-Phenyl-3-aminopropyltrimethoxysilane
2-PZ = Curezol ®-2PZ
Curezol DCP = Dicumyl Peroxide

The physical properties of cured aliquots of Formulations I-IV were analyzed as described above in MATERIAL AND METHODS. The results from these analyses are given below in Table 15B.

TABLE 15B
Properties of Preliminary Formulations

| | Formulation Number | | | |
|---|---|---|---|---|
| Property | I | II | III | IV |
| TGA | | | | |
| Td (5%) (° C.) | 386.5 | 400.5 | 393 | 418 |
| CTE | | | | |
| ppm/° C. | | 372/318 | 548/586 | 87.8/187 |
| T_{g} | | | | |
| TGA (° C.) | | 65.5 | | 49.6 |
| DMA (° C.) | 52.4 | 37 | 34.75 | 52.2165 |
| Peel strength | | | | |
| 1 hr@175° C. | | | | |
| (kN/m) | 1.11 | 1.29 | 1.25 | 1.24 |
| Modulus @RT | | | | |
| (MPa) | 76.6 | 21.4 | 22.3 | 2.55 |
| Dk | | | | |
| 20 GHz | 2.46 | 2.432 | 2.4 | 2.55 |
| Df | | | | |
| 20 GHz | 0.00233 | 0.0031 | 0.004 | 0.00404 |
| Water absorption | | | | |
| 23° C./24 hrs | 0.12 | 0.09 | 0.22 | |

Table 15B shows that Formulations I-IV were inadequate to meet the T_{g} requirements for current high-performance circuit boards that may be assembled or operate at temperatures of 150-200° C. Moreover, the addition of a small amount of epoxy resin added to Formulations III and IV appeared to raise the Df value tremendously. The addition of epoxy resin can be tolerated in the manufacture of printed circuit boards that do not require low Df values. However, extremely low-loss and ultra-low loss, high-performance circuit boards require dielectric materials with Df value of less than 0.0025. In such applications, the inclusion of epoxy resin may not be possible.

The industry standard material that is used in making printed circuit boards is polyphenylene ether (PPE; Sabic-9000). This material does have a T_{g} over 170° C., and is hydrophobic, however, the Df of PPE is about 0.009 @20 GHz, so by itself it is unsatisfactory for high frequency printed circuit boards. Other have combined PPE with a wide range of free-radically curable co-resins, such as acrylics, or other very low Df resins such as polybutadienes or styrene-butadiene co-polymers. Often a small, highly functionalized cross-linker may be used to get maximum cure and high cross-linking to obtain high T_{g} and to keep moisture out to prevent a rise in the Df after exposure to humidity.

The invention maleimide-terminated polyimides have much better Df values than PPE; however, these materials absorb much more moisture, and therefore the Df values increase after exposure to humidity, often by over 50%.

### Example 16: Table 2: Improved Resin Formulations T_{g}

To determine whether the combination of PPE with the maleimide-terminated polyimides of the invention and various cross-linkers could produce materials with high T_{g} and low Df values, we prepared the formulations in Table 16, including such combinations. Since the most frequently-used cross-linkers, such as SR833 (tricyclodencane dimethanol-diacrylate) and TAIC (triallyl-isocyanurate) have high oxygen content can lower hydrophobicity. Therefore, they were purposely kept to a low wt % in the formulations to keep the Df as low as possible.

Samples were prepared according to the formulations given in Table 16. To each sample was added 2 wt % dicumyl peroxide and the compositions were oven cured for 1 hour at 200° C. according to the procedure described in previous EXAMPLES and assayed for the listed properties as described in MATERIALS AND METHODS.

Two different Df values were taken after the film was cured and then after 24 hours exposure to approximately 50% relative humidity, from High T_{g} to Low.

As summarized in Table 16, more than half the formulations had a T_{g} of 150° C. or greater; 24 of 57 had a T_{g} of 160° C. or greater, and nearly 20% had a T_{g} of 170° C. or greater.

Based on the data in Table 16, the composition in row 7 had the best combination of high T_{g}(171° C.) and low Df after exposure to humidity (Df @ 20 GHz 0.00298). This composition was combined with various fillers and made into prepregs with glass cloth as described below in EXAMPLES 17 AND 18.

TABLE 16
Compositions and Properties of Improved Formulations

| | Compositions (Weight Percent) | | | | | | | | | | | | | | | | Properties | | | |
|---|---|---|---|---|---|---|---|---|---|---|---|---|---|---|---|---|---|---|---|---|
| No. | 1 | 3 | 4 | 6 | 7 | 8 | 9 | 10 | 11 | 12 | 13 | 14 | TAIC | PPE | TBS | SR833 | T_{g} | CTE | Dk | Df |
| 1 | 55 | | | | | | | | | | 35 | | 10 | | | | 177 | 45 | 2.52 | 0.00269 |
| | | | | | | | | | | | | | | | | | | | | 0.00440 |
| 2 | 55 | 35 | | | | | | | | | | | 10 | | | | 177 | 169 | 2.45 | 0.00285 |
| | | | | | | | | | | | | | | | | | | | | 0.00500 |
| 3 | 30 | 32.5 | | | | | | | | | 27.5 | | 10 | | | | 176 | 30 | 2.60 | 0.00233 |
| | | | | | | | | | | | | | | | | | | | | 0.00375 |
| 4 | 55 | | | | | | | | | | 40 | | 5 | | | | 175 | 56 | 2.62 | 0.00300 |
| | | | | | | | | | | | | | | | | | | | | 0.00430 |
| 5 | 25 | 40 | | | | | | | | | 25 | | 10 | | | | 175 | 97 | 2.35 | 0.00200 |
| | | | | | | | | | | | | | | | | | | | | 0.00366 |
| 6 | 45 | | | | | | | | | | 45 | | 10 | | | | 174 | 45 | 2.5 | 0.00250 |
| | | | | | | | | | | | | | | | | | | | | 0.00380 |
| 7 | | | | | | | 25 | | | | 25 | | 10 | 40 | | | 171 | 67 | 2.44 | 0.00223 |
| | | | | | | | | | | | | | | | | | | | | 0.00298 |
| 8 | | 40 | | | | | | | | | 25 | | 10 | 25 | | | 170 | 66 | 2.45 | 0.00210 |
| | | | | | | | | | | | | | | | | | | | | 0.00300 |
| 9 | 50 | | | | | | | | | | 40 | | 10 | | | | 170 | 50 | 2.5 | 0.00283 |
| | | | | | | | | | | | | | | | | | | | | 0.00404 |
| 10 | 40 | | | | | | | | | | 45 | | 15 | | | | 170 | 180 | 2.54 | 0.00283 |
| | | | | | | | | | | | | | | | | | | | | 0.00403 |
| 11 | | 35 | | | | | | | | | 25 | | 10 | 30 | | | 170 | 38 | 2.42 | 0.00208 |
| | | | | | | | | | | | | | | | | | | | | 0.00325 |
| 12 | | 40 | | | | | | | | | 25 | | 15 | 20 | | | 169 | 70 | 2.4 | 0.0020 |
| | | | | | | | | | | | | | | | | | | | | 0.00320 |
| 13 | | 30 | | | | | | | | | 30 | | 10 | 30 | | | 169 | 82 | 2.45 | 0.00235 |
| | | | | | | | | | | | | | | | | | | | | 0.00310 |
| 14 | | | | | | | | | | | 25 | | 10 | 65 | | | 168 | 97 | 2.49 | 0.00292 |
| | | | | | | | | | | | | | | | | | | | | 0.00355 |
| 15 | | | | | | | 40 | | | | 25 | | 15 | 20 | | | 168 | 55 | 2.43 | 0.00212 |
| | | | | | | | | | | | | | | | | | | | | 0.00315 |
| 16 | | 40 | | | | | | | | | | | | 50 | 10 | | 167 | 30 | 2.5 | 0.00295 |
| | | | | | | | | | | | | | | | | | | | | 0.00465 |
| 17 | 65 | | | | | | | | 30 | | | 5 | | | | | 165 | 23 | 2.6 | 0.00420 |
| | | | | | | | | | | | | | | | | | | | | 0.00578 |
| 18 | | 40 | | | | | | | | | 10 | | | 50 | | | 165 | 35 | 2.48 | 0.00246 |
| | | | | | | | | | | | | | | | | | | | | 0.00369 |
| 19 | | 40 | | | | | | | | | | | 10 | 50 | | | 165 | 32 | 2.38 | 0.00245 |
| | | | | | | | | | | | | | | | | | | | | 0.0070 |
| 20 | | 40 | | | | | | | | 10 | | | | 50 | | | 161 | 42 | 2.5 | 0.0030 |
| | | | | | | | | | | | | | | | | | | | | 0.00359 |
| 21 | | | | 20 | | | | | 70 | | | | 10 | | | | 161 | 73 | 2.6 | 0.00215 |
| | | | | | | | | | | | | | | | | | | | | 0.00480 |
| 22 | | 40 | | | | | | | | | 25 | | 10 | 25 | | | 160 | 69 | 2.6 | 0.00236 |
| | | | | | | | | | | | | | | | | | | | | 0.00323 |
| 23 | | | | 20 | | | | | 65 | | | | 15 | | | | 160 | 73 | 2.65 | 0.00200 |
| | | | | | | | | | | | | | | | | | | | | 0.00490 |
| 24 | | | | | | | 40 | | | | 25 | | 10 | 25 | | | 160 | 48 | 2.5 | 0.00220 |
| | | | | | | | | | | | | | | | | | | | | 0.00290 |
| 25 | | 70 | | | | | | | | 20 | | | 10 | | | | 159 | 265 | 2.5 | 0.00212 |
| | | | | | | | | | | | | | | | | | | | | 0.00373 |
| 26 | | 25 | | | | | | | | | 25 | | 10 | 40 | | | 156 | 131 | 2.45 | 0.00213 |
| | | | | | | | | | | | | | | | | | | | | 0.00299 |
| 27 | | | | 15 | | | | | 75 | | | | 10 | | | | 156 | 55 | 2.6 | 0.00195 |
| | | | | | | | | | | | | | | | | | | | | 0.00375 |
| 28 | | | | | 45 | 45 | | | | 10 | | | | | | | 156 | 32 | 2.65 | 0.00272 |
| | | | | | | | | | | | | | | | | | | | | 0.00412 |
| 29 | | 50 | | | | | | | 40 | 10 | | | | | | | 140 | 53 | 2.36 | 0.00146 |
| | | | | | | | | | | | | | | | | | | | | 0.00236 |
| 30 | 20 | 40 | | | | | | | | | 25 | | 15 | | | | 155 | 87 | 2.58 | 0.00190 |
| | | | | | | | | | | | | | | | | | | | | 0.00291 |
| 31 | 20 | 55 | | | | | | | | | 15 | | 10 | | | | 155 | 80 | 2.55 | 0.00272 |
| | | | | | | | | | | | | | | | | | | | | 0.00473 |
| 32 | | 60 | | | | | | | | | 30 | | 10 | | | | 151 | 75 | 2.45 | 0.00175 |
| | | | | | | | | | | | | | | | | | | | | 0.00322 |
| 33 | | | | | 30 | | | | | | 40 | | 10 | 20 | | | 150 | 357 | 2.5 | 0.00336 |
| | | | | | | | | | | | | | | | | | | | | 0.00485 |
| 34 | 10 | 50 | | | | | | | | | 30 | | 10 | | | | 147 | 47 | 2.45 | 0.00195 |
| | | | | | | | | | | | | | | | | | | | | 0.00355 |
| 35 | | | | | | | | 80 | | | | 20 | | | | | 146 | 45 | 2.45 | 0.0020 |
| | | | | | | | | | | | | | | | | | | | | 0.00375 |
| 36 | | | | | | 40 | | 60 | | | | | | | | | 145 | 68 | 2.55 | 0.00192 |
| | | | | | | | | | | | | | | | | | | | | 0.00423 |
| 37 | | | | 20 | | | | | 75 | | | | | | | | 144 | 66 | 2.5 | 0.00230 |
| | | | | | | | | | | | | | | | | | | | | 0.00480 |
| 38 | | 40 | | | 25 | | | | | | 25 | | 10 | | | | 143 | 81 | 2.6 | 0.00225 |
| | | | | | | | | | | | | | | | | | | | | 0.00334 |
| 39 | | | | 60 | | | | | | | 30 | | 10 | | | | 142 | 79 | 2.55 | 0.00245 |
| | | | | | | | | | | | | | | | | | | | | 0.00470 |
| 40 | 50 | | | | | | | | | | 40 | | 10 | | | | 142 | 74 | 2.45 | 0.00225 |
| | | | | | | | | | | | | | | | | | | | | 0.00355 |
| 41 | 10 | 50 | | | | | | | 30 | | | | 10 | | | | 141 | 45 | 2.45 | 0.00250 |
| | | | | | | | | | | | | | | | | | | | | 0.00490 |
| 42 | | | | | 20 | 30 | | | | | 40 | | 10 | | | | 140 | 75 | 2.5 | 0.00245 |
| | | | | | | | | | | | | | | | | | | | | 0.00295 |
| 43 | | 40 | | | | | | | | | 25 | | 10 | 25 | | | 140 | 69 | 2.35 | 0.00220 |
| | | | | | | | | | | | | | | | | | | | | 0.00330 |
| 44 | | 75 | | | | | | | | | 12.5 | | 12.5 | | | | 140 | 54 | 2.4 | 0.00203 |
| | | | | | | | | | | | | | | | | | | | | 0.00429 |
| 45 | | 65 | | | | | | | | | 25 | | 10 | | | | 140 | 60 | 2.5 | 0.00165 |
| | | | | | | | | | | | | | | | | | | | | 0.00330 |
| 46 | | | | | | | 35 | | | | 25 | | 10 | 30 | | | 140 | 81 | 2.5 | 0.00242 |
| | | | | | | | | | | | | | | | | | | | | 0.00340 |
| 47 | | 50 | | | | | | | | | 37.5 | | 12.5 | | | | 137 | 58 | 2.55 | 0.002 |
| | | | | | | | | | | | | | | | | | | | | 0.00329 |
| 48 | | | | | 15 | | | | 75 | | | | 10 | | | | 135 | 78 | 2.6 | 0.00191 |
| | | | | | | | | | | | | | | | | | | | | 0.00353 |
| 49 | | 35 | | | | | | | | | 25 | | 10 | 30 | | | 135 | 19 | 2.55 | 0.00261 |
| | | | | | | | | | | | | | | | | | | | | 0.00326 |
| 50 | | 45 | | | | | | | | | 25 | | 10 | 20 | | | 135 | 44 | 2.5 | 0.00216 |
| | | | | | | | | | | | | | | | | | | | | 0.00290 |
| 51 | 15 | 50 | | | | | | | | | 25 | | 10 | | | | 132 | 88 | 2.4 | 0.00215 |
| | | | | | | | | | | | | | | | | | | | | 0.00340 |
| 52 | | | | | | | | 90 | | | | | 10 | | | | 130 | 75 | 2.55 | 0.0018 |
| | | | | | | | | | | | | | | | | | | | | 0.00300 |
| 53 | | | 45 | | | | | | 45 | | | | 10 | | | | 130 | 36 | 2.52 | 0.0018 |
| | | | | | | | | | | | | | | | | | | | | 0.00338 |
| 54 | | | 40 | | | | | 40 | | | | 10 | 10 | | | | 130 | 45 | 2.55 | 0.00205 |
| | | | | | | | | | | | | | | | | | | | | 0.00341 |
| 55 | | | | | 25 | | | | | 75 | | | | | | | 130 | 56 | 2.5 | 0.00215 |
| | | | | | | | | | | | | | | | | | | | | 0.00375 |
| 56 | | | | | | | 65 | | | | 25 | | 10 | | | | 128 | 50 | 2.5 | 0.00201 |
| | | | | | | | | | | | | | | | | | | | | 0.00322 |
| 57 | | | | | | | 40 | | | | 25 | | | 25 | | 10 | 123 | 84 | 2.4 | 0.00244 |
| | | | | | | | | | | | | | | | | | | | | 0.00340 |

1, 3, 4, 6, 7, 8, 9, 10, 11, 12, 13 and 14 are Compounds 1, 3, 4, 6, 7, 8, 9, 10, 11, 12, 13 and 14, respectively, described above
TAIC = 1,3,5-Triallylisocyanurate
PPE = SA-9000; low molecular weight, bi-functional oligomer based on polyphenylene ether+
TBS = t-butyl styrene
SR833 = tricyclodecane dimethanol diacrylate
T_{g} = Glass Transition Temperature (° C.) (TMA))
CTE = Coefficient of Thermal Expansion (ppm/° C.)
Dk = Dielectric Constant @20 GHz
Df = Dissipation Factor @20 GHz; Top value immediately after cure; Bottom value after 24 hours at 50% relative humidity.

### Example 17: Low DF Prepregs

To a 500 mL beaker was added 20 g of resin comprising 40 wt % PPE, 20 wt % FM51-116, 20 wt % BMI-689 and 10 wt % TAIC. To the resin was added 100 g of toluene and the mixture was stirred with a spatula until homogeneous. To the solution was added 0.4 g (2 weight percent (wt %) dicumyl peroxide with stirring to dissolve the powder. To the solution was added 60 g of Denka FB-5D fused silica. The mixture was stirred with the aid of a paddle and electric motor for 15 minutes to get good particle distribution and make a slurry.

A 10 inch×10 inch section of Nittobo NE-glass fabric was placed in the beaker and stirred with a spatula to facilitate impregnation of the slurry. The glass fabric was removed and suspended with paper clips to air dry for about 30 minutes. Then the impregnated fabric was then suspended in an oven at 100° C. for 10 minutes to fully drive off any remaining solvent.

The dried, impregnated fabric was cut into 4 equal portions with scissors. The portions were stacked one on top the other and sandwiched between KAPTON® release film (high temperature polyimide film; DuPont, Wilmington, Del.). The stack was placed in a hot press for lamination. The temperature of the press was set to 200° C. for 1 hour and the pressure was set to 20,000 psi.

The material was removed from the laminator and removed from the KAPTON® release film. The 4-layer prepreg with approximately 25% resin and 75% silica filler was measured at about 300 microns thick. The T_{g} of the prepreg was determined to be 187° C. by DMA measurement. The Dk @20 GHz was 3.02 and the Df @ 20 GHz was 0.0022 after 24-hour exposure to humidity.

### Example 18: Low DF Prepregs

The same resin mixture as EXAMPLE 17 was made again, accept that 60 g polytetrafluoroethylene (PTFE) powder was added. The prepreg was prepared and cured in the same manner as in EXAMPLE 17. The T_{g} of the prepreg was measured at 178° C. (DMA). The Dk @ 20 GHz was determined to be 2.28 and the Df @ 20 GHz was determined to be 0.00213 after exposure to 50% relative humidity for 24 hours.

The prepregs in EXAMPLES 17 and 18 show that the compositions of the invention can be used for high performance copper clad laminates that combine high T_{g}>150° C., and very low dissipation factor (under 0.0025).

1. A matrix formulation for preparing a prepreg, copper clad laminate or flexible copper clad laminate, comprising at least one curable polyimide compound having a structure according to Formula I: 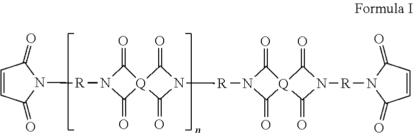
wherein,
each R is independently selected from the group consisting of substituted or unsubstituted aliphatic, cycloaliphatic, alkenyl, aromatic, and heteroaromatic;
each Q is independently selected from the group consisting of substituted or unsubstituted aliphatic, cycloaliphatic, and alkenyl; and
n is and integer having the value 0-10;
wherein the at least one curable polyimide compound is the product of a condensation of a diamine with an anhydride.

2. (canceled)

3. The matrix formulation of claim 12, wherein the diamine is selected from the group consisting of: 4,4′-methylenebis(2,6-diethylaniline); tricyclodecane diamine (TCD-diamine); Bisaniline-P; 2.2-bis[4-(4-aminophenoxy)phenyl] hexafluoropropane; 1,10-diaminodecane; 1,12-diaminododecane; PRIAMINE™ 1075 (dimer diamine): PRIAMINE™ 1074 (dimer diamine); dimer diamine; hydrogenated dimer diamine; 1,2-diamino-2-methylpropane; 1,2-diaminocyclohexane; 1,2-diaminopropane; 1,3-diaminopropane; 1,4-diaminobutane; 1,5-diaminopentane; 1,7-diaminoheptane; 1,8-diaminomenthane; 1,8-diaminooctane; 1,9-diaminononane; 3,3′-diamino-N-methyldipropylamine; diaminomaleonitrile; 1,3-diaminopentane; 9,10-diaminophenanthrene; 4,4′-diaminooctafluorobiphenyl; 3,5-diaminobenzoic acid; 3,7-diamino-2-methoxyfluorene; 4,4′-diaminobenzophenone; 3,4-diaminobenzophenone; 3,4-diaminotoluene; 2,6-diaminoanthroquinone; 2,6-diaminotoluene; 2,3-diaminotoluene; 1,8-diaminonaphthalene; 2,4-diaminotoluene; 2,5-diaminotoluene; 1,4-diaminoanthroquinone; 1,5-diaminoanthroquinone; 1,5-diaminonaphthalene; 1,2-diaminoanthroquinone; 2,4-cumenediamine; 1,3-bisaminomethylbenzene; 1,3-bisaminomethylcyclohexane; 2-chloro-1,4-diaminobenzene; 1,4-diamino-2,5-dichlorobenzene; 1,4-diamino-2,5-dimethylbenzene; 4,4′-diamino-2,2′-bistrifluoromethylbiphenyl; bis(amino-3-chlorophenyl)ethane; bis(4-amino-3,5-dimethylphenyl)methane; bis(4-amino-3,5-diisopropylphenyl)methane; bis(4-amino-3,5-methyl-isopropylphenyl)methane; bis(4-amino-3,5-diethylphenyl)methane; bis(4-amino-3-ethylphenyl)methane; diaminofluorene; 4,4′-(9-Fluorenylidene)dianiline; diaminobenzoic acid; 2,3-diaminonaphthalene; 2,3-diaminophenol; -5-methylphenyl)methane; bis(4-amino-3-methylphenyl)methane; bis(4-amino-3-ethylphenyl)methane; 4,4′-diaminophenylsulfone; 3,3′-diaminophenylsulfone; 2,2-bis(4,-(4-aminophenoxy)phenyl)sulfone; 2,2-bis(4-(3-aminophenoxy)phenyl)sulfone; 4,4′-oxydianiline; 4,4′-diaminodiphenyl sulfide; 3,4′-oxydianiline; 2,2-bis(4-(4-aminophenoxy)phenyl)propane; 1,3-bis(4-aminophenoxy)benzene; 4,4′-bis(4-aminophenoxy)biphenyl; 4,4′-diamino-3,3′-dihydroxybiphenyl; 4,4′-diamino-3,3′-dimethylbiphenyl; 4,4′-diamino-3,3′-dimethoxybiphenyl; Bisaniline M; Bisaniline P; 9,9-bis(4-aminophenyl)fluorene; o-tolidine sulfone; methylene bis(anthranilic acid); 1,3-bis(4-aminophenoxy)-2,2-dimethylpropane; 1,3-bis(4-aminophenoxy)propane; 1,4-bis(4-aminophenoxy)butane; 1,5-bis(4-aminophenoxy)butane; 2,3,5,6-tetramethyl-1,4-phenylenediamine; 3,3′, 5,5′-tetramehylbenzidine; 4,4′-diaminobenzanilide; 2,2-bis(4-aminophenyl)hexafluoropropane; polyoxyalkylenediamines; 1,3-cyclohexanebis(methylamine); m-xylylenediamine; p-xylylenediamine; bis(4-amino-3-methylcyclohexyl)methane; 1,2-bis(2-aminoethoxy)ethane; 3(4),8(9)-bis(aminomethyl)tricyclo(5.2.1.0^{2,6})decane; and combinations thereof

4. (canceled)

5. The matrix formulation of claim 12, wherein the anhydride is selected from the group consisting of: Bisphenol-A-dianhydride; biphenyl tetracarboxylic dianhydride; pyromellitic dianhydride; maleic anhydride; polybutadiene-graft-maleic anhydride; polyethylene-graft-maleic anhydride; polyethylene-alt-maleic anhydride; polymaleic anhydride-alt-1-octadecene; polypropylene-graft-maleic anhydride; poly(styrene-co-maleic anhydride); maleic anhydride; succinic anhydride; 1,2,3,4-cyclobutanetetracarboxylic dianhydride; 1,4,5,8-naphthalenetetracarboxylic dianhydride; 3,4,9,10-perylenentetracarboxylic dianhydride; bicyclo(2.2.2)oct-7-ene-2,3,5,6-tetracarboxylic dianhydride; diethylenetriaminepentaacetic dianhydride; ethylenediaminetetraacetic dianhydride; 3,3′, 4,4′-benzophenone tetracarboxylic dianhydride; 3,3′, 4,4′-biphenyl tetracarboxylic dianhydride; 4,4′-oxydiphthalic anhydride; 3,3′, 4,4′-diphenylsulfone tetracarboxylic dianhydride; 2,2′-bis(3,4-dicarboxyphenyl)hexafluoropropane dianhydride; 4,4′-bisphenol A diphthalic anhydride; 5-(2,5-dioxytetrahydro)-3-methyl-3-cyclohexene-1,2-dicarboxylic anhydride; ethylene glycol bis(trimellitic anhydride); hydroquinone diphthalic anhydride; allyl nadic anhydride; 2-octen-1-ylsuccinic anhydride; phthalic anhydride; 1,2,3,6-tetrahydrophthalic anhydride; 3,4,5,6-tetrahydrophthalic anhydride; 1,8-naphthalic anhydride; glutaric anhydride; dodecenylsuccinic anhydride; hexadecenylsuccinic anhydride; hexahydrophthalic anhydride; methylhexahydrophthalic anhydride; tetradecenylsuccinic anhydride and combinations thereof.

6. (canceled)

7. The matrix formulation of claim 1, wherein the at least one curable polyimide compound is selected from the group consisting of:

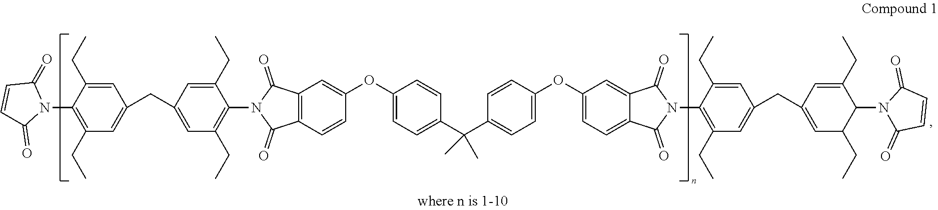

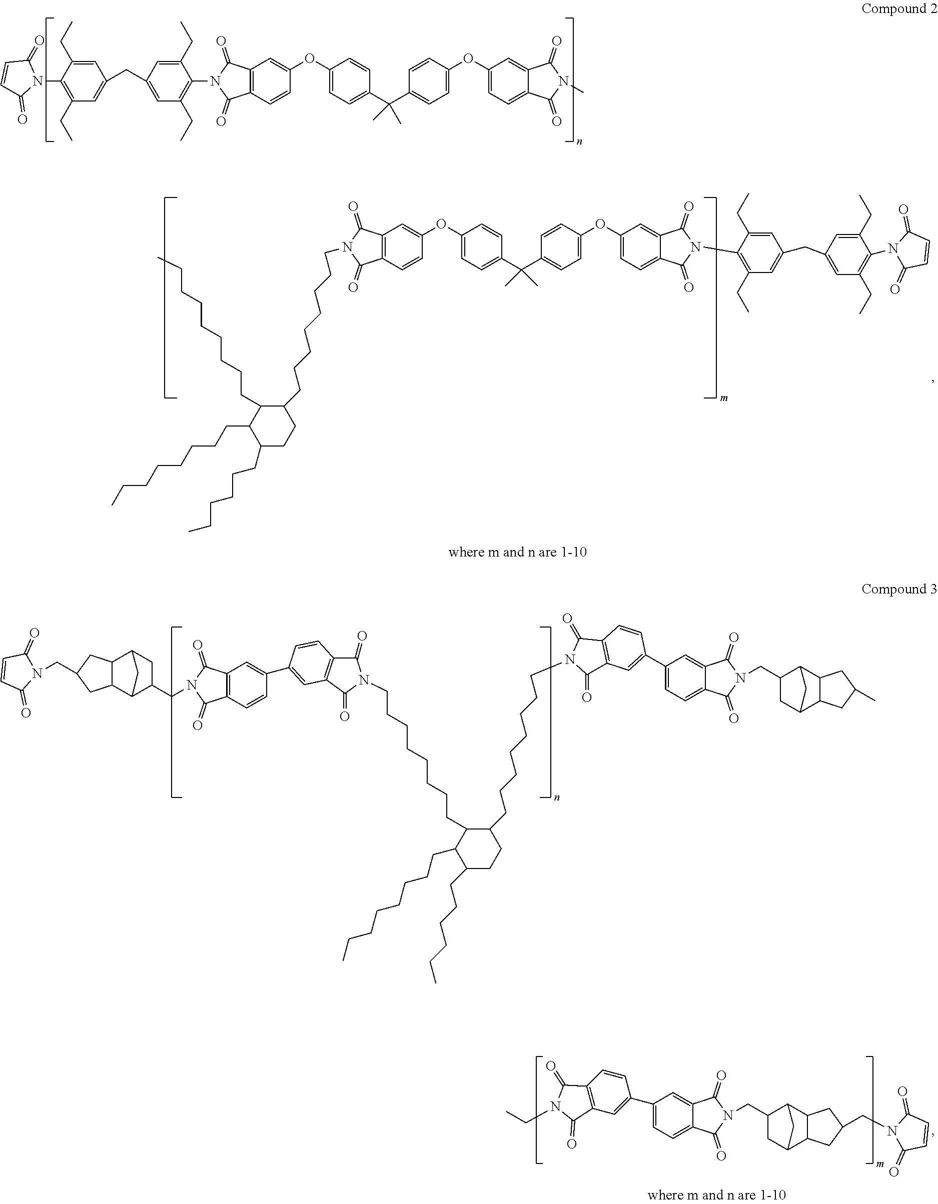

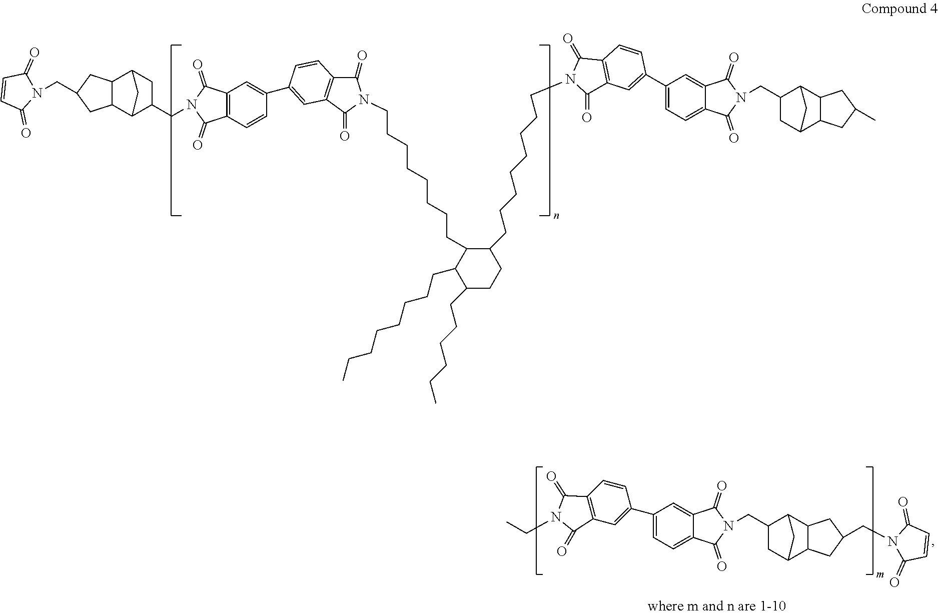

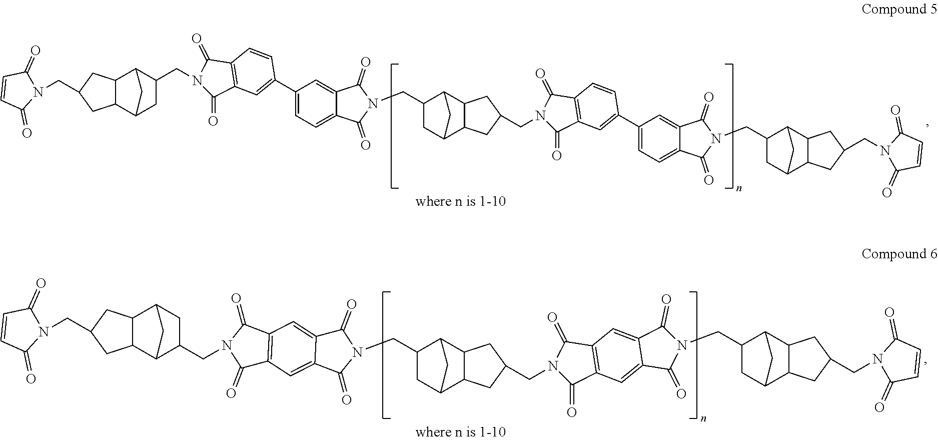

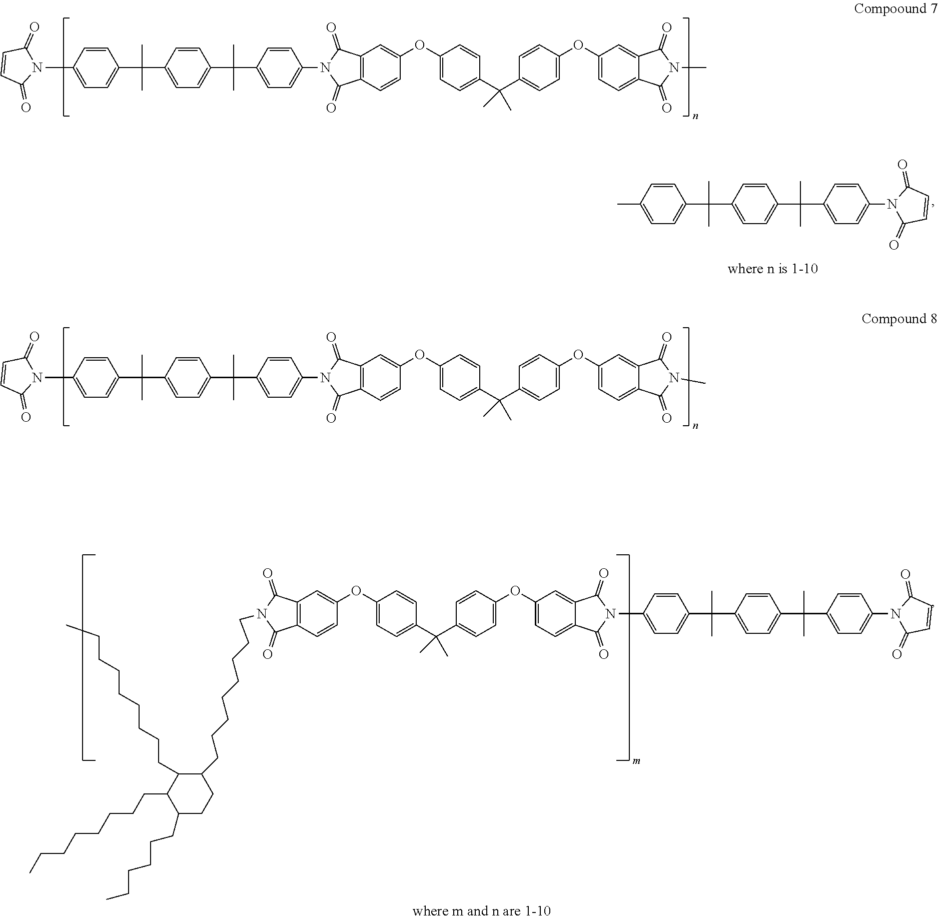

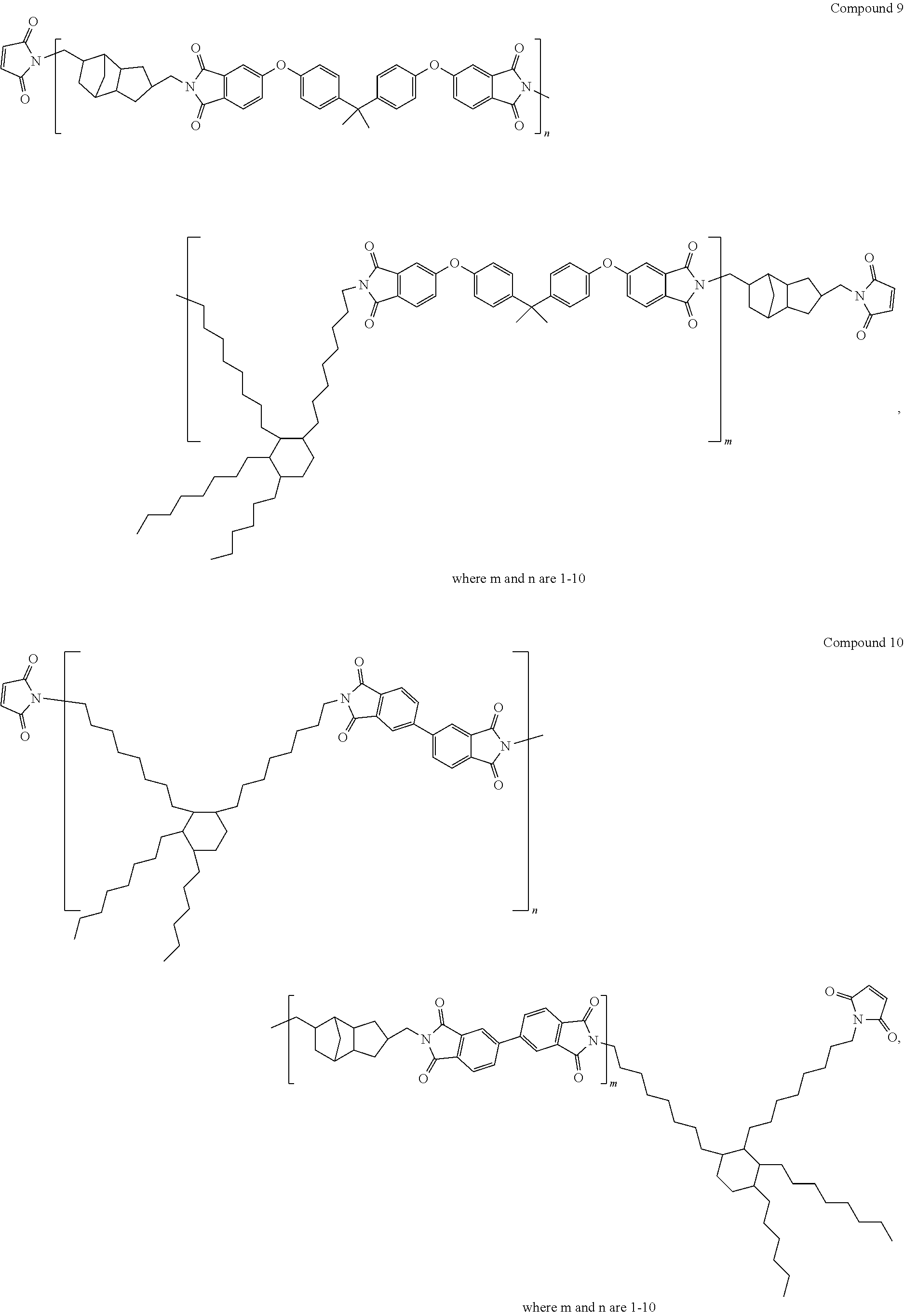

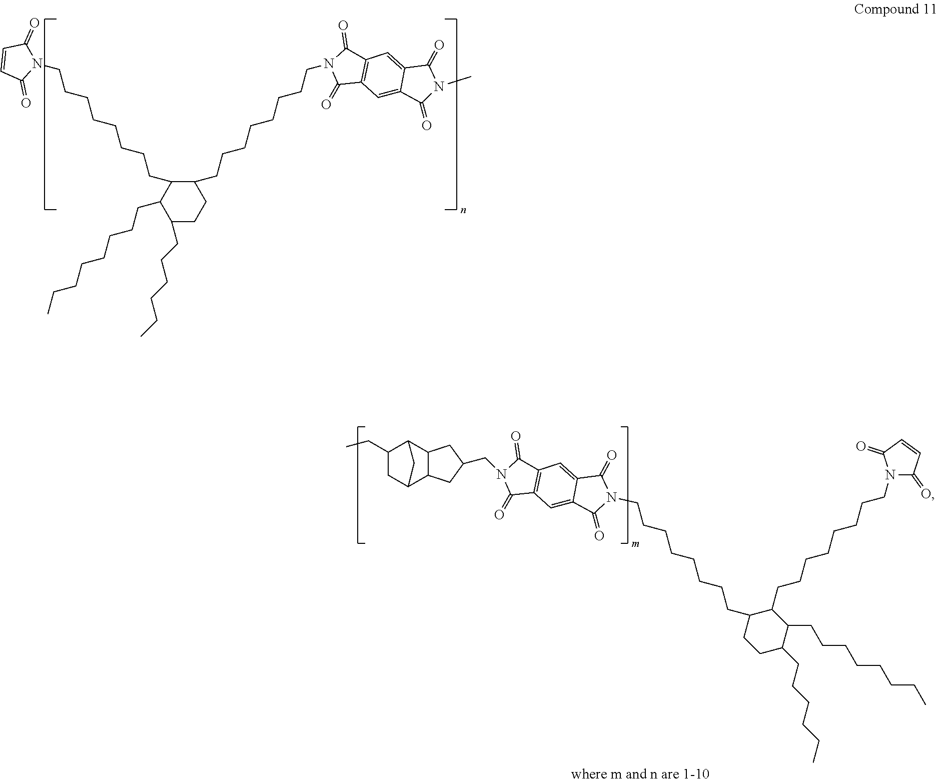

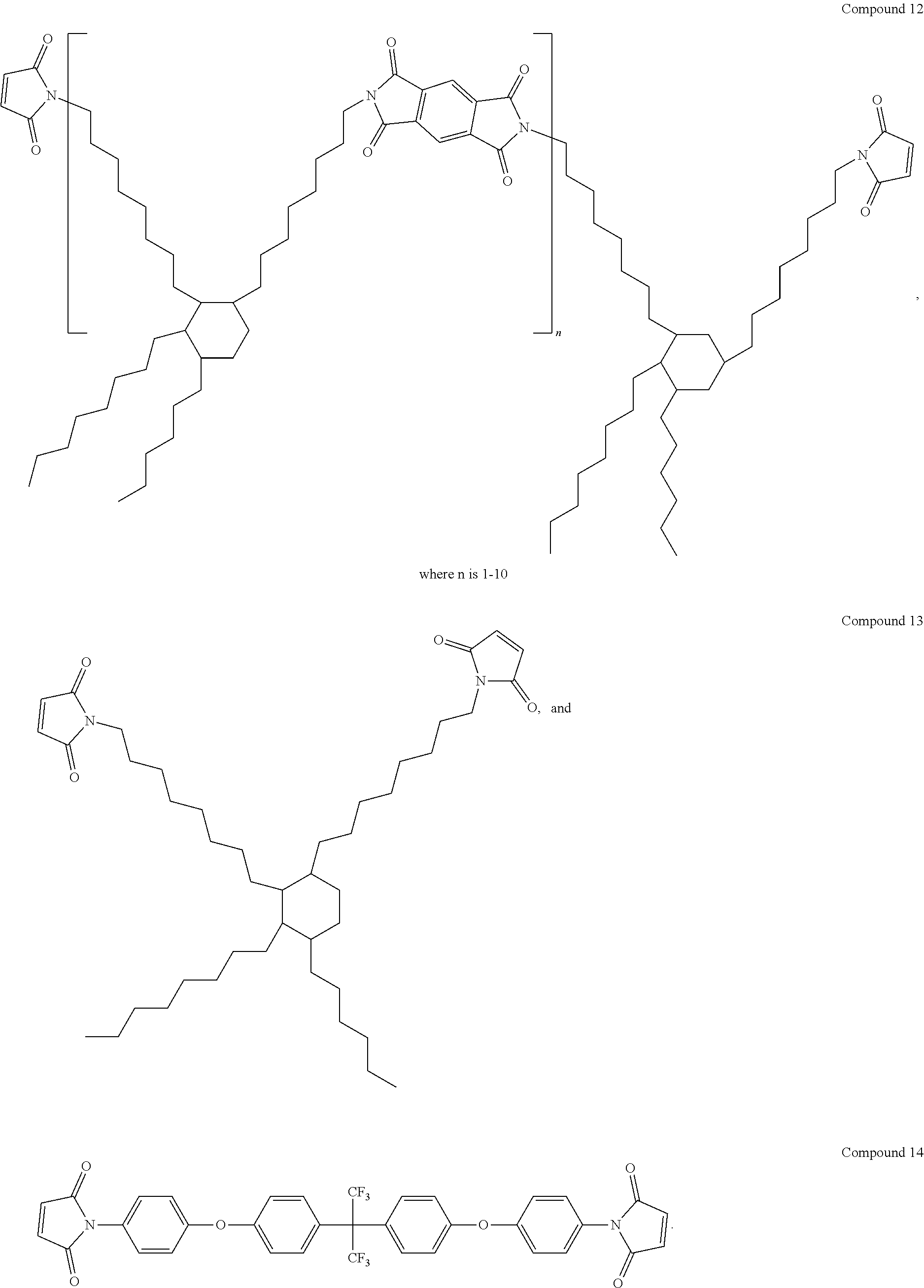

8. The matrix formulation of claim 7, wherein the at least one curable polyimide compound
is selected from the group consisting of Compounds 1, 3, 4, 6, 8, 9, 10, 11, 12, 13, 14 and combinations thereof; or
is selected from the group consisting of Compounds 1, 3, 6, 7, 8, 9, 11, 12, and 13; or
is a combination of Compounds 1 and 3; 1 and 11; 1 and 13; 1 and 14; 1, 3, and 11; 1, 3 and 13; 1, 3, and 14; 1, 11, and 14; 1, 11, and 13; 1, 13 and 14; 3 and 7; 3 and 11; 3 and 12; 3 and 13; 3, 7 and 11; 3, 7 and 12; 3, 7 and 13; 3, 11 and 12; 3, 11 and 13; 3, 12 and 13; 4 and 10; 4 and 11; 4 and 14; 4, 10 and 11; 4, 10 and 14; 4, 11 and 14; 6 and 11; 6 and 13; 7 and 8; 7 and 11; 7 and 12; 7 and 13; 7, 8 and 11; 7, 8 and 12; 7, 8 and 13; 7, 11 and 12; 7, 12 and 13; 8 and 10; 9 and 11; 9 and 13; 9 and 14; 9, 11 and 13; 9, 11 and 14; 9, 13 and 14; 10 and 14; and 11 and 12; or
is a combination of Compounds 1 and 13; 1 and 3; 9 and 13; 1 and 11; 3 and 12; 6 and 11; 7 and 13; 7, 8 and 12; or 1, 3 and 13; or
is a combination of Compound 9 and 13.

9. (canceled)

10. (canceled)

11. (canceled)

12. (canceled)

13. The matrix formulation of claim 1, further comprising polyphenylene ether (PPE).

14. The matrix formulation of claim 1, wherein the matrix further comprises at least one reactive additive, coupling agent, adhesion promoter, cross-linker, initiator, catalyst or a combination thereof.

15. The matrix formulation of claim 14, wherein:
the at least one reactive additive is selected from the group consisting of: bismaleimide resins, citraconimide resins, benzoxazine resins, reactive ester resins, phenolic resins, carboxyl resins, tackifier resins, polyphenylene oxide (PPO) resins and polyphenylene ether (PPE) resins, allylic resins, vinyl resins, vinyl ethers resins, vinyl ether resins, acrylic resins, epoxy resins, and combinations thereof, wherein the reactive ester resin is optionally a cyanate ester resin; or
the at least one reactive additive is selected from the group consisting of: 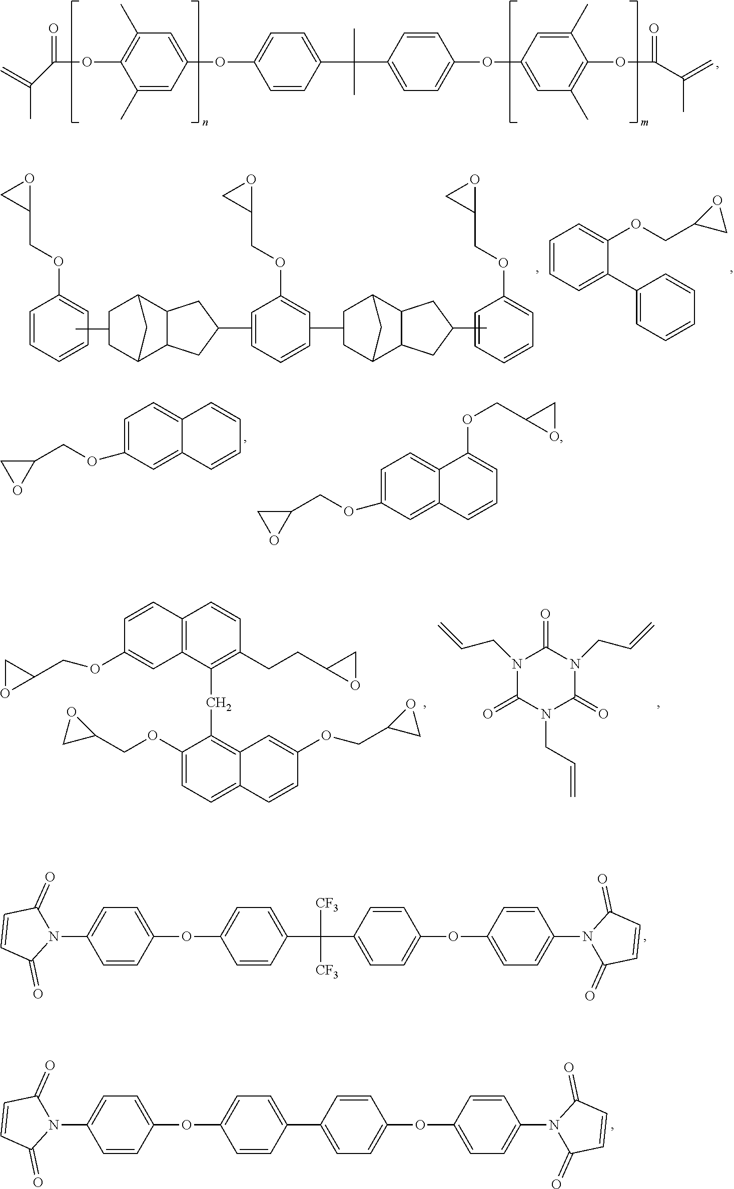 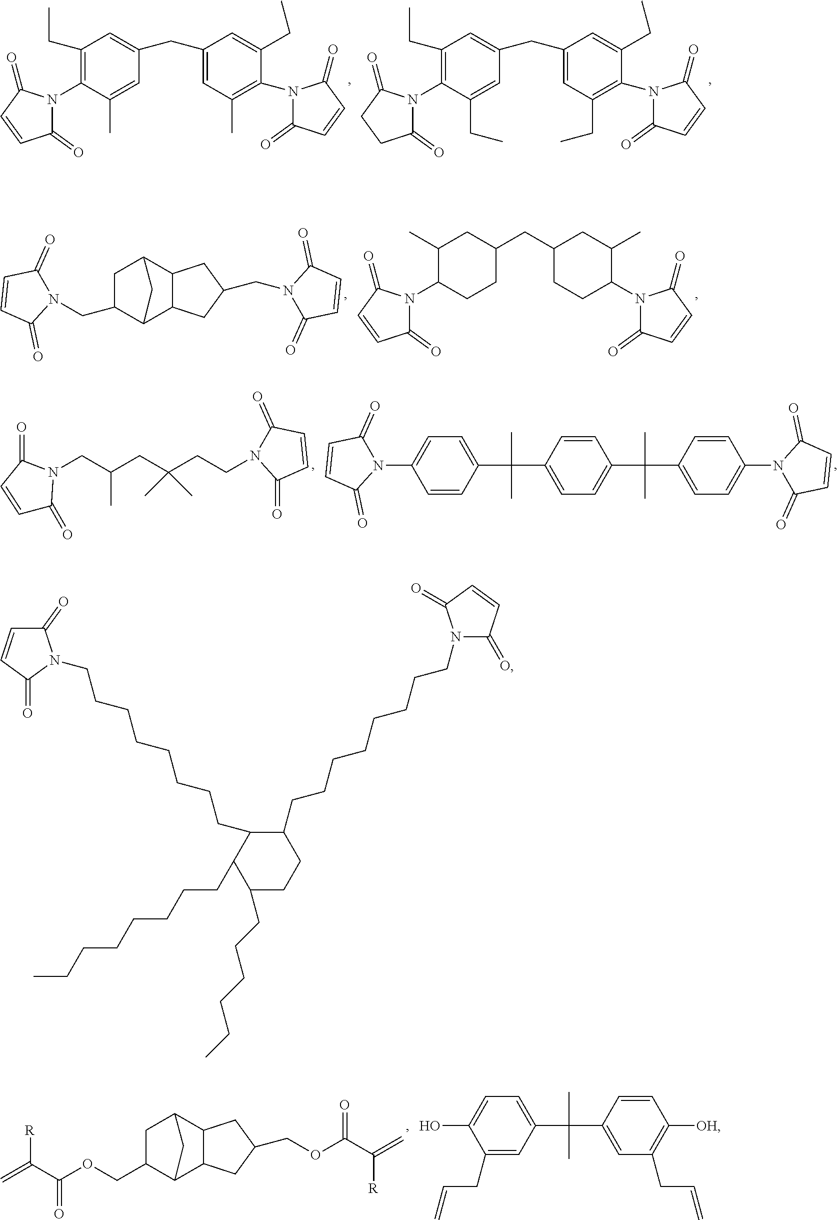 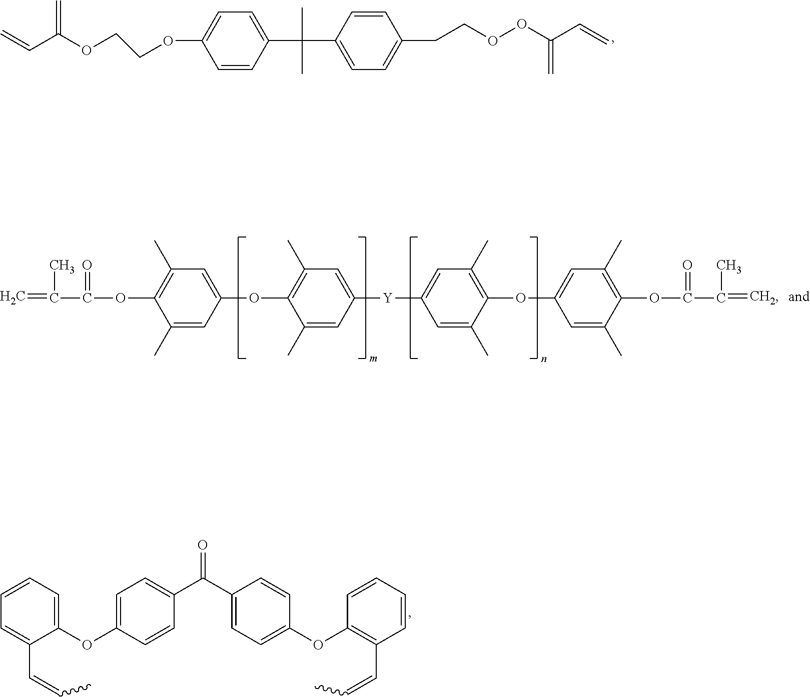
and combinations thereof; or
the at least one coupling agent is selected from the group consisting of silane coupling agents optionally comprising 2-(3,4 epoxycyclohexyl) ethyltrimethoxysilane, N-Phenyl-3-aminopropyltrimethoxysilane), or combinations thereof, titanium coupling agents, zirconium coupling agents, boranes, reactive anhydrides, salts of fatty acids, and combinations thereof; or
the at least one cross-linker is selected from the group consisting of tricyclodencane dimethanol-diacrylate, triallyl-isocyanurate and combinations thereof; or
the at least one initiator is selected from the group consisting of dicumyl peroxide (DCP), 2-phenylimidazole (2-PZ) and combinations thereof; or
the at least one catalyst is selected from the group consisting of free-radical generator catalysts, anionic initiator catalysts, cationic initiator catalysts, and carbenium ion salt catalysts and combinations thereof, wherein the free-radical generator is optionally an organoperoxide, the anionic initiator catalyst is optionally an imidazole, or the cationic initiator catalyst is optionally a Lewis acid.

16. (canceled)

17. (canceled)

18. (canceled)

19. (canceled)

20. (canceled)

21. (canceled)

22. (canceled)

23. (canceled)

24. (canceled)

25. (canceled)

26. The matrix formulation of claim 14, further comprising at least one filler, wherein the at least one filler is optionally selected from the group consisting of silica, polytetrafluoroethylene (PTFE), carbon, which is optionally a carbon nanotube, graphite, alumina and boron nitride.

27. (canceled)

28. (canceled)

29. The matrix formulation any of claim 1, further comprising at least one fire retardant, wherein the at least one fire retardant is optionally selected from the group consisting of organophosphonates and organophosphinates, wherein the organophosphinates is optionally aluminum diethyl phosphinate.

30. (canceled)

31. (canceled)

32. A prepreg comprising the matrix formulation of claim 1, and a fiber support, wherein the fiber support is optionally a woven or non-woven fabric, and optionally comprises a fiber selected from the group consisting of: quartz glass fiber, carbon fiber, PTFE glass coated fiber, E-glass fiber, S-glass fiber, HDPE fiber, aramid fiber, and combinations thereof.

33. (canceled)

34. (canceled)

35. A method for preparing a prepreg comprising the steps of:
a) providing a reinforcing fiber, which is optionally selected from a woven or unwoven fabric, and optionally comprises at least one fiber selected from the group consisting of quartz glass fiber, carbon fiber, PTFE glass coated fiber, E-glass fiber, S-glass fiber, HDPE fiber, aramid fiber and combinations thereof; and
b) immersing the reinforcing fiber in a matrix formulation of claim 1; and optionally further comprising:
c) draining the prepreg to remove excess liquid formulation; and
d) drying the prepreg,
thereby impregnating the reinforcing fiber- and preparing a prepreg.

36. (canceled)

37. (canceled)

38. (canceled)

39. A prepreg prepared according to the method of claim 35, wherein the prepreg has a T_{g} of 150° C., 160° C., 170° C. or greater, and optionally has a low Df after exposure to humidity for 24 hours, wherein the Df is optionally lower than 0.0025.

40. (canceled)

41. (canceled)

42. (canceled)

43. (canceled)

44. A method for preparing a copper-clad laminate (CCL) comprising the steps of:
a) providing the prepreg of claim 39, and
b) disposing copper on one or both sides of the prepreg;
thereby, preparing a copper-clad laminate,
wherein, optionally, disposing copper consists of electroplating copper to the one or the both sides of the prepreg or laminating copper foil to the one or the both sides of the prepreg.

45. (canceled)

46. (canceled)

47. A CCL comprising a reinforcing fiber impregnated with a composition of claim 1, having copper disposed on one or both sides.

48. A CCL prepared according to the method of claim 44, wherein the CCL optionally has T_{g}>150° C., >160° C., or >170° C., and optionally has a low Df after exposure to humidity for 24 hours, wherein optionally the Df is <0.0025.

49. (canceled)

50. (canceled)

51. (canceled)

52. (canceled)

53. A method for preparing a printed circuit board (PCB) comprising the steps of:
a) providing the CCL of claim 48; and
b) etching circuit traces in the copper disposed on the one or the both sides of the CCL, thereby preparing a printed circuit board.

54. A PCB prepared by the method of claim 53.

55. A method for preparing a flexible copper-clad laminate (FCCL) comprising the steps of:
a) providing a film comprising the matrix formulation of claim 1;
b) laminating copper foil to the adhesive on the one or the both sides of the film, wherein optionally, the film is an adhesive film,
thereby preparing a FCCL.

56. (canceled)

57. An FCCL comprising a film comprising the matrix formulation of claim 1, having copper foil laminated to one or both sides of the film and
optionally, further comprising an adhesive layer between each copper foil and the film, wherein the film is optionally an adhesive film.

58. (canceled)

59. (canceled)

60. An FCCL prepared according to the method of claim 55.

61. (canceled)

62. A method for preparing a thin, flexible electronic circuit, comprising the steps of:
a) providing the FCCL of claim 61; and
b) etching circuit traces in the copper foil on one or both sides of the FCCL;
thereby preparing a thin, flexible circuit.

63. A thin, flexible electronic circuit comprising a layer of adhesive film comprising a cured film comprising the matrix formulation of claim 1; and etching copper circuit traces on one or both sides of the adhesive film.
